(19) United States
(12) Patent Application Publication
(10) Pub. No.: US 2023/0111583 A1
(43) Pub. Date: Apr. 13, 2023

(54) DIELECTRIC RESONATOR ANTENNA AND ANTENNA DEVICE

(71) Applicant: SAMSUNG ELECTRO-MECHANICS CO., LTD., Suwon-si (KR)

(72) Inventors: Nam Ki KIM, Suwon-si (KR); Jeongki RYOO, Suwon-si (KR); Woncheol LEE, Suwon-si (KR)

(73) Assignee: SAMSUNG ELECTRO-MECHANICS CO., LTD., Suwon-si (KR)

(21) Appl. No.: 17/864,611

(22) Filed: Jul. 14, 2022

(30) Foreign Application Priority Data
Oct. 12, 2021 (KR) 10-2021-0134968
Dec. 14, 2021 (KR) 10-2021-0179141

(51) Int. Cl. H01Q 9/04; H01Q 1/50; H01Q 1/36

(52) U.S. Cl. CPC H01Q 9/0485; H01Q 1/50; H01Q 1/36

(57) ABSTRACT

A dielectric resonator antenna is provided. The dielectric resonator antenna includes a dielectric material block; a first feed unit disposed in the dielectric material block and having a first height measured from a lower surface of the dielectric material block; and a second feed unit disposed in the dielectric material block and having a second height measured from the lower surface of the dielectric material block, wherein the first feed unit and the second feed unit are disposed to be symmetrical to each other with reference to a center region of a lower surface of the dielectric material block.

### CROSS-REFERENCE TO RELATED APPLICATIONS

This application claims the benefit under 35 USC § 119(a) of Korean Patent Application No. 10-2021-0179141, filed on Dec. 14, 2021, and Korean Patent Application No. 10-2021-0134968, filed on Oct. 12, 2021, in the Korean Intellectual Property Office, the entire disclosures of which are incorporated herein by reference for all purposes.

### BACKGROUND

### 1. Field

The following description relates to a dielectric resonator antenna and an antenna device.

### 2. Description of Related Art

The recent development of wireless communication systems has significantly changed our lifestyles. An advanced mobile system with a gigabit data speed per second is desirable to support potential wireless applications such as, but not limited to, multimedia devices, internet of things (IoT), and intelligent transportation systems. This may be difficult to implement in view of the limited bandwidth capability of the current fourth generation (4G) communication system. In order to overcome such a bandwidth limitation, the International Telecommunication Union has licensed a spectrum of a millimeter wave (mmWave) for a potential fifth generation (5G) application range.

Recently, a down-size of the mmWave 5G antenna module for mobile devices has been desired. Since the form factor of mobile devices, such as mobile phones, has become slimmer, the size of the antenna module has also decreased.

Accordingly, since the size of antenna modules has decreased, antenna performance such as antenna gain and bandwidth, and isolation between a low frequency band and a high frequency band, may deteriorate.

The above information disclosed in this Background section is only for enhancement of understanding of the background of the described technology, and therefore it may contain information that does not form the prior art that is already known in this country to a person of ordinary skill in the art.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a dielectric resonator antenna, including a dielectric material block; a first feed unit disposed in the dielectric material block and configured to have a first height; and a second feed unit disposed in the dielectric material block and configured to have a second height, wherein the first feed unit and the second feed unit are disposed to be symmetrical to each other with reference to a center region of a lower surface of the dielectric material block.

The first height and the second height may be measured from the lower surface of the dielectric material block.

The dielectric resonator antenna may further include a shield via disposed in the dielectric material block, and disposed between the first feed unit and the second feed unit.

The shield via may be configured to overlap the center region.

The lower surface of the dielectric material block may include a first side that extends in a first direction and a second side that extends in a second direction different from the first direction, and a first straight line overlaps an intersection of the first side and the second side.

The first feed unit and the second feed unit may each respectively be a via disposed in the dielectric material block.

The first feed unit and the second feed unit may each respectively be a feed strip disposed on an external surface of the dielectric material block.

The lower surface of the dielectric material block may include a first side that extends in a first direction, and a second side that extends in a second direction different from the first direction, and a first straight line is parallel to one of first side and the second side.

The dielectric resonator antenna may further include a third feed unit disposed in the dielectric material block, and configured to have the first height, and a fourth feed unit disposed in the dielectric material block, and configured to have the second height, wherein the first feed unit and the fourth feed unit are configured to overlap a second straight line intersecting the center region of the lower surface of the dielectric material block, and wherein a first interval is formed between the first feed unit and the center region, and a second interval is formed between the fourth feed unit and the center region.

The dielectric material block may be configured to extend in a first direction, a second direction different from the first direction, and a third direction perpendicular to the first direction and the second direction, the lower surface comprises two first sides parallel to the first direction and two second sides parallel to the second direction, and a first straight line and the second straight line overlap an intersection of the first side and the second side.

The dielectric material block may be configured to extend in a first direction, a second direction different from the first direction, and a third direction perpendicular to the first direction and the second direction, and a first straight line is parallel to the first direction and the second straight line is parallel to the second direction.

The lower surface may include two first sides parallel to the first direction and two second sides parallel to the second direction, and the first straight line and the second straight line overlap a center of the first side and a center of the second side.

The dielectric material block may include a first dielectric material block, a second dielectric material block, and a third dielectric material block stacked from the lower surface, the first feed unit may be disposed in the first dielectric material block and the second dielectric material block, and the second feed unit may be disposed in the first dielectric material block.

The dielectric material block may further include a first dielectric layer disposed between the first dielectric material block and the second dielectric material block, and a second dielectric layer disposed between the second dielectric material block and the third dielectric material block, and a dielectric constant of the first dielectric layer and a dielectric constant of the second dielectric layer may be lower than a dielectric constant of the first dielectric material block, a dielectric constant of the second dielectric material block, and a dielectric constant of the third dielectric material block.

In a general aspect, a dielectric resonator antenna includes a dielectric material block; a first feed unit disposed in the dielectric material block, and configured to have a first height; a second feed unit disposed in the dielectric material block, and configured to have a second height different from the first height; and a shield via disposed in the dielectric material block, and configured to overlap a center region of a lower surface of the dielectric material block, and configured to be separated from the first feed unit and the second feed unit by a same interval.

The first height and the second height may be measured from the lower surface of the dielectric material block.

The shield via may include a third height, the third height of the shield via is measured from the lower surface of the dielectric material block; and the third height is equal to or greater than the second height.

The lower surface of the dielectric material block may include a first side that extends in the first direction and a second side that extends in a second direction different from the first direction, the first feed unit and the second feed unit may be configured to overlap a straight line disposed on the lower surface of the dielectric material block, and the straight line may be parallel to one of the first side and the second side.

The lower surface of the dielectric material block may include a first side that extends in a first direction and a second side that extends in a second direction different from the first direction, the first feed unit and the second feed unit may be configured to overlap a straight line disposed on the lower surface of the dielectric material block, and the straight line is configured to overlap an intersection of the first side and the second side.

The dielectric resonator antenna may further include a third feed unit disposed in the dielectric material block, and configured to have the first height, and a fourth feed unit disposed in the dielectric material block, and configured to have the second height, wherein the shield via is spaced at a same interval from the third feed unit and the fourth feed unit.

The lower surface of the dielectric material block may include a first side that extends in a first direction and a second side that extends in a second direction different from the first direction, the first feed unit and the fourth feed unit overlap a first straight line on the lower surface of the dielectric material block, the second feed unit and the third feed unit overlap a second straight line on the lower surface of the dielectric material block, and the first straight line and the second straight line may be respectively parallel to the first side or the second side.

The lower surface of the dielectric material block may include a first side that extends in a first direction, and a second side that extends in a second direction different from the first direction, the first feed unit and the fourth feed unit may overlap the first straight line on the lower surface of the dielectric material block, the second feed unit and the third feed unit may overlap the second straight line on the lower surface of the dielectric material block, and the first straight line and the second straight line are diagonal lines that overlap an intersection of the first side and the second side.

The dielectric material block may include a first dielectric material block, a second dielectric material block, and a third dielectric material block stacked from the lower surface, the first feed unit is disposed in the first dielectric material block and the second dielectric material block, and the second feed unit may be disposed in the first dielectric material block.

The dielectric material block may further include a first dielectric layer disposed between the first dielectric material block and the second dielectric material block, and a second dielectric layer disposed between the second dielectric material block and the third dielectric material block, and a dielectric constant of the first dielectric layer and a dielectric constant of the second dielectric layer are lower than a dielectric constant of the first dielectric material block, a dielectric constant of the second dielectric material block, and a dielectric constant of the third dielectric material block.

In a general aspect, an antenna device includes a dielectric material block; a first feed unit disposed in the dielectric material block and configured to have a first height measured from a lower surface of the dielectric material block; a second feed unit disposed in the dielectric material block and configured to have a second height measured from the lower surface of the dielectric material block; a ground plane disposed under the dielectric material block; and a pattern part connected to the ground plane and disposed between the first feed unit and the second feed unit, wherein the first height is different from the second height.

The antenna device may further include a shield via, disposed in the dielectric material block, and separated at a same interval from the first feed unit and the second feed unit, and the pattern part may be configured to overlap the shield via.

The pattern part may include an extension part that extends between the first feed unit and the second feed unit from a center region of the dielectric material block overlapping the shield via.

The pattern part may include a first pattern part comprising an extension part that extends between the first feed unit and the second feed unit from the center region overlapping the shield via, and a second pattern part connected to the first pattern part and configured to surround the first feed unit and the second feed unit.

The second pattern part may include a part that extends outside the lower surface of the dielectric material block.

The antenna device may include a third feed unit, disposed in the dielectric material block, and configured to have the first height, and a fourth feed unit, disposed in the dielectric material block, and configured to have the second height, and the pattern part comprises a first extension that extends between the first feed unit and the second feed unit from the center region overlapping the shield via, a second extension that extends between the first feed unit and the third feed unit, a third extension that extends between the second feed unit and the fourth feed unit, and a fourth extension that extends between the third feed unit and the fourth feed unit.

The dielectric material block may include a first dielectric material block, a second dielectric material block, and a third dielectric material block stacked from the lower surface,

The first feed unit and the third feed unit may be disposed in the first dielectric material block and the second dielectric material block, and the second feed unit and the fourth feed unit may be disposed in the first dielectric material block.

In a general aspect, an antenna includes a multilayered dielectric material block; a first feed unit of a first length disposed in a first layer and a second layer of the multilayered dielectric material block; a second feed unit of a second length, different from the first length, disposed in the first layer of the multilayered dielectric material block; wherein the first length of the first feed unit is greater than the second length of the second feed unit.

A dielectric constant of the first layer may be different from a dielectric constant of the second layer.

The antenna may be configured to transmit and/or receive a radio frequency (RF) signal of a first bandwidth through the one or more first feed units, and transmit and/or receive a RF signal of a second bandwidth through the one or more second feed units.

A center frequency of the first bandwidth may be lower than a center frequency of the second bandwidth.

The antenna may further include a shield via disposed on a center area of a lower surface of the multilayered dielectric material block, wherein the shield via is disposed on a line between the first feed unit and the second feed unit, and wherein an interval between the shield via and the first feed unit is equal to an interval between the shield via and the second feed unit.

A length of the shield via may be equal to or greater than the second length of the second feed unit.

Other features and aspects will be apparent from the following detailed description, the drawings, and the claims.

### BRIEF DESCRIPTION OF DRAWINGS

FIG. 1 illustrates a perspective view of an example dielectric resonator antenna, in accordance with one or more embodiments.

FIG. 2A and FIG. 2B illustrate top plan views of an example dielectric resonator antenna, in accordance with one or more embodiments.

FIG. 3 illustrates a perspective view of an example dielectric resonator antenna, in accordance with one or more embodiments.

FIG. 4A and FIG. 4B illustrate top plan views of an example dielectric resonator antenna, in accordance with one or more embodiments.

FIG. 5 illustrates a perspective view of an example dielectric resonator antenna, in accordance with one or more embodiments.

FIG. 6A and FIG. 6B illustrate top plan views of an example dielectric resonator antenna, in accordance with one or more embodiments.

FIG. 7 illustrates a perspective view of a dielectric resonator antenna, in accordance with one or more embodiments.

FIG. 8A and FIG. 8B illustrate top plan views of an example dielectric resonator antenna, in accordance with one or more embodiments.

FIG. 9 illustrates a perspective view of an example dielectric resonator antenna, in accordance with one or more embodiments.

FIG. 10A and FIG. 10B illustrate top plan views of an example dielectric resonator antenna, in accordance with one or more embodiments.

FIG. 11 illustrates a perspective view of an example dielectric resonator antenna, in accordance with one or more embodiments.

FIG. 12A and FIG. 12B illustrate top plan views of an example dielectric resonator antenna, in accordance with one or more embodiments.

FIG. 13 illustrates a perspective view of an example dielectric resonator antenna, in accordance with one or more embodiments.

FIG. 14A and FIG. 14B illustrate top plan views of an example dielectric resonator antenna, in accordance with one or more embodiments.

FIG. 15 illustrates a perspective view of an example dielectric resonator antenna, in accordance with one or more embodiments.

FIG. 16A and FIG. 16B illustrate top plan views of an example dielectric resonator antenna, in accordance with one or more embodiments.

FIG. 17 illustrates a perspective view of an example dielectric resonator antenna, in accordance with one or more embodiments.

FIG. 18 illustrates a top plan view of an example dielectric resonator antenna, in accordance with one or more embodiments.

FIG. 19 illustrates a perspective view of an example dielectric resonator antenna, in accordance with one or more embodiments.

FIG. 20 illustrates a top plan view of an example dielectric resonator antenna, in accordance with one or more embodiments.

FIG. 21 illustrates a perspective view of an example dielectric resonator antenna, in accordance with one or more embodiments.

FIG. 22 illustrates a perspective view of an example dielectric resonator antenna, in accordance with one or more embodiments.

FIG. 23 illustrates a perspective view of an example dielectric resonator antenna, in accordance with one or more embodiments.

FIG. 24 illustrates a perspective view of an example dielectric resonator antenna according, in accordance with one or more embodiments.

FIG. 25 illustrates a perspective view of an example dielectric resonator antenna, in accordance with one or more embodiments.

FIG. 26 illustrates a perspective view of an example dielectric resonator antenna, in accordance with one or more embodiments.

FIG. 27 illustrates a perspective view of an example dielectric resonator antenna, in accordance with one or more embodiments.

FIG. 28 illustrates a perspective view of an example dielectric resonator antenna, in accordance with one or more embodiments.

FIG. 29 illustrates a perspective view of an example dielectric resonator antenna, in accordance with one or more embodiments.

FIG. 30 illustrates a perspective view of an example dielectric resonator antenna, in accordance with one or more embodiments.

FIG. 31 illustrates a perspective view of an example antenna device, in accordance with one or more embodiments.

FIG. 32 illustrates a cross-sectional view of an example antenna device, in accordance with one or more embodiments.

FIG. 33 illustrates a top plan view of an example antenna device, in accordance with one or more embodiments.

FIG. 34A, FIG. 34B, FIG. 34C, FIG. 34D, and FIG. 34E illustrate perspective views of a manufacturing method of an example antenna device, in accordance with one or more embodiments.

FIG. 35 illustrates a top plan view of a portion of an example antenna device, in accordance with one or more embodiments.

FIG. 36 illustrates a top plan view of a portion of an example antenna device, in accordance with one or more embodiments.

FIG. 37 illustrates a top plan view of a portion of an example antenna device, in accordance with one or more embodiments.

FIG. 38 illustrates a top plan view of a portion of an example antenna device, in accordance with one or more embodiments.

FIG. 39 illustrates a top plan view of a portion of an example antenna device, in accordance with one or more embodiments.

FIG. 40 illustrates a top plan view of a portion of an example antenna device, in accordance with one or more embodiments.

FIG. 41 illustrates a top plan view of a portion of an example antenna device, in accordance with one or more embodiments.

FIG. 42 illustrates a top plan view of a portion of an example antenna device, in accordance with one or more embodiments.

FIG. 43 illustrates a top plan view of a portion of an example antenna device, in accordance with one or more embodiments.

FIG. 44 illustrates a layout view of an example antenna device, in accordance with one or more embodiments.

FIG. 45 illustrates a layout view of an example antenna device, in accordance with one or more embodiments.

FIG. 46 illustrates a layout view of an example antenna device, in accordance with one or more embodiments.

FIG. 47 illustrates a layout view of an example antenna device, in accordance with one or more embodiments.

FIG. 48 illustrates a layout view of an example antenna device, in accordance with one or more embodiments.

FIG. 49 illustrates a layout view of an example antenna device according to another embodiment.

FIG. 50 illustrates a layout view of an example antenna device according to another embodiment.

FIG. 51 illustrates a layout view of an example antenna device, in accordance with one or more embodiments.

FIG. 52 illustrates a layout view of an example antenna device, in accordance with one or more embodiments.

FIG. 53 illustrates a layout view of an example antenna device, in accordance with one or more embodiments.

FIG. 54 illustrates a diagram illustrating an example electronic device including an example antenna device, in accordance with one or more embodiments.

FIG. 55, FIG. 56, and FIG. 57 illustrate graphs of a result of an experimental example, in accordance with one or more embodiments.

FIG. 58, FIG. 59, FIG. 60, and FIG. 61 illustrate views of a result of another experimental example, in accordance with one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined, all terms, including technical and scientific terms, used herein have the same meaning as commonly understood by one of ordinary skill in the art to which this disclosure pertains after an understanding of the disclosure of the present application. Terms, such as those defined in commonly used dictionaries in the context of this art, are to be interpreted as having a meaning that is consistent with their meaning in the context of the relevant art and the disclosure of the present application, and are not to be interpreted in an idealized or overly formal sense unless expressly so defined herein.

Further, in the one or more examples, the phrase “on a plane” means that the object portion is viewed from the top, and the phrase “on a cross-section” means that a cross-section of which the object portion is vertically cut from is viewed from the side.

One or more examples may provide an antenna and an antenna device that may prevent antenna performance degradation while reducing the antenna size.

In one or more examples, a pattern, a via, a plane, a line, and an electrical connection structure may include metal materials, as non-limiting examples, (copper (Cu), aluminum (Al), silver (Ag), tin (Sn), gold (Au), nickel (Ni), lead (Pb), titanium (Ti), or a conductive material such as alloys thereof), and may be formed according to a plating method such as chemical vapor deposition (CVD), physical vapor deposition (PVD), sputtering, a subtractive, additive, or semiadditive process (SAP), a modified semiadditive process (MSAP), etc., but is not limited thereto.

In one or more examples, a dielectric layer and/or an insulation layer may be realized by FR4, a liquid crystal polymer (LCP), an low temperature co-fired ceramic (LTCC), thermosetting resins such as epoxy resins, thermoplastic resins such as a polyimide, or resins in which these resins are impregnated into core materials such as glass fibers (a glass fiber, glass cloth, glass fabric) together with inorganic fillers, a prepreg, an Ajinomoto Build-up Film (ABF), FR-4, bismaleimide triazine (BT), a photoimagable dielectric (PID) resin, a copper clad laminate (CCL) or insulators of glass or ceramic series.

In one or more non-limiting examples, the RF signal may have a format according to Wi-Fi (IEEE 802.11 family, etc.), WiMAX (IEEE 802.16 family, etc.), IEEE 802.20, long term evolution (LTE), Evolution-Data Optimized (EV-DO), high-speed packet access plus (HSPA), high-speed downlink packet access (HSDPA), high-speed uplink packet access (HSUPA), Enhanced Data GSM Evolution (EDGE), Global System for Mobile communication (GSM), Global Positioning System (GPS), General Packet Radio Service (GPRS), Code Division Multiple Access (CDMA), Time Division Multiple Access (TDMA), digital enhanced cordless communication (DECT), Bluetooth, third generation (3G), fourth generation (4G), fifth generation (5G), and other arbitrary wireless and wired protocols designated later, but is not limited thereto.

Hereinafter, various examples are described in detail with reference to accompanying drawings.

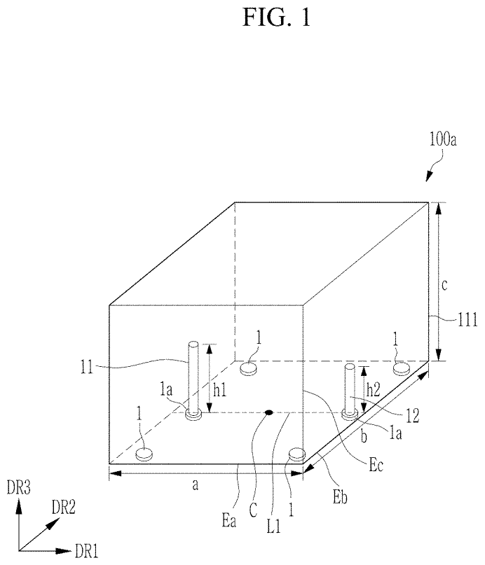

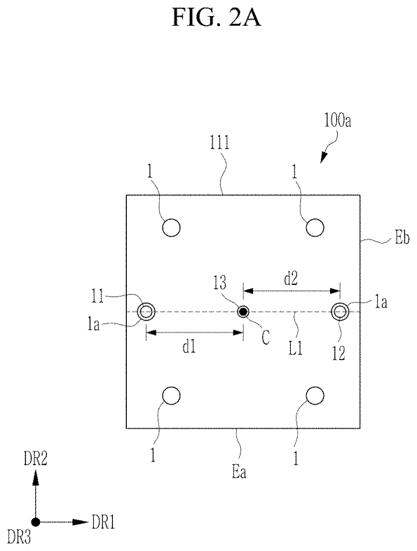

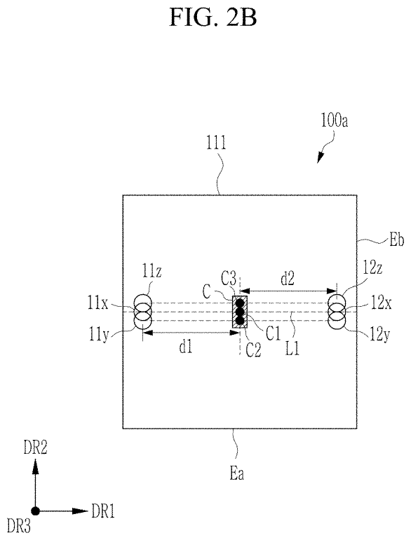

An example dielectric resonator antenna 100a, in accordance with one or more embodiments, is described with reference to FIG. 1, FIG. 2A, and FIG. 2B. FIG. 1 illustrates a perspective view of an example dielectric resonator antenna, in accordance with one or more embodiments, and FIG. 2A and FIG. 2B illustrate top plan views of an example dielectric resonator antenna of FIG. 1, as an example.

Referring to FIG. 1 and FIG. 2A, an example dielectric resonator antenna (DRA) 100a, in accordance with one or more embodiments, may include a dielectric material block 111 having a shape extending along a first direction DR1 and a second direction DR2 different from the first direction DR1, and a third direction DR3 perpendicular to the first direction DR1 and the second direction DR2, a first feed unit 11 and a second feed unit 12 disposed inside the dielectric material block 111, and a plurality of connecting parts 1 and 1a disposed under the dielectric material block 111, that is, attached to the bottom surface of the dielectric material block 111. However, this is only an example, and the plurality of connecting parts 1 and 1a may be disposed in the dielectric material block 111. The part 1a of the plurality of connecting parts 1 and 1a may respectively overlap the first feed unit 11 and the second feed unit 12.

In an example, the dielectric material block 111 may have a rectangular parallelepiped shape, and the dielectric material block 111 may have a via hole into which the first feed unit 11 and the second feed unit 12 are inserted.

The dielectric material block 111 may include a plurality of first sides Ea parallel to the first direction DR1, a plurality of second sides Eb parallel to the second direction DR2, and a plurality of third sides Ec parallel to the third direction DR3. The dielectric material block 111 may have a first length a along the first direction DR1, a second length b along the second direction DR2, and a third length c along the third direction DR3, thereby resulting in the dielectric material block 111 having cuboid shape.

The first feed unit 11 and the second feed unit 12 may be disposed within a portion of the dielectric material block 111 along the third direction DR3.

In a non-limiting example, the first height h1 of the first feed unit 11 measured from the bottom surface of the dielectric material block 111 along the third direction DR3 may be greater than the second height h2 of the second feed unit 12 measured from the bottom surface of the dielectric material block 111 along the third direction DR3.

When an electrical signal is applied to the first feed unit 11 and the second feed unit 12, a resonance of a certain frequency may occur inside the dielectric material block 111, and an RF signal may be transmitted and received according to the resonance frequency of the antenna 100a.

The dielectric resonator antenna 100a may transmit and/or receive an RF signal of a first bandwidth through the first feed unit 11, and may transmit and/or receive an RF signal of a second bandwidth different from the first bandwidth through the second feed unit 12. In an example, a center frequency of the first bandwidth may be lower than the center frequency of the second bandwidth. In a non-limiting example, the center frequency of the first bandwidth may be approximately 24 GHz or approximately 28 GHz, and the center frequency of the second bandwidth may be approximately 39 GHz.

The first feed unit 11 and the second feed unit 12 may pass through the center part C of the bottom surface of the dielectric material block 111 and be disposed to an imaginary first straight line L1 parallel to the first direction DR1, and the first feed unit 11 and the second feed unit 12 may be disposed to be symmetrical with reference to the center part C of the bottom surface of the dielectric material block 111.

In a non-limiting example, the first feed unit 11 and the second feed unit 12 may be disposed adjacent to approximately a central part C of the two second sides Eb. The first feed unit 11 and the second feed unit 12 may face each other along the first direction DR1, and a first interval d1 between the center part C of the bottom surface of the dielectric material block 111 and the first feed unit 11 may be approximately equal to a second interval d2 between the center part C and the second feed unit 12.

Referring to FIG. 2B, when the first feed unit 11 and the second feed unit 12 are disposed to be symmetrical to each other with respect to the first straight line L1, the first feed unit 11 and the second feed unit 12 may not only be disposed on the first positions 11x and 12x where the center of the first feed unit 11 and the second feed unit 12 is disposed on the first straight line L1, but may also be disposed on the second positions 11y and 12y and the third positions 11z and 12z, which are respectively disposed on both sides of the first positions 11x and 12x, and the edge parts of the first feed unit 11 and the second feed via 12 may be disposed on the first straight line L1.

Therefore, the center part C of the bottom surface of the dielectric material block 111 where the first feed unit 11 and the second feed unit 12 are symmetrical to each other does not mean a right center region of the bottom surface of the dielectric material block 111, but the center part C may be a predetermined region that may include all of a symmetrical center part C1 of which the first feed unit 11 and the second feed unit 12 are symmetrical to each other when being disposed on the first positions 11x and 12x, a symmetrical center part C2 of which the first feed unit 11 and the second feed unit 12 are symmetrical to each other when being disposed on the second positions 11y and 12y, and a symmetrical center part C3 of which the first feed unit 11 and the second feed unit 12 are symmetrical to each other when being disposed on the third positions 11z and 12z.

Accordingly, since the first feed unit 11 and the second feed unit 12 may be disposed to be spaced apart from each other so as to be adjacent to the respective edges of the second sides Eb that face each other along the first direction DR1 and symmetrical to each other with reference to the center part C of the bottom surface of the dielectric material block 111, and in the dielectric material block 111, the distribution length of the electric field generated by the electrical signal applied to the first feed unit 11 and the distribution length of the electric field generated by the electrical signal applied to the second feed unit 12 may be increased, respectively, and accordingly, the bandwidth of the RF signal of the first bandwidth and the RF signal of the second bandwidth may be widened without increasing the size of the dielectric material block 111, while the interference between the RF signal of the first bandwidth transmitted and received by the electrical signal applied to the first feed unit 11 and the RF signal of the second bandwidth transmitted and received by the electrical signal applied to the second feed unit 12 may be reduced.

According to the example dielectric resonator antenna 100a, in accordance with one or more embodiments, in the dielectric material block 111, since the first feed unit 11 and the second feed 12 via having the different heights are separately disposed on one straight line to be symmetrical to each other with reference to the center part C of the bottom surface of the dielectric material block 111, and to be adjacent to the edge Eb of the bottom surface of the dielectric material block 111, the RF signals of the different bands may be transmitted and received by implementing one dielectric material block 111, the bandwidths of the RF signal of the first bandwidth and the RF signal of the second bandwidth may be broadened, and the gain of the antenna 100a may be increased by reducing the interference between the RF signals of the first bandwidth and the RF signals of the second bandwidth.

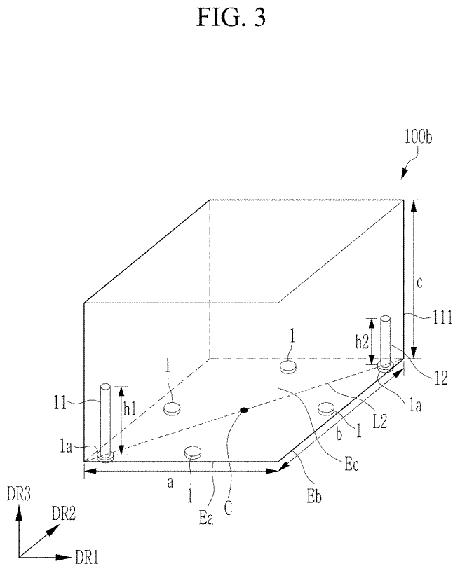

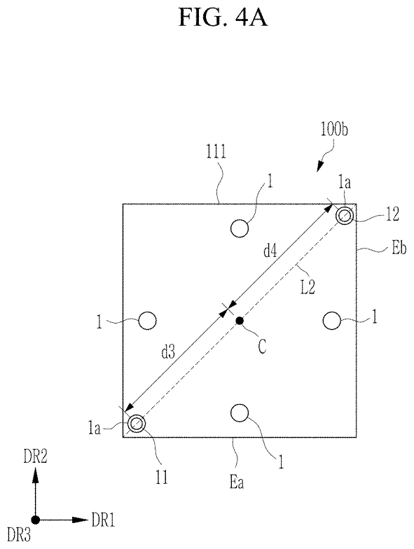

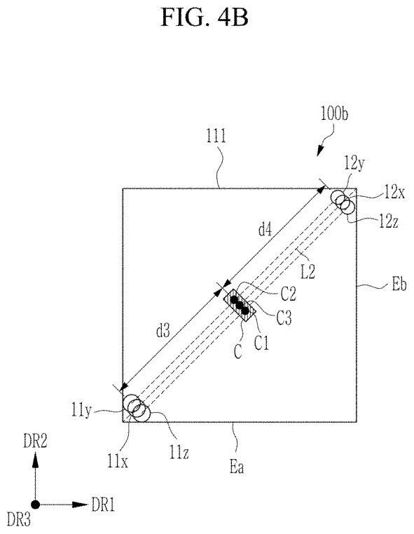

An example dielectric resonator antenna 100b, in accordance with one or more embodiments, is described with reference to FIG. 3, FIG. 4A, and FIG. 4B. FIG. 3 is a perspective view of an example dielectric resonator antenna, in accordance with one or more embodiments, and FIG. 4A and FIG. 4B are top plan views of an example dielectric resonator antenna of FIG. 3.

Referring to FIG. 3 and FIG. 4A, the example dielectric resonator antenna 100b according to the present embodiment is similar to the dielectric resonator antenna 100a according to the embodiment described with reference to FIG. 1, FIG. 2A, and FIG. 2B above. The detailed description of the same constituent element is omitted.

Referring to FIG. 3 and FIG. 4A, the example dielectric resonator antenna 100b, in accordance with one or more embodiments, similarly to the dielectric resonator antenna 100a according to the above-described example, may include a dielectric material block 111, a first feed unit 11 of a first length, and a second feed unit 12 of a second length disposed inside the dielectric material block 111, and a plurality of connecting parts 1 and 1a disposed under the dielectric material block 111, that is, attached to the bottom surface of the dielectric material block 111. In an example, the first length or height of the first feed unit 11 may be different from the second length or height of the second feed unit 12.

The first feed unit 11 and the second feed unit 12 may be disposed within a portion of the dielectric material block 111 along a side of the dielectric material block 111 that is parallel to the third direction DR3.

The first height h1 of the first feed unit 11 measured from the bottom surface of the dielectric material block 111 along the third direction DR3 may be higher than the second height h2 of the second feed unit 12.

The dielectric resonator antenna 100b may transmit and/or receive an RF signal of a first bandwidth through the first feed unit 11, and may transmit and/or receive an RF signal of a second bandwidth different from the first bandwidth through the second feed unit 12. In a non-limiting example, the center frequency of the first bandwidth may be lower than the center frequency of the second bandwidth.

However, in the example dielectric resonator antenna 100b, unlike the dielectric resonator antenna 100a according to the above-described example, the first feed unit 11 and the second feed unit 12 may be disposed on an imaginary second straight line L2 that is a diagonal passing through the center part C of the bottom surface of the dielectric material block 111.

In an example, the first feed unit 11 and the second feed unit 12 may be disposed adjacent to two edges where the first side Ea, parallel to the first direction DR1, and the second side Eb, parallel to the second direction DR2, meet each other.

In an example, the third interval d3 between the center part C of the bottom surface of the dielectric material block 111 and the first feed unit 11 may be approximately equal to the fourth interval d4 between the center part C and the second feed unit 12.

Referring to FIG. 4B, when the first feed unit 11 are the second feed unit 12 are disposed to be symmetrical to each other on the second straight line L2, the first feed unit 11 and the second feed unit 12 may not only be disposed on the first positions 11x and 12x where the center of the first feed unit 11 and the second feed unit 12 is disposed on the second straight line L2, but may also be disposed on the second positions 11y and 12y and the third positions 11z and 12z which are respectively disposed on both sides of the first positions 11x and 12x and the edge parts of the first feed unit 11 and the second feed unit 12 disposed on the second straight line L2.

Therefore, the center part C of the bottom surface of the dielectric material block 111 where the first feed unit 11 and the second feed unit 12 are symmetrical to each other does not mean a right center region of the bottom surface of the dielectric material block 111, but the center part C may be a predetermined region that may include all of a symmetrical center part C1 that the first feed unit 11 and the second feed unit 12 are symmetrical to each other when being disposed on the first positions 11x and 12x, a symmetrical center part C2 that the first feed unit 11 and the second feed unit 12 are symmetrical to each other when being disposed on the second positions 11y and 12y, and a symmetrical center part C3 that the first feed unit 11 and the second feed unit 12 are symmetrical to each other when being disposed on the third positions 11z and 12z.

Accordingly, since the first feed unit 11 and the second feed unit 12 may be disposed on a straight line to be spaced apart from each other to be adjacent to two corners formed by the first side Ea parallel to the first direction DR1 and the second side Eb parallel to the second direction DR2 that meet each other to face each other and to be symmetrical to each other with reference to the center part C of the bottom surface of the dielectric material block 111, the interval between the first feed unit 11 and the second feed unit 12 may be widened.

Therefore, an interference between the RF signal of the first bandwidth transmitted and received by the electrical signal applied to the first feed unit 11, and the RF signal of the second bandwidth transmitted and received by the electrical signal applied to the second feed unit 12 may be reduced. Additionally, in the dielectric material block 111, the distribution length of the electric field generated by the electrical signal applied to the first feed unit 11 and the distribution length of the electric field generated by the electrical signal applied to the second feed unit 12 may be increased, respectively, and accordingly the bandwidth of the RF signal of the first bandwidth and the RF signal of the second bandwidth may be widened without increasing the size of the dielectric material block 111.

In the example dielectric resonator antenna 100b, in accordance with one or more embodiments, in the dielectric material block 111, by disposing the first feed unit 11 and the second feed unit 12 having different heights at the diagonal passing through the center part C to be spaced apart from each other and to be symmetrical to each other with reference to the center part C of the bottom surface of the dielectric material block 111, the RF signals of the different bands may be transmitted and received by implementing one dielectric material block 111, the bandwidths of the RF signals of the first bandwidth and the RF signals of the second bandwidth may be broadened, the gain of the antenna 100b may be increased by reducing the interference between the RF signals of the first bandwidth and the RF signal of the second bandwidth.

Many features of the example antenna described above are applicable to the antenna according to the present example.

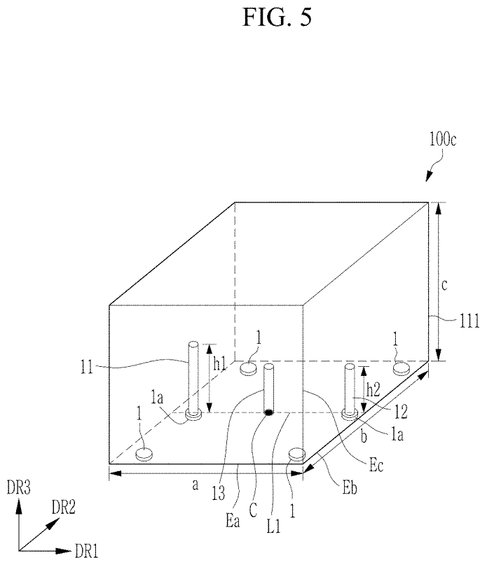

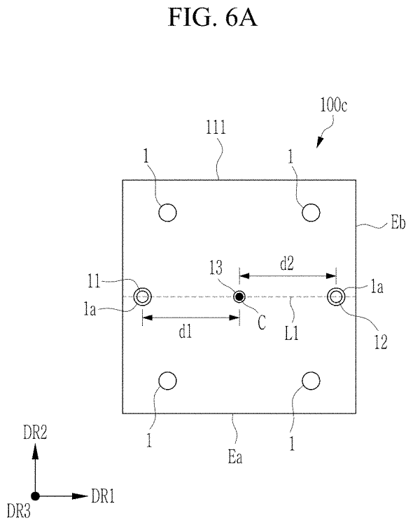

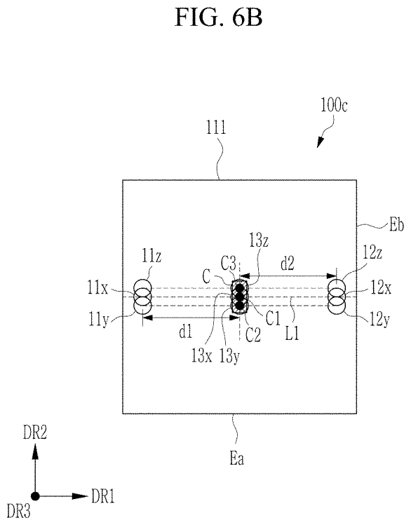

An example dielectric resonator antenna 100c, in accordance with one or more embodiments, is described with reference to FIG. 5, FIG. 6A, and FIG. 6B. FIG. 5 is a perspective view of an example dielectric resonator antenna, in accordance with one or more embodiments, and FIG. 6A and FIG. 6B are top plan views of an example dielectric resonator antenna of FIG. 5.

Referring to FIG. 5, FIG. 6A and FIG. 6B, the example dielectric resonator antenna 100c, in accordance with one or more embodiments, is similar to the example dielectric resonator antenna 100a, in accordance with one or more embodiments, described with reference to FIG. 1, FIG. 2A, and FIG. 2B. The detailed description of the same constituent element will be omitted.

Referring to FIG. 5 and FIG. 6A, the dielectric resonator antenna 100b, in accordance with one or more embodiments, similarly to the example dielectric resonator antenna 100a according to the above-described example, may include a dielectric material block 111, a first feed unit 11, and a second feed unit 12 disposed inside the dielectric material block 111, and a plurality of connecting parts 1 and 1a disposed under the dielectric material block 111, that is, attached to the bottom surface of the dielectric material block 111.

The first feed unit 11 and the second feed unit 12 may be disposed within a portion of the dielectric material block 111 along the third direction DR3.

In an example, the first height h1 of the first feed unit 11 measured from the bottom surface of the dielectric material block 111 along the third direction DR3 may be higher than the second height h2 of the second feed unit 12.

The dielectric resonator antenna 100c may transmit and/or receive the RF signal of a first bandwidth through the first feed unit 11, and may transmit and/or receive the RF signal of a second bandwidth different from the first bandwidth through the second feed unit 12. In an example, the center frequency of the first bandwidth may be lower than the center frequency of the second bandwidth.

The first feed unit 11 and the second feed unit 12 may be disposed adjacent to the center part of the two second sides Eb, and may face each other along the first direction DR1, and may be disposed on the virtual first straight line L1 that passes through the center part C of the bottom surface of the dielectric material block 111 and may be parallel to the first direction DR1, and the first interval d1 between the center part C of the bottom surface of the dielectric material block 111 and the first feed unit 11 may be approximately equal to the second interval d2 between the center part C and the second feed unit 12.

However, in an example, the example dielectric resonator antenna 100c, in accordance with one or more embodiments, may further include a shield via 13 that overlaps the center part C of the bottom surface of the dielectric material block 111, unlike the example dielectric resonator antenna 100a according to the example described above. In an example, the shield via may be a ground via which may for a decoupling parasitic pattern between the respective feed units.

In an example, the shield via 13 may be disposed between the first feed unit 11 and the second feed unit 12. In a non-limiting example, the shield via 13 may be spaced to have an approximately equal interval from the first feed unit 11 and the second feed unit 12, and, in an example, the third height h3 of the shield via 13 measured from the bottom surface of the dielectric material block 111 may be lower than the first height h1 of the first feed unit 11, and may be equal to or higher than the second height h2 of the second feed unit 12. However, the disclosure is not limited thereto, and may include all that the third height h3 of the shield via 13 is equal to or higher than the second height h2 of the second feed unit 12 or lower than the second height h2 of the second feed unit 12.

Referring to FIG. 6B, the center part C of the bottom surface of the dielectric material block 111 where the first feed unit 11 and the second feed unit 12 are symmetrical to each other does not mean a right center region of the bottom surface of the dielectric material block 111, but the center part C may be a predetermined region that may include all of a symmetrical center part C1 that the first feed unit 11 and the second feed unit 12 are symmetrical to each other when being disposed on the first positions 11x and 12x, a symmetrical center part C2 that the first feed unit 11 and the second feed unit 12 are symmetrical to each other when being disposed on the second positions 11y and 12y, and a symmetrical center part C3 that the first feed unit 11 and the second feed unit 12 are symmetrical to each other when being disposed on the third positions 11z and 12z. Additionally, the shield via 13 may be disposed on the center part C of the bottom surface of the dielectric material block 111 including the center parts C1, C2, and C3.

As such, since the example dielectric resonator antenna 100c may further include the shield via 13 disposed between the first feed unit 11 and the second feed unit 12, spaced apart to have an approximately equal interval from the first feed unit 11 and the second feed unit 12, and may have a third height h3 equal to or higher than the second height h2 of the second feed unit 12, the interference between the RF signal of the first bandwidth transmitted and received by the electrical signal applied to the first feed unit 11 and the RF signal of the second bandwidth transmitted and received by the electrical signal applied to the second feed unit 12 may be further reduced.

Additionally, according to the example dielectric resonator antenna 100c, in the dielectric material block 111, by disposing the first feed unit 11 and the second feed unit 12 having the different heights on a straight line to be spaced apart from each other so as to be symmetrical to each other with reference to the center part C of the bottom surface of the dielectric material block 111 and adjacent to the edge of the bottom surface of the dielectric material block 111, RF signals of different bands may be transmitted and received by implementing one dielectric material block 111, the bandwidths of the RF signals of first bandwidth and the RF signals of the second bandwidth may be broadened, and the gain of the antenna 100c may be increased by reducing the interference between the RF signals of first bandwidth and the RF signal of the second bandwidth.

Many features of the example antennas according to the embodiments described above are applicable to the antennas according to the present example.

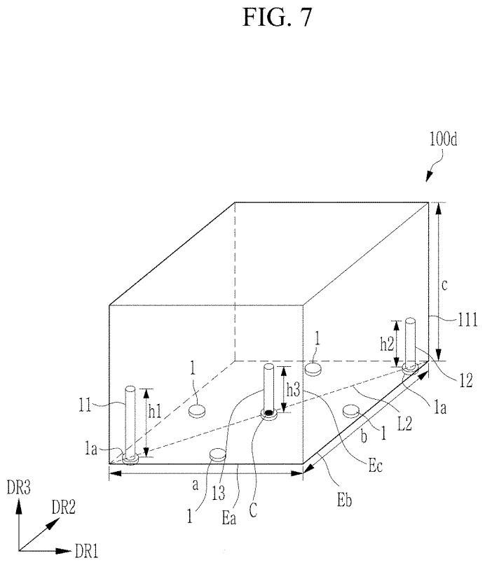

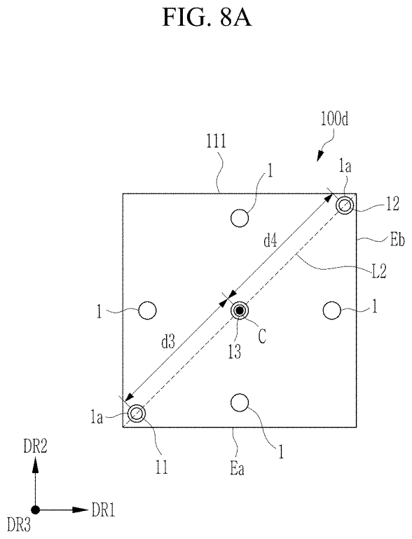

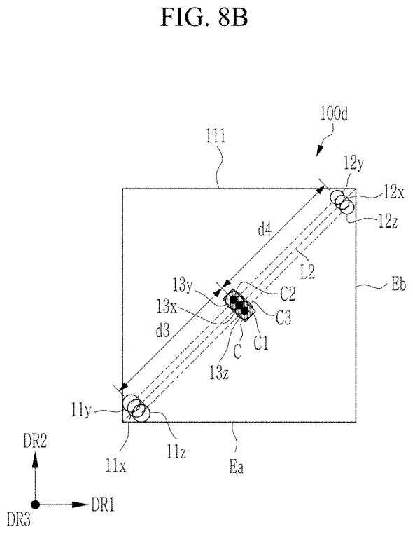

A dielectric resonator antenna 100d according to another embodiment is described with reference to FIG. 7, FIG. 8A, and FIG. 8B. FIG. 7 is a perspective view of a dielectric resonator antenna according to another embodiment, and FIG. 8A and FIG. 8B are top plan views of a dielectric resonator antenna of FIG. 7.

Referring to FIG. 7, FIG. 8A and FIG. 8B, the example dielectric resonator antenna 100d is similar to the example dielectric resonator antenna 100a according to the embodiment described with reference to FIG. 3, FIG. 4A, and FIG. 4B. The detailed description of the same constituent elements will be omitted.

Referring to FIG. 7 and FIG. 8A, the example dielectric resonator antenna 100d, similarly to the example dielectric resonator antenna 100b according to the above-described example, may include a dielectric material block 111, a first feed unit 11, and a second feed unit 12 disposed inside the dielectric material block 111, and a plurality of connecting parts 1 and 1a disposed under the dielectric material block 111, that is, attached to the bottom surface of the dielectric material block 111.

The first feed unit 11 and the second feed unit 12 may be disposed within a portion of the dielectric material block 111 along the third direction DR3.

The first height h1 of the first feed unit 11 measured from the bottom surface of the dielectric material block 111 along the third direction DR3 may be higher than the second height h2 of the second feed unit 12.

The dielectric resonator antenna 100d may transmit and/or receive the RF signal of the first bandwidth through the first feed unit 11, and may transmit and/or receive the RF signal of the second bandwidth which is different from the first bandwidth through the second feed unit 12. In an example, the center frequency of the first bandwidth may be lower than the center frequency of the second bandwidth.

The first feed unit 11 and the second feed unit 12 may overlap an imaginary second straight line L2 that is a diagonal passing through the center part C of the bottom surface of the dielectric material block 111, the first feed unit 11 and the second feed unit 12 may be disposed adjacent to two edges where the first side Ea which is parallel to the first direction DR1 and the second side Eb which is parallel to the second direction DR2 meet each other, and the third interval d3 between the center part C of the bottom surface of the dielectric material block 111 and the first feed unit 11 may be approximately equal to the fourth interval d4 between the center part C and the second feed unit 12.

However, the dielectric resonator antenna 100d according to the present example may further include a shield via 13 that overlaps the center part C of the bottom surface of the dielectric material block 111, unlike the dielectric resonator antenna 100b according to the example described above.

The shield via 13 may be disposed between the first feed unit 11 and the second feed unit 12, the shield via 13 may be spaced apart to have the approximately equal interval from the first feed unit 11 and the second feed unit 12, and the third height h3 of the shield via 13 measured from the bottom surface of the dielectric material block 111 may be lower than the first height h1 of the first feed unit 11 and may be equal to or higher than the second height h2 of the second feed unit 12. However, the disclosure is not limited thereto, and the third height h3 of the shield via 13 may be equal to or higher than the second height h2 of the second feed unit 12, or lower than the second height h2 of the second feed unit 1. Additionally, in an example, the third height h3 of the shield via 13 may be higher than the first height h1 of the first feed unit 11.

Referring to FIG. 8B, the center part C of the bottom surface of the dielectric material block 111 where the first feed unit 11 and the second feed unit 12 are symmetrical to each other does not mean a right center region of the bottom surface of the dielectric material block 111, but the center part C may be a predetermined region that may include all of a symmetrical center part C1 that the first feed unit 11 and the second feed unit 12 are symmetrical to each other when being disposed on the first positions 11x and 12x, a symmetrical center part C2 that the first feed unit 11 and the second feed unit 12 are symmetrical to each other when being disposed on the second position 11y and 12y, and a symmetrical center part C3 that the first feed unit 11 and the second feed unit 12 are symmetrical to each other when being disposed on the third position 11z and 12z. Additionally, the shield via 13 may be disposed on the center part C of the bottom surface of the dielectric material block 111 including the center parts C1, C2, and C3.

As such, since the dielectric resonator antenna 100d according to the present embodiment may further include the shield via 13 disposed between the first feed unit 11 and the second feed unit 12, and spaced apart to have the approximately equal interval from the first feed unit 11 and the second feed unit 12, and may have a third height h3 equal to or higher than the second height h2 of the second feed unit 12, the interference between the RF signal of the first bandwidth transmitted and received by the electrical signal applied to the first feed unit 11 and the RF signal of the second bandwidth transmitted and received by the electrical signal applied to the second feed unit 12 may be further reduced.

In addition, according to the dielectric resonator antenna 100d according to the present embodiment, by disposing the first feed unit 11 and the second feed unit 12 of different heights to be spaced apart from each other on the diagonal passing through the center part C in the dielectric material block 111 so as to be symmetrical to each other with reference to the center part C of the bottom surface of the dielectric material block 111, the RF signals of different bands may be transmitted and received by implementing one dielectric material block 111, and the bandwidths of the RF signal of the first bandwidth and the RF signal of the second bandwidth may be widened, and the gain of antenna 100d may be increased by reducing interference between the RF signal of the first bandwidth and the RF signal of the second bandwidth.

Many features of the antennas according to the examples described above are applicable to the antennas according to the present example.

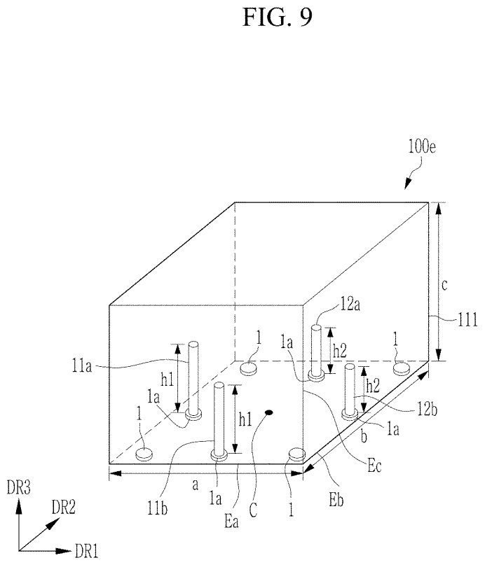

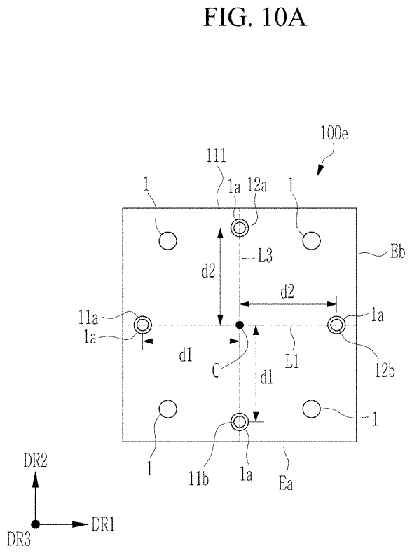

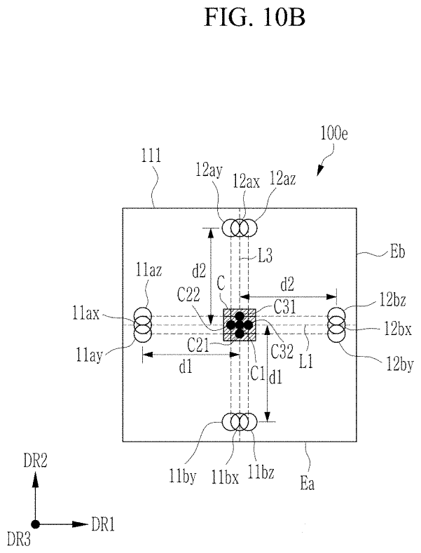

An example dielectric resonator antenna 100e, in accordance with one or more embodiments, is described with reference to FIG. 9, FIG. 10A, and FIG. 10B. FIG. 9 is a perspective view of an example dielectric resonator antenna, in accordance with one or more embodiments, and FIG. 10A and FIG. 10B are top plan views of an example dielectric resonator antenna of FIG. 9.

Referring to FIG. 9, FIG. 10A, and FIG. 10B, the example dielectric resonator antenna 100e, in accordance with one or more embodiments, is similar to the dielectric resonator antenna 100a according to the example described with reference to FIG. 1, FIG. 2A, and FIG. 2B. The detailed description of the same constituent elements will be omitted.

Referring to FIG. 9 and FIG. 10A, the example dielectric resonator antenna 100e, in accordance with one or more embodiments, may include a plurality of feed units 11a, 11b, 12a, and 12b disposed in the dielectric material block 111 and a plurality of connecting parts 1 and 1a attached to the bottom surface of the dielectric material block 111.

Different from the example dielectric resonator antenna 100a according to the above-described example, the example dielectric resonator antenna 100e according to the present example may include feed units or vias 11a, 11b, 12a, and 12b including a first feed unit or via 11a, a second feed unit or via 11b, a third feed unit or via 12a, and a fourth feed unit or via 12b disposed inside the dielectric material block 111.

The first feed unit 11a, the second feed unit 11b, the third feed unit 12a, and the fourth feed unit 12b may be disposed within a portion of the dielectric material block 111 along the third direction DR3.

The first feed unit 11a and the second feed unit 11b may have a first height h1 measured from the bottom surface of the dielectric material block 111 along the third direction DR3, and the third feed unit 12a and the fourth feed unit 12b may have a second height h2, and the first height h1 may be higher than the second height h2. However, this is only an example, and the first feed unit 11a and the second feed unit 11b may have different heights from each other, and the third feed unit 12a and the fourth feed unit 12b may have different heights from each other.

The dielectric resonator antenna 100e may transmit and/or receive a first polarization RF signal of a first bandwidth through the first feed unit 11a, and may transmit and/or receive a second polarization RF signal of a first bandwidth through the second feed unit 11b. Similarly, the dielectric resonator antenna 100e may transmit and/or receive a first polarization RF signal of a second bandwidth through the third feed unit 12a, and may transmit and/or receive a second polarization RF signal of a second bandwidth through the fourth feed unit 12b.

The center frequency of the first bandwidth may be lower than the center frequency of the second bandwidth, the first polarization may be horizontal polarization, and the second polarization may be vertical polarization.

The first feed unit 11a, the second feed unit 11b, the third feed unit 12a, and the fourth feed unit 12b may be disposed approximately adjacent to a center part of four sides respectively parallel to the first direction DR1 and the second direction DR2 of the dielectric material block 111, and the first feed unit 11a, the second feed unit 11b, the third feed unit 12a, and the fourth feed unit 12b may overlap the first straight line L1 and the third straight line L3 passing through the center part C of the bottom surface of the dielectric material block 111 and parallel to the first direction DR1 and the second direction DR2. The first feed unit 11a, the second feed unit 11b, the third feed unit 12a, and the fourth feed unit 12b may be disposed at four positions, that is, up, down, left, and right with reference to the center part C of the bottom surface of the dielectric material block 111.

A first interval d1 may be formed between the center part C of the bottom surface of the dielectric material block 111 and the first feed unit 11a, and between the center part C and the second feed unit 11b, and a second interval d2 may be formed between the center part C and the third feed unit 12a and between the center part C and the fourth feed unit 12b, and the first interval d1 and the second interval d2 may be approximately equal.

In an example, the first feed unit 11a and the fourth feed unit 12b may be disposed to be symmetrical to each other with reference to the center part C of the bottom surface along the first direction DR1, and the second feed unit 11b and the third feed unit 12a may be disposed to be symmetrical to each other with reference to the center part C of the bottom surface along the second direction DR2.

Referring to FIG. 10B, when the first feed unit 11a and the fourth feed unit 12b are disposed to be symmetrical to each other with regard to the first straight line L1, the first feed unit 11a and the fourth feed unit 12b may not only be disposed on the first positions 11ax and 12bx where the centers of the first feed unit 11a and the fourth feed unit 12b are disposed on the first straight line L1, but also the second positions 11ay and 12by and the third positions 11az and 12bz which are disposed on both sides of the first positions 11ax and 12bx and the edge parts of the first feed unit 11a and the fourth feed unit 12b are disposed on the first straight line L1. Simultaneously, when the second feed unit 11b and the third feed unit 12a are disposed to be symmetrical to each other to the third straight line L3, the second feed unit 11b and the third feed unit 12a may not only be disposed on the fourth positions 11bx and 12ax where the centers of the second feed unit 11b and the third feed unit 12a are disposed on the third straight line L3, but also the fifth positions 11by and 12ay and the sixth positions 11bz and 12az which are disposed on both sides of the fourth positions 11bx and 12ax and the edge parts of the second feed unit 11b and the third feed unit 12a are disposed on the third straight line L3.

Therefore, the center part C of the bottom surface of the dielectric material block 111 where the first feed unit 11a and the fourth feed unit 12b are symmetrical to each other does not mean the right center region of the bottom surface of the dielectric material block 111, but the center part C may be a predetermined region that may include all of a symmetrical center part C1 that the first feed unit 11a and the fourth feed unit 12b are symmetrical to each other when being disposed on the first positions 11ax and 12bx, a symmetrical center part C21 that the first feed unit 11a and the fourth feed unit 12b are symmetrical to each other when being disposed on the second positions 11ay and 12by, a symmetrical center part C31 that the first feed unit 11a and the fourth feed unit 12b are symmetrical to each other when being disposed on the third positions 11az and 12bz, a symmetrical center part C22 that the second feed unit 11b and the third feed unit 12a are symmetrical to each other when being disposed on the fifth positions 11by and 12ay, and a symmetrical center part C32 that the second feed unit 11b and the third feed unit 12a are symmetrical to each other when being disposed on the sixth positions 11bz and 12az.

Accordingly, since the first feed unit 11a, the second feed unit 11b, the third feed unit 12a, and the fourth feed unit 12b may be disposed to be spaced apart from each other so as to be adjacent to the first side Ea which is parallel to the first direction DR1 and the second side Eb which is parallel to the second direction DR2 and to be symmetrical to each other with reference to the center part C of the bottom surface of the dielectric material block 111 on the imaginary first straight line L1 and third straight line L3 passing through the center part C of the bottom surface of the dielectric material block 111 and parallel to the first direction DR1 and the second direction DR2, the interval between the first feed unit 11a, the second feed unit 11b, the third feed unit 12a, and the fourth feed unit 12b may be widened.

Therefore, the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be reduced, the interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and the interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Additionally, in the dielectric material block 111, the distribution length of the electric field generated by the electrical signal applied to the first feed unit 11a and the second feed unit 11b and the distribution length of the electric field generated by the electrical signal applied to the third feed unit 12a and the fourth feed unit 12b may be largely formed, so the bandwidth of the first polarization RF signal and the second polarization RF signal of the first bandwidth and the first polarization RF signal and the second polarization RF signal of the second bandwidth may be widened without increasing the size of the dielectric material block 111.

According to the example dielectric resonator antenna 100e, in accordance with the present example, by differently forming the heights of the first feed unit 11a and the second feed unit 11b, and the third feed unit 12a and the fourth feed unit 12b in the dielectric material block 111, and disposing the first feed unit 11a, the second feed unit 11b, the third feed unit 12a, and the fourth feed unit 12b to be spaced apart from each other on the first straight line L1 and the third straight line L3 passing the center part C so as to be symmetrical to each other with reference to the center part C of the bottom surface, the RF signals of the different bands may be transmitted and received by implementing one dielectric material block 111, the bandwidth of the first polarization RF signal and the second polarization RF signal of the first bandwidth and the first polarization RF signal and the second polarization RF signal of the second bandwidth may be broadened, and the gain of the antenna 100e may be increased by reducing the interference between the first polarization RF signal and the second polarization RF signal of the first bandwidth and the first polarization RF signal and the second polarization RF signal of the second bandwidth.

Many features of the example antenna described above are applicable to the antenna according to the present example.

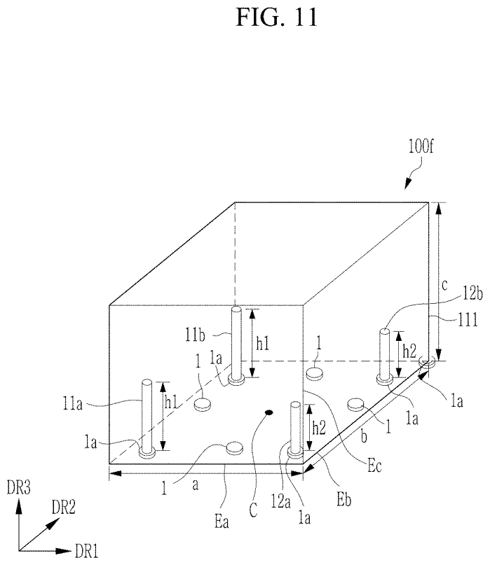

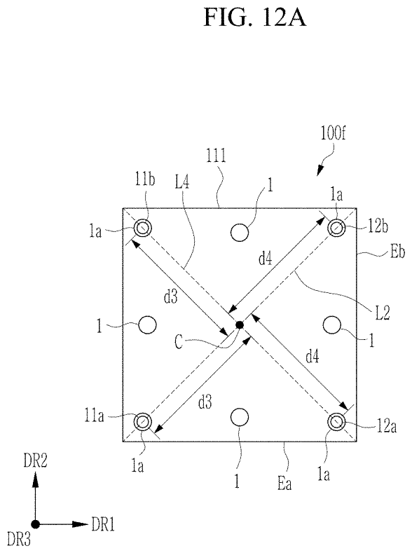

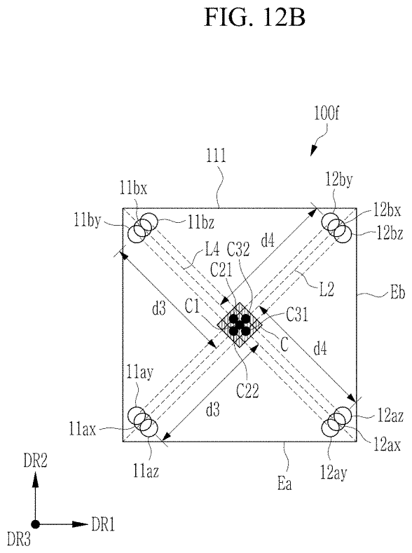

An example dielectric resonator antenna 100f according to an embodiment is described with reference to FIG. 11, FIG. 12A, and FIG. 12B. FIG. 11 is a perspective view of a dielectric resonator antenna according to another embodiment, and FIG. 12A and FIG. 12B are top plan views of a dielectric resonator antenna of FIG. 11.

Referring to FIG. 11, FIG. 12A, and FIG. 12B, the dielectric resonator antenna 100f according to the present embodiment is similar to the dielectric resonator antenna 100e according to the embodiment described with reference to FIG. 9, FIG. 10A, and FIG. 10B above. The detailed description for the same constituent elements is omitted.

Referring to FIG. 11 and FIG. 12A, the example dielectric resonator antenna 100f, in accordance with the present example, may include a plurality of feed units 11a, 11b, 12a, and 12b disposed inside the dielectric material block 111 and a plurality of connecting parts 1 and 1a attached to the bottom surface of the dielectric material block 111.

The first feed unit 11a and the second feed unit 11b may have a first height h1 measured from the bottom surface of the dielectric material block 111 along the third direction DR3, the third feed unit 12a and the fourth feed unit 12b may have a second height h2, and, in an example, the first height h1 may be higher than the second height h2.

The dielectric resonator antenna 100f may transmit and/or receive the first polarization RF signal of the first bandwidth through the first feed unit 11a and may transmit and/or receive the second polarization RF signal of the first bandwidth through the second feed unit 11b. Similarly, the dielectric resonator antenna 100e may transmit and/or receive the first polarization RF signal of the second bandwidth through the third feed unit 12a and may transmit and/or receive the second polarization RF signal of the second bandwidth through the fourth feed unit 12b.

In an example, the center frequency of the first bandwidth may be lower than the center frequency of the second bandwidth, and in an example, the first polarization may be horizontal polarization, and the second polarization may be vertical polarization.

The first feed unit 11a, the second feed unit 11b, the third feed unit 12a, and the fourth feed unit 12b may overlap the second straight line L2 and the fourth straight line L4, which are the diagonals passing through the center part C of the bottom surface of the dielectric material block 111 and passing through the corner portion formed by the intersection of the two first sides Ea and the two second sides Eb. The first feed unit 11a, the second feed unit 11b, the third feed unit 12a, and the fourth feed unit 12b may be symmetrically disposed at four corners with reference to the center part C of the bottom surface of the dielectric material block 111.

A third interval d3 may be formed between the center part C of the bottom surface of the dielectric material block 111 and the first feed unit 11a and between the center part C and the second feed unit 11b, a fourth interval d4 may be formed between the center part C and the third feed unit 12a and between the center part C and the fourth feed unit 12b, and the third interval d3 and the fourth interval d4 may be almost the same.

The first feed unit 11a and the fourth feed unit 12b may disposed to be symmetrical to each other with reference to the center part C of the bottom surface, and the second feed unit 11b and the third feed unit 12a may be disposed to be symmetrical to each with reference to the center part C of the bottom surface.

Referring to FIG. 12B, when disposing the first feed unit 11a and the fourth feed unit 12b to be symmetrical to each other on the second straight line L2, the first feed unit 11a and the fourth feed unit 12b may not only be disposed on the first positions 11ax and 12bx where the center of the first feed unit 11a and the fourth feed unit 12b is disposed on the second straight line L2, but may also be disposed on the second positions 11ay and 12by and the third positions 11az and 12bz which are disposed on both sides of the first positions 11ax and 12bx, and the edge parts of the first feed unit 11a and the fourth feed unit 12b are disposed on the second straight line L2. Simultaneously, when the second feed unit 11b and the third feed unit 12a are disposed to be symmetrical to each other to the fourth straight line L4, the second feed unit 11b and the third feed unit 12a may not only be disposed on the fourth positions 11bx and 12ax where the centers of the second feed unit 11b and the third feed unit 12a are disposed on the fourth straight line L4, but may also be disposed on the fifth positions 11by and 12ay and the sixth positions 11bz and 12az which are disposed on both sides of the fourth positions 11bx and 12ax, and the edge parts of the second feed unit 11b and the third feed unit 12a are disposed on the fourth straight line L4.

Therefore, the center part C of the bottom surface of the dielectric material block 111 where the first feed unit 11a and the fourth feed unit 12b are symmetrical to each other does not mean the right center region of the bottom surface of the dielectric material block 111, but the center part C may be a predetermined region that may include all of a symmetrical center part C1 that the first feed unit 11a and the fourth feed unit 12b are is symmetrical to each other when being disposed on the first positions 11ax and 12bx, a symmetrical center part C21 that the first feed unit 11a and the fourth feed unit 12b are symmetrical to each other when being disposed on the second positions 11ay and 12by, a symmetrical center part C31 that the first feed unit 11a and the fourth feed unit 12b are symmetrical to each other when being disposed on the third positions 11az and 12bz, a symmetrical center part C22 that the second feed unit 11b and the third feed unit 12a are symmetrical to each other when being disposed on the fifth positions 11by and 12ay, and a symmetrical center part C32 that the second feed unit 11b and the third feed unit 12a are symmetrical to each other when being disposed on the sixth positions 11bz and 12az.

Accordingly, by disposing the first feed unit 11a, the second feed unit 11b, the third feed unit 12a, and the fourth feed unit 12b to be spaced apart from each other on the second straight line L2 and the fourth straight line L4 which pass through the center part C of the bottom surface of the dielectric material block 111 and are two diagonal lines so as to be respectively adjacent to four corners formed by the intersection of the first side Ea parallel to the first direction DR1 and the second side Eb parallel to the second direction DR2 and to be symmetrical to each other with reference to the center part C of the bottom surface of the dielectric material block 111, the interval between the first feed unit 11a, the second feed unit 11b, the third feed unit 12a, and the fourth feed unit 12b may be further widened without increasing the size of the dielectric material block 111.

Therefore, the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be reduced. Additionally, in the dielectric material block 111, the distribution length of the electric field generated by the electrical signal applied to the first feed unit 11a and the second feed unit 11b and the distribution length of the electric field generated by the electrical signal applied to the third feed unit 12a and the fourth feed unit 12b may be largely formed, so the bandwidth of the first polarization RF signal and the second polarization RF signal of the first bandwidth and the first polarization RF signal and the second polarization RF signal of the second bandwidth may be widened without increasing the size of the dielectric material block 111.

According to the example dielectric resonator antenna 100f, in accordance with one or more embodiments, by forming the first feed unit 11a and the second feed unit 11b to have a first height, and forming the third feed unit 12a and the fourth feed unit 12b to have a second height, in the dielectric material block 111, and by disposing the first feed unit 11a, the second feed unit 11b, the third feed unit 12a, and the fourth feed unit 12b to be spaced apart from each other on the second straight line L2 and the fourth straight line L4 of two diagonals passing through the center part C so as to be symmetrical to each other with reference to the center part C of the bottom surface, the RF signals of the different bands may be transmitted and received by implementing one dielectric material block 111, the bandwidth of the first polarization RF signal and the second polarization RF signal of the first bandwidth and the first polarization RF signal and the second polarization RF signal of the second bandwidth may be broadened, and the gain of the antenna 100f may be increased by reducing the interference between the first polarization RF signal and the second polarization RF signal of the first bandwidth and the first polarization RF signal and the second polarization RF signal of the second bandwidth.

Many features of the example antenna according to the example described above are applicable to the example antenna according to the present example.

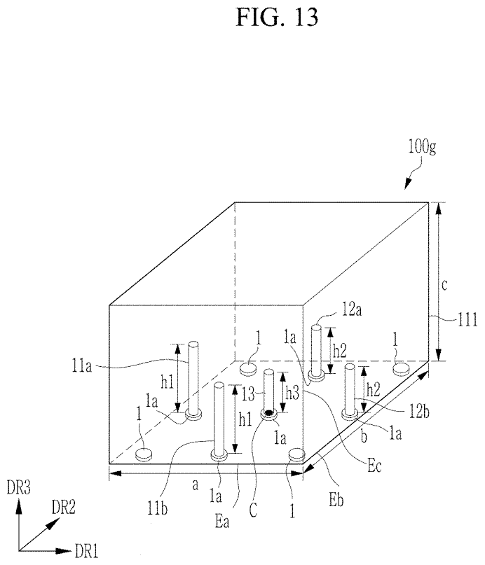

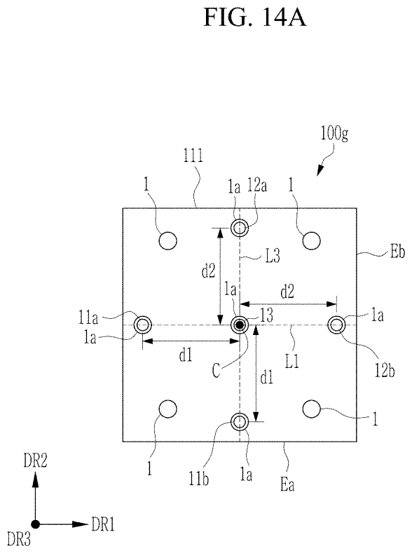

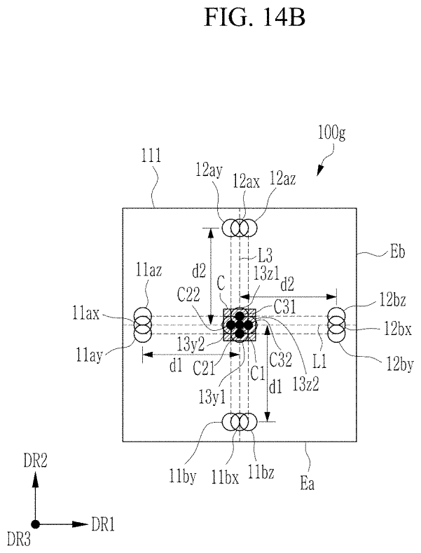

An example dielectric resonator antenna 100g, in accordance with one or more embodiments, is described with reference to FIG. 13, FIG. 14A, and FIG. 14B. FIG. 13 is a perspective view of an example dielectric resonator antenna, in accordance with one or more embodiments, and FIG. 14A and FIG. 14B are top plan views of an example dielectric resonator antenna of FIG. 13.

Referring to FIG. 13, FIG. 14A, and FIG. 14B, the example dielectric resonator antenna 100g, in accordance with one or more embodiments, is similar to the example dielectric resonator antenna 100e, in accordance with one or more embodiments described with reference to FIG. 9, FIG. 10A, and FIG. 10B above. The detailed description for the same constituent elements is omitted.

Referring to FIG. 13 and FIG. 14A, the example dielectric resonator antenna 100g, in accordance with one or more embodiments, may include a plurality of feed units 11a, 11b, 12a, and 12b disposed inside the dielectric material block 111 and a plurality of connecting parts 1 and 1a attached to the bottom surface of the dielectric material block 111.

The first feed unit 11a and the second feed unit 11b may each have a first height h1 measured from the bottom surface of the dielectric material block 111 along the third direction DR3, the third feed unit 12a and the fourth feed unit 12b may each have a second height h2, and in an example, the first height h1 may be higher than the second height h2.

The dielectric resonator antenna 100g may transmit and/or receive the first polarization RF signal of the first bandwidth through the first feed unit 11a and may transmit and/or receive the second polarization RF signal of the first bandwidth through the second feed unit 11b. Similarly, the dielectric resonator antenna 100e may transmit and/or receive the first polarization RF signal of the second bandwidth through the third feed unit 12a and may transmit and/or receive the second polarization RF signal of the second bandwidth through the fourth feed unit 12b.

In an example, the center frequency of the first bandwidth may be lower than the center frequency of the second bandwidth, the first polarization may be horizontal polarization, and the second polarization may be vertical polarization.

The first feed unit 11a, the second feed unit 11b, the third feed unit 12a, and the fourth feed unit 12b may be disposed adjacent to an approximately central part of four sides parallel to the first direction DR1 and the second direction DR2 of the dielectric material block 111, and the first feed unit 11a, the second feed unit 11b, the third feed unit 12a, and the fourth feed unit 12b, may overlap the first straight line L1 and the third straight line L3 passing through the center part C of the bottom surface of the dielectric material block 111 and parallel to the first direction DR1 and the second direction DR2. The first feed unit 11a, the second feed unit 11b, the third feed unit 12a, and the fourth feed unit 12b may be disposed at four positions, that is, up, down, left, and right with reference to the center part C of the bottom surface of the dielectric material block 111.

Referring to FIG. 14A, in an example, a first interval d1 may be formed between the center part C of the bottom surface of the dielectric material block 111 and the first feed unit 11a, and between the center part C and the second feed unit 11b, and a second interval d2 may be formed between the center part C and the third feed unit 12a and between the center part C and the fourth feed unit 12b. In an example, the first interval d1 and the second interval d2 may be approximately equal to each other.

The first feed unit 11a and the fourth feed unit 12b may be disposed to be symmetrical to each other with reference to the center part C of the bottom surface along the first direction DR1, and the second feed unit 11b and the third feed unit 12a may be disposed to be symmetrical to each other with reference to the center part C of the bottom surface along the second direction DR2.

Accordingly, by disposing the first feed unit 11a, the second feed unit 11b, the third feed unit 12a, and the fourth feed unit 12b to be spaced apart from each other on the imaginary first straight line L1 and the imaginary third straight line L3 passing through the center part C of the bottom surface of the dielectric material block 111 and parallel to the first direction DR1 and the second direction DR2 so as to be respectively adjacent to the first side Ea which is parallel to the first direction DR1 and the second side Eb which is parallel to the second direction DR2 and to be symmetrical to each other with reference to the center part C of the bottom surface of the dielectric material block 111, the interval between the first feed unit 11a, the second feed unit 11b, the third feed unit 12a, and the fourth feed unit 12b may be widened.

Therefore, the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be reduced. Additionally, in the dielectric material block 111, the distribution length of the electric field generated by the electrical signal applied to the first feed unit 11a and the second feed unit 11b and the distribution length of the electric field generated by the electrical signal applied to the third feed unit 12a and fourth feed unit 12b may be largely formed, so the bandwidth of the first polarization RF signal and the second polarization RF signal of the first bandwidth and the first polarization RF signal and the second polarization RF signal of the second bandwidth may be widened without increasing the size of the dielectric material block 111.

However, in an example, the dielectric resonator antenna 100g, in accordance with one or more embodiments, may further include a shield via 13 that overlaps the center part C of the bottom surface of the dielectric material block 111, unlike the dielectric resonator antenna 100e according to the example described above.

The shield via 13 may be disposed at a center region C between the first feed unit 11a and the fourth feed unit 12b, and between the second feed unit 11b and the third feed unit 12a. In an example, the shield via 13 may be spaced apart from the first feed unit 11a, the second feed unit 11b, the third feed unit 12a, and the fourth feed unit 12b to have approximately a same interval from the first feed unit 11a, the second feed unit 11b, the third feed unit 12a, and the fourth feed unit 12b. In an example, the third height h3 of the shield via 13 measured from the bottom surface of the dielectric material block 111 may be lower than the first height h1 of the first feed unit 11a and the second feed unit 11b, and may be equal to or higher than the second height h2 of the third feed unit 12a and the fourth feed unit 12b. However, this is only an example, and the third height h3 of the shield via 13 may be greater than the first height h1 of the first feed unit 11a and the second feed unit 11b, and may be less than the second height h2 of the third feed unit 12a and the fourth feed unit 12b.

Referring to FIG. 14B, similarly to that described with reference to FIG. 10B above, the center part C of the bottom surface of the dielectric material block 111 where the first feed unit 11a and the fourth feed unit 12b are symmetrical to each other does not mean the right center region of the bottom surface of the dielectric material block 111, but the center part C may be a predetermined region that may include all of a symmetrical center part C1 that the first feed unit 11a and the fourth feed unit 12b are symmetrical to each other when being disposed on the first positions 11ax and 12bx, a symmetrical center part C21 that the first feed unit 11a and the fourth feed unit 12b are symmetrical to each other when being disposed on the second positions 11ay and 12by, a symmetrical center part C31 that the first feed unit 11a and the fourth feed unit 12b are symmetrical to each other when being disposed on the third positions 11az and 12bz, a symmetrical center part C22 that the second feed unit 11b and the third feed unit 12a are symmetrical to each other when being disposed on the fifth positions 11by and 12ay, and a symmetrical center part C32 that the second feed unit 11b and the third feed unit 12a are symmetrical to each other when being disposed on the sixth positions 11bz and 12az. Additionally, the shield via 13 may be disposed at the center part C of the bottom surface of the dielectric material block 111 including the center parts C1, C21, C31, C22, and C32.

Accordingly, since the example dielectric resonator antenna 100h may further include the shield via 13 disposed between the first feed unit 11a and the fourth feed unit 12b, and between the second feed unit 11b and the third feed unit 12a, and the shield via 13 may be separated from the first feed unit 11a, the second feed unit 11b, the third feed unit 12a, and the fourth feed unit 12b to have almost a same interval between the first feed unit 11a, the second feed unit 11b, the third feed unit 12a, and the fourth feed unit 12b, and since the third height h3 of the shield via 13 may be equal to or higher than the second height h2 of the third feed unit 12a and the fourth feed unit 12b, the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b may be additionally reduced.

According to the example dielectric resonator antenna 100h, in accordance with one or more embodiments, by differently forming the heights of the first feed unit 11a and the second feed unit 11b, and the third feed unit 12a and the fourth feed unit 12b, in the dielectric material block 111, and disposing the first feed unit 11a, the second feed unit 11b, the third feed unit 12a, and the fourth feed unit 12b to be spaced apart from each other on the first straight line L1 and the third straight line L3 passing through the center part C so as to be symmetrical to each other with reference to the center part C of the bottom surface, the RF signals of the different bands may be transmitted and received by implementing one dielectric material block 111, the bandwidth of the first polarization RF signal and the second polarization RF signal of the first bandwidth, and the first polarization RF signal and the second polarization RF signal of the second bandwidth may be broadened, and the gain of the antenna 100g may be increased by reducing the interference between the first polarization RF signal and the second polarization RF signal of the first bandwidth and the first polarization RF signal and the second polarization RF signal of the second bandwidth.

Additionally, since the example dielectric resonator antenna 100g according to the present example may further include the shield via 13, the interference between the first polarization RF signal and the second polarization RF signal of the first bandwidth transmitted and received by the electrical signal applied to the first feed unit 11a and the second feed unit 11b, and first polarization RF signal and the second polarization RF signal of the second bandwidth transmitted and received by the electrical signal applied to the third feed unit 12a and the fourth feed unit 12b, may be additionally reduced.

Many features of the example antenna according to the example described above are applicable to the example antenna according to the present example.

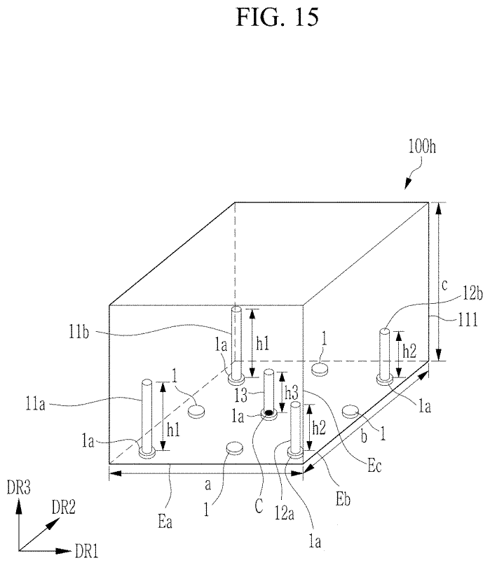

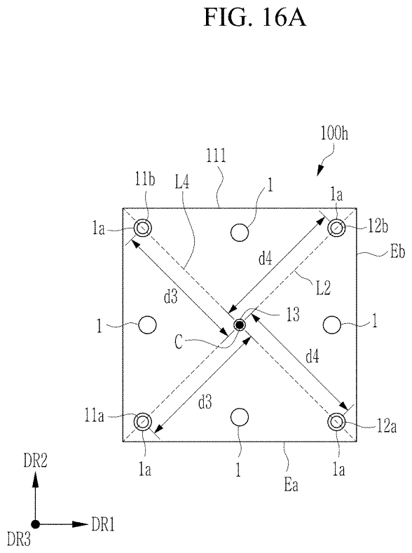

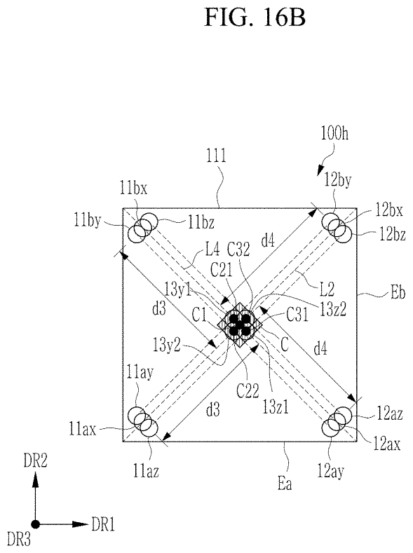

An example dielectric resonator antenna 100h, in accordance with one or more embodiments, is described with reference to FIG. 15, FIG. 16A, and FIG. 16B. FIG. 15 is a perspective view of an example dielectric resonator antenna, in accordance with one or more embodiments, and FIG. 16A and FIG. 16B are top plan views of an example dielectric resonator antenna of FIG. 11.

Referring to FIG. 15, FIG. 16A, and FIG. 16B, the example dielectric resonator antenna 100h, in accordance with one or more embodiments, is similar to the example dielectric resonator antenna 100f according to the example described with reference to FIG. 11, FIG. 12A, and FIG. 12B above. The detailed description for the same constituent elements is omitted.

Referring to FIG. 15 and FIG. 16A, the example dielectric resonator antenna 100h, in accordance with one or more embodiments, may include a plurality of feed units 11a, 11b, 12a, and 12b disposed inside the dielectric material block 111 and a plurality of connecting parts 1 and 1a attached to the bottom surface of the dielectric material block 111.

The first feed unit 11a and the second feed unit 11b may have a first height h1 measured from the bottom surface of the dielectric material block 111 along the third direction DR3, the third feed unit 12a and the fourth feed unit 12b may have a second height h2. In an example, the first height h1 may be higher than the second height h2.

The dielectric resonator antenna 100h may transmit and/or receive the first polarization RF signal of the first bandwidth through the first feed unit 11a and may transmit and/or receive the second polarization RF signal of the first bandwidth through the second feed unit 11b. Similarly, the dielectric resonator antenna 100h may transmit and/or receive the first polarization RF signal of the second bandwidth through the third feed unit 12a and may transmit and/or receive the second polarization RF signal of the second bandwidth through the fourth feed unit 12b.

In an example, the center frequency of the first bandwidth may be lower than the center frequency of the second bandwidth, the first polarization may be horizontal polarization, and the second polarization may be vertical polarization.

The first feed unit 11a, the second feed unit 11b, the third feed unit 12a, and the fourth feed unit 12b may overlap the second straight line L2 and the fourth straight line L4, which are the diagonals passing through the center part C of the bottom surface of the dielectric material block 111 and passing through the corner portion formed by the intersection of the two first sides Ea and the two second sides Eb. The first feed unit 11a, the second feed unit 11b, the third feed unit 12a, and the fourth feed unit 12b may be symmetrically disposed at four corners with reference to the center part C of the bottom surface of the dielectric material block 111.

A third interval d3 may be formed between the center part C of the bottom surface of the dielectric material block 111 and the first feed unit 11a, and between the center part C and the second feed unit 11b, a fourth interval d4 may be formed between the center part C and the third feed unit 12a, and between the center part C and the fourth feed unit 12b, and in an example, the third interval d3 and the fourth interval d4 may be approximately the same.

The first feed unit 11a and the fourth feed unit 12b may be disposed to be symmetrical to each other with reference to the center part C of the bottom surface, and the second feed unit 11b and the third feed unit 12a may be disposed to be symmetrical to each with reference to the center part C of the bottom surface.

Accordingly, by disposing the first feed unit 11a, the second feed unit 11b, the third feed unit 12a, and the fourth feed unit 12b to be spaced apart from each other on the second straight line L2 and the fourth straight line L4 which are two diagonal lines passing through the center part C, so as to be respectively adjacent to four corners formed by the intersection of the first side Ea parallel to the first direction DR1 and the second side Eb parallel to the second direction DR2 and to be symmetrical to each other with reference to the center part C of the bottom surface of the dielectric material block 111, the interval between the first feed unit 11a, the second feed unit 11b, the third feed unit 12a, and the fourth feed unit 12b may be further widened without increasing the size of the dielectric material block 111.

Therefore, the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be reduced. Additionally, in the dielectric material block 111, the distribution length of the electric field generated by the electrical signal applied to the first feed unit 11a and the second feed unit 11b and the distribution length of the electric field generated by the electrical signal applied to the third feed unit 12a and the fourth feed unit 12b may be largely formed, so the bandwidth of the first polarization RF signal and the second polarization RF signal of the first bandwidth and the first polarization RF signal and the second polarization RF signal of the second bandwidth may be widened without increasing the size of the dielectric material block 111.

However, the example dielectric resonator antenna 100h, in accordance with one or more embodiments, may further include a shield via 13 overlapping the center part C of the bottom surface of the dielectric material block 111, unlike the dielectric resonator antenna 100f according to the example described above.

The shield via 13 may be disposed between the first feed unit 11a and the fourth feed unit 12b and between the second feed unit 11b and the third feed unit 12a, the shield via 13 may be disposed to be spaced to have almost a same interval from the first feed unit 11a, the second feed unit 11b, the third feed unit 12a, and the fourth feed unit 12b. The third height h3 of the shield via 13 measured from the bottom surface of the dielectric material block 111 may be less than the first height h1 of the first feed unit 11a and the second feed unit 11b and equal to or higher than the second height h2 of the third feed unit 12a and the fourth feed unit 12b. However, this is only an example, and the third height h3 of the shield via 13 may be greater than the first height h1 of the first feed unit 11a and the second feed unit 11b, and may be less than the second height h2 of the third feed unit 12a and the fourth feed unit 12b.

Referring to FIG. 16B, similarly to the description above with regard to FIG. 12B, the center part C of the bottom surface of the dielectric material block 111 where the first feed unit 11a and the fourth feed unit 12b are symmetrical to each other does not mean the right center region of the bottom surface of the dielectric material block 111, but the center part C may be a predetermined region that may include all of a symmetrical center part C1 that the first feed unit 11a and the fourth feed unit 12b are symmetrical to each other when being disposed on the first positions 11ax and 12bx, a symmetrical center part C21 that the first feed unit 11a and the fourth feed unit 12b are symmetrical to each other when being disposed on the second positions 11ay and 12by, a symmetrical center part C31 that the first feed unit 11a and the fourth feed unit 12b are symmetrical to each other when being disposed on the third positions 11az and 12bz, a symmetrical center part C22 that the second feed unit 11b and the third feed unit 12a are symmetrical to each other when being disposed on the fifth positions 11by and 12ay, and a symmetrical center part C32 that the second feed unit 11b and the third feed unit 12a are symmetrical to each other when being disposed on the sixth positions 11bz and 12az. In addition, the shield via 13 may be disposed at the center part C of the bottom surface of the dielectric material block 111 including the center parts C1, C21, C31, C22, and C32.

Accordingly, since the dielectric resonator antenna 100h, according to the present example, may further include the shield via 13 disposed between the first feed unit 11a and the fourth feed unit 12b and between the second feed unit 11b and the third feed unit 12a, where the shield via 13 may be disposed to be spaced so as to have almost the same interval from the first feed unit 11a, the second feed unit 11b, the third feed unit 12a and the fourth feed unit 12b, and since the shield via 13 may have a third height h3 that is equal to or higher than the second height h2 of the third feed unit 12a and the fourth feed unit 12b, the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be additionally reduced.

According to the dielectric resonator antenna 100h according to the present example, since a first height of the first feed unit 11a and the second feed unit 11b, and a second height of the third feed unit 12a and the fourth feed unit 12b in the dielectric material block 111 may be different, by disposing the first feed unit 11a, the second feed unit 11b, the third feed unit 12a, and the fourth feed unit 12b to be spaced apart from each other on the second straight line L2 and the fourth straight line L4 of two diagonals passing through the center part C so as to be symmetrical to each other with reference to the center part C of the bottom surface, the RF signals of the different bands may be transmitted and received by implementing one dielectric material block 111, the bandwidth of the first polarization RF signal and the second polarization RF signal of the first bandwidth, and the first polarization RF signal and the second polarization RF signal of the second bandwidth may be broadened, and the gain of the antenna 100h may be increased by reducing the interference between the first polarization RF signal and the second polarization RF signal of the first bandwidth and the first polarization RF signal and the second polarization RF signal of the second bandwidth.

Additionally, since the example dielectric resonator antenna 100h, in accordance with one or more embodiments, may further include the shield via 13, the interference between the first polarization RF signal and the second polarization RF signal of the first bandwidth transmitted and received by the electrical signal applied to the first feed unit 11a and the second feed unit 11b, and first polarization RF signal and the second polarization RF signal of the second bandwidth transmitted and received by the electrical signal applied to the third feed unit 12a and the fourth feed unit 12b, may be additionally reduced.

Many features of the example antenna according to the example described above are applicable to the example antenna according to the present example.

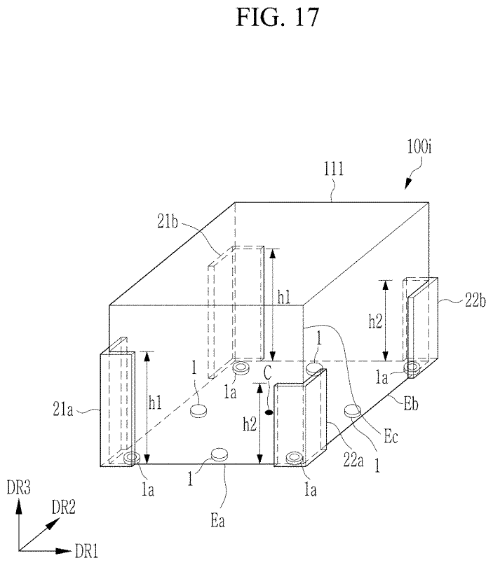

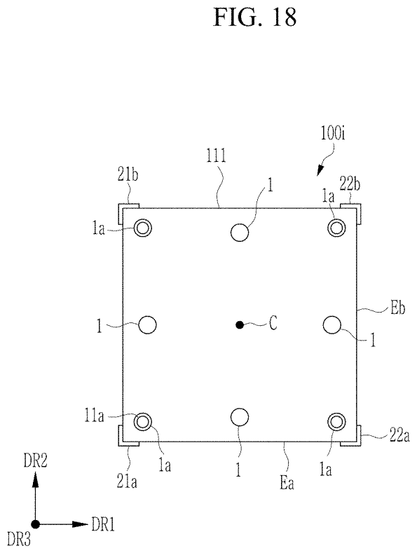

An example dielectric resonator antenna 100i, in accordance with one or more embodiments, is described with reference to FIG. 17 and FIG. 18. FIG. 17 is a perspective view of an example dielectric resonator antenna, in accordance with one or more embodiments, and FIG. 18 is a top plan view of an example dielectric resonator antenna of FIG. 17.

Referring to FIG. 17 and FIG. 18, the example dielectric resonator antenna 100i, in accordance with one or more embodiments, may include the first feed strip 21a, the second feed strip 21b, the third feed strip 22a, and the fourth feed strip 22b that extend in the third direction DR3 from the bottom surface of the dielectric material block 111 along four corners formed by the intersection of the respective first sides Ea parallel to the first direction DR1 and the respective second sides Eb parallel to the second direction DR2 of the dielectric material block 111. A plurality of connecting parts 1 and 1a may be attached to the bottom surface of the dielectric material block 111.

The first feed strip 21a and the second feed strip 21b may have a first height h1 measured from the bottom surface of the dielectric material block 111, the third feed strip 22a and the fourth feed strip 22b may have a second height h2, and, in an example, the first height h1 may be higher than the second height h2.

The dielectric resonator antenna 100i may transmit and/or receive the first polarization RF signal of the first bandwidth through the first feed strip 21a and may transmit and/or receive the second polarization RF signal of the first bandwidth through the second feed strip 21b. Similarly, the dielectric resonator antenna 100i may transmit and/or receive the first polarization RF signal of the second bandwidth through the third feed strip 22a, and may transmit and/or receive the second polarization RF signal of the second bandwidth through the fourth feed strip 22b.

In an example, the center frequency of the first bandwidth may be lower than the center frequency of the second bandwidth, the first polarization may be horizontal polarization, and the second polarization may be vertical polarization.

The first feed strip 21a, the second feed strip 21b, the third feed strip 22a, and the fourth feed strip 22b may overlap two diagonals passing through the center part C of the bottom surface of the dielectric material block 111 and passing through the corners formed by the intersection of two first sides Ea and two second sides Eb. The first feed strip 21a, the second feed strip 21b, the third feed strip 22a, and the fourth feed strip 22b may be symmetrically disposed at four corners with reference to the center part C of the bottom surface of the dielectric material block 111.

The first feed strip 21a, the second feed strip 21b, the third feed strip 22a, and the fourth feed strip 22b may have a same interval from the center part C of the bottom surface of the dielectric material block 111.

The first feed strip 21a and the fourth feed strip 22b may be disposed to be symmetrical to each other with reference to the center part C of the bottom surface as a reference, and the second feed strip 21b and the third feed strip 22a may be disposed to be symmetrical to each with reference to the center part C of the bottom surface as a reference.

Accordingly, the first feed strip 21a, the second feed strip 21b, the third feed strip 22a, and the fourth feed strip 22b may be disposed at four corners formed by the intersection of the first side Ea that is parallel to first direction DR1, and the second side Eb that is parallel to the second direction DR2 and are disposed to be spaced apart from each other on two diagonals passing though the center part C of the bottom surface of the dielectric material block 111 so as to be symmetrical to each other with reference to the center part C of the bottom surface of the dielectric material block 111 Accordingly the interval between the first feed strip 21a, the second feed strip 21b, the third feed strip 22a, and the fourth feed strip 22b may be widened without increasing the size of the dielectric material block 111.

Therefore, the interference between the first polarization RF signal and the second polarization RF signal of the first bandwidth transmitted and received by the electrical signal applied to the first feed strip 21a and the second feed strip 21b and the first polarization RF signal and the second polarization RF signal of the second bandwidth transmitted and received by the electrical signal applied to the third feed strip 22a and the fourth feed strip 22b may be reduced. Additionally, in the dielectric material block 111, the distribution length of the electric field generated by the electrical signal applied to the first feed strip 21a and the second feed strip 21b and the distribution length of the electric field generated by the electrical signal applied to the third feed strip 22a and the fourth feed strip 22b may be increased, so the bandwidth of the first polarization RF signal and the second polarization RF signal of the first bandwidth and the first polarization RF signal and the second polarization RF signal of the second bandwidth may be widened without increasing the size of the dielectric material block 111.

According to the example dielectric resonator antenna 100i, in accordance with one or more embodiments, the different heights of the first feed strip 21a and the second feed strip 21b and the third feed strip 22a and the fourth feed strip 22b may be formed in the dielectric material block 111, and the first feed strip 21a, the second feed strip 21b, the third feed strip 22a, and the fourth feed strip 22b may be disposed to be spaced apart from each other at the four corners of the dielectric material block 111 so as to overlap the second straight line L2 and the fourth straight line L4 as two diagonals passing through the center part C of the bottom surface, and to be symmetrical to each other with reference to the center part C. The RF signals of the different bands may be transmitted and/or received by implementing one dielectric material block 111, the bandwidth of the first polarization RF signal and the second polarization RF signal of the first bandwidth and the first polarization RF signal and the second polarization RF signal of the second bandwidth may be expanded, and the gain of the antenna 100i may be increased by reducing the interference between the first polarization RF signal and the second polarization RF signal of the first bandwidth and the first polarization RF signal and the second polarization RF signal of the second bandwidth.

Many features of the antenna according to the example described above are applicable to the example antenna, in accordance with one or more embodiments.

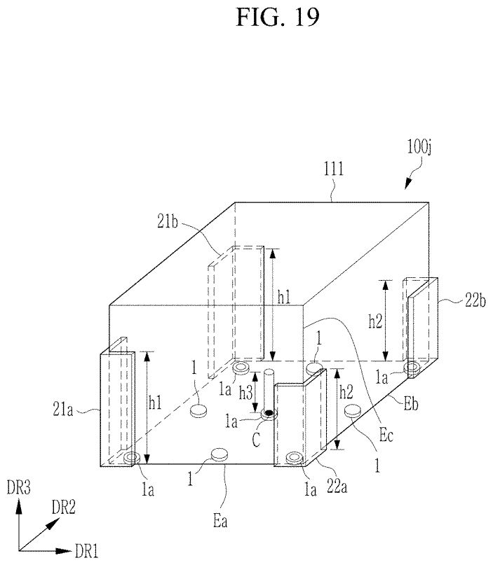

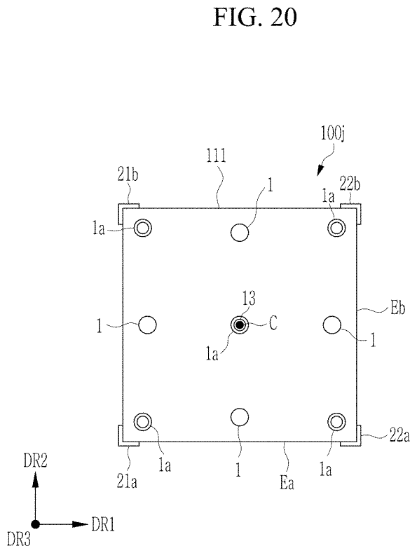

An example dielectric resonator antenna 100j, in accordance with one or more embodiments, is described with reference to FIG. 19 and FIG. 20. FIG. 19 is a perspective view of an example dielectric resonator antenna, in accordance with one or more embodiments, and FIG. 20 is a top plan view of an example dielectric resonator antenna of FIG. 19.

Referring to FIG. 19 and FIG. 20, the dielectric resonator antenna 100j according to the present example is similar to the dielectric resonator antenna 100i according to the example described with reference to FIG. 17 and FIG. 18 above. The detailed description for the same constituent elements is omitted.

The dielectric resonator antenna 100j according to the present example may include the first feed strip 21a, the second feed strip 21b, the third feed strip 22a, and the fourth feed strip 22b extending in the third direction DR3 from the bottom surface of the dielectric material block 111 along four corners formed by the intersection of the first side Ea that is parallel to the first direction DR1, and the second side Eb that is parallel to the second direction DR2 of the dielectric material block 111, and a plurality of connecting parts 1 and 1a attached to the bottom surface of the dielectric material block 111.

The first feed strip 21a and the second feed strip 21b may have a first height h1 measured from the bottom surface of the dielectric material block 111, the third feed strip 22a and the fourth feed strip 22b may have a second height h2. In an example, the first height h1 may be higher than the second height h2.

The dielectric resonator antenna 100j may transmit and/or receive the first polarization RF signal of the first bandwidth through the first feed strip 21a and may transmit and/or receive the second polarization RF signal of the first bandwidth through the second feed strip 21b. Similarly, the dielectric resonator antenna 100j may transmit and/or receive the first polarization RF signal of the second bandwidth through the third feed strip 22a, and may transmit and/or receive the second polarization RF signal of the second bandwidth through the fourth feed strip 22b.

In an example, the center frequency of the first bandwidth may be lower than the center frequency of the second bandwidth, the first polarization may be horizontal polarization, and the second polarization may be vertical polarization.

The first feed strip 21a, the second feed strip 21b, the third feed strip 22a, and the fourth feed strip 22b may be disposed at four corners formed by the intersection of the first side Ea which is parallel to the first direction DR1 and the second side Eb which is parallel to the second direction DR2, and may be disposed to be spaced apart from each other so as to be symmetrical to each other with reference to the center part C of the bottom surface of the dielectric material block 111 by passing through the center part C of the bottom surface of the dielectric material block 111 and overlapping the second straight line L2 and the fourth straight line L4 of two diagonals. Accordingly, the interval between the first feed strip 21a, the second feed strip 21b, the third feed strip 22a, and the fourth feed strip 22b may be widened without increasing the size of the dielectric material block 111.

Therefore, the interference between the first polarization RF signal and the second polarization RF signal of the first bandwidth transmitted and received by the electrical signal applied to the first feed strip 21a and the second feed strip 21b and the first polarization RF signal and the second polarization RF signal of the second bandwidth transmitted and received by the electrical signal applied to the third feed strip 22a and the fourth feed strip 22b may be reduced. Additionally, in the dielectric material block 111, the distribution length of the electric field generated by the electrical signal applied to the first feed strip 21a and the second feed strip 21b and the distribution length of the electric field generated by the electrical signal applied to the third feed strip 22a and the fourth feed strip 22b may be increased. Accordingly, the bandwidth of the first polarization RF signal and the second polarization RF signal of the first bandwidth and the first polarization RF signal and the second polarization RF signal of the second bandwidth may be widened without increasing the size of the dielectric material block 111.

However, the dielectric resonator antenna 100j according to the present example may further include the shield via 13 that overlaps the center part C of the bottom surface of the dielectric material block 111, unlike the dielectric resonator antenna 100i according to the example described above.

In an example, the shield via 13 may be disposed on an imaginary diagonal line connecting the first feed strip 21a and the fourth feed strip 22b, and on an imaginary diagonal line connecting the second feed strip 21b and the third feed strip 22a, the shield via 13 may be disposed to be spaced apart to have approximately the same interval from the first feed strip 21a, the second feed strip 21b, the third feed strip 22a, and the fourth feed strip 22b. In an example, the third height h3 of the shield via 13 measured from the bottom surface of the dielectric material block 111 may be lower than the first height h1 of the first feed strip 21a and the second feed strip 21b and may be equal to or higher than the second height h2 of the third feed strip 22a and the fourth feed strip 22b. However, this is only an example, and the third height h3 of the shield via 13 may be greater than the first height h1 of the first feed strip 21a and the second feed strip 21b, and may be less than the second height h2 of the third feed strip 22a and the fourth feed strip 22b.

Accordingly, the dielectric resonator antenna 100j according to the present example, may further include the shield via 13 disposed between the first feed strip 21a and the fourth feed strip 22b and between the second feed strip 21b and the third feed strip 22a, separated from the first feed strip 21a, the second feed strip 21b, the third feed strip 22a, and the fourth feed strip 22b to have approximately the same interval, and may have the third height h3 equal to or higher than the second height h2 of the third feed strip 22a and the fourth feed strip 22b. Accordingly, the interference between the first polarization RF signal and the second polarization RF signal of the first bandwidth transmitted and received by the electrical signal applied to the first feed strip 21a and the second feed strip 21b, and the first polarization RF signal and the second polarization RF signal of the second bandwidth transmitted and received by the electrical signal applied to the third feed strip 22a and the fourth feed strip 22b may be additionally reduced.

According to the example dielectric resonator antenna 100j according to the present example, the different heights of the first feed strip 21a and the second feed strip 21b and the third feed strip 22a and the fourth feed strip 22b may be formed in the dielectric material block 111, and the first feed strip 21a, the second feed strip 21b, the third feed strip 22a, and the fourth feed strip 22b may be disposed to be spaced apart from each other at four corners of the dielectric material block 111 so as to be symmetrical to each other with reference to the center part C of the bottom surface and to overlap two diagonals passing through the center part C, the RF signals of the different bands may be transmitted and/or received by implementing one dielectric material block 111, the bandwidth of the first polarization RF signal and the second polarization RF signal of the first bandwidth and the first polarization RF signal and the second polarization RF signal of the second bandwidth may be expanded, and se the gain of the antenna 100j may be increased by reducing the interference between the first polarization RF signal and the second polarization RF signal of the first bandwidth and the first polarization RF signal and the second polarization RF signal of the second bandwidth.

Additionally, since the example dielectric resonator antenna 100j according to the present example may further include the shield via 13, the interference between the first polarization RF signal and the second polarization RF signal of the first bandwidth transmitted and received by the electrical signal applied to the first feed strip 21a and the second feed strip 21b, and the first polarization RF signal and the second polarization RF signal of the second bandwidth transmitted and received by the electrical signal applied to the third feed strip 22a and the fourth feed strip 22b may be additionally reduced.

Many features of the example antenna according to the example described above are applicable to the example antenna according to the present example.

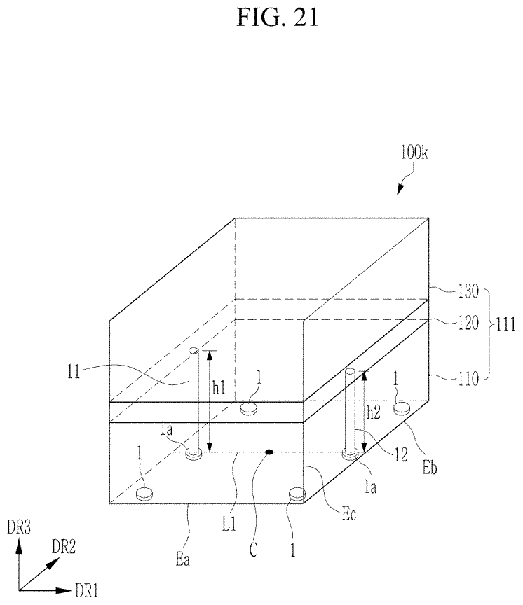

A dielectric resonator antenna 100k, in accordance with one or more embodiments, is described with reference to FIG. 21. FIG. 21 is a perspective view of an example dielectric resonator antenna, in accordance with one or more embodiments.

Referring to FIG. 21, the dielectric resonator antenna 100k according to the present embodiment is similar to the dielectric resonator antenna 100a according to the embodiment described with reference to FIG. 1 and FIG. 2. The detailed description for the same constituent elements is omitted.

The example dielectric resonator antenna 100k may include a dielectric material block 111, a first feed unit 11 and a second feed unit 12 disposed inside the dielectric material block 111, and a plurality of connecting parts 1 and 1a disposed under the dielectric material block 111, that is, attached to the bottom surface of the dielectric material block 111.

In an example, the dielectric material block 111 may include a first dielectric material block 110, a second dielectric material block 120, and a third dielectric material block 130 sequentially disposed along the third direction DR3. In an example, the dielectric constants of the first dielectric material block 110, the second dielectric material block 120, and the third dielectric material block 130 may be the same. However, this is only an example, and the dielectric constants of the first dielectric material block 110, the second dielectric material block 120, and the third dielectric material block 130 may be different from each other. In an example, the dielectric constants of the first dielectric material block 110 and the third dielectric material block 130 may be higher than the dielectric constant of the second dielectric material block 120. However, this is only an example, and the dielectric constants of the first dielectric material block 110 and the third dielectric material block 130 may be less than the dielectric constant of the second dielectric material block 120. The respective dielectric constants of the first dielectric material block 110, the second dielectric material block 120, and the third dielectric material block 130 may be changeable.

In an example, the first dielectric material block 110, the second dielectric material block 120, and the third dielectric material block 130 may have the same planar shape, and may overlap each other along the third direction DR3. When the first dielectric material block 110, the second dielectric material block 120, and the third dielectric material block 130 are laminated and joined together along the third direction DR3, the sides of each, that is, four pairs of the side surfaces, may be seamlessly connected to each other without a step to be disposed to be coplanar, respectively.

The dielectric material block 111 including the first dielectric material block 110, the second dielectric material block 120, and the third dielectric material block 130 may have a cuboid shape, and only an example, and the dielectric material block 111 may have a via hole through which a first feed unit 11 and a second feed unit 12 are inserted.

The first feed unit 11 and the second feed unit 12 may be disposed within a portion of the dielectric material block 111 along the third direction DR3. In an example, the first feed unit 11 may be disposed in the first dielectric material block 110 and the second dielectric material block 120, and the second feed unit 12 may be disposed in the first dielectric material block 110. In an example, the first height h1 of the first feed unit 11 measured from the bottom surface of the dielectric material block 111 along the third direction DR3 may be higher than the second height h2 of the second feed unit 12.

The dielectric resonator antenna 100k may transmit and/or receive the RF signal of the first bandwidth through the first feed unit 11, and may transmit and/or receive the RF signal of the second bandwidth different from the first bandwidth through the second feed unit 12.

In an example, the center frequency of the first bandwidth may be lower than the center frequency of the second bandwidth.

The first feed unit 11 and the second feed unit 12 may be disposed adjacent to the center area of two second sides Eb that face each other along the first direction DR1, and may be disposed along an imaginary first straight line L1 passing through the center part C of the bottom surface of the dielectric material block 111 and parallel to the first direction DR1, and the first feed unit 11 and the second feed unit 12 may have approximately the same interval from the center part C of the bottom surface of the dielectric material block 111.

Accordingly, the dielectric resonator antenna 100k according to the present example may include the first feed unit 11 disposed in the first dielectric material block 110 and the second dielectric material block 120 of the dielectric material block 111 including the first dielectric material block 110, the second dielectric material block 120, and the third dielectric material block 130, and the second feed unit 12 disposed in the first dielectric material block 110. The first feed unit 11 and the second feed unit 12 may be disposed to be spaced apart from each other so as to be symmetrical to each other with the same interval with reference to the center part C of the bottom surface of the dielectric material block 111 and to be adjacent to the edge of the bottom surface of the dielectric material block 111, thereby the RF signals of the different bands may be transmitted and/or received by implementing the same dielectric material block 111, and the bandwidths of the RF signal of the first bandwidth and the RF signal of the second bandwidth may be widened, and the gain of the antenna 100k may be increased, by reducing the interference between the RF signal of the first bandwidth and the RF signal of the second bandwidth.

Many features of the antennas according to the examples described above are applicable to the example antennas according to the present example.

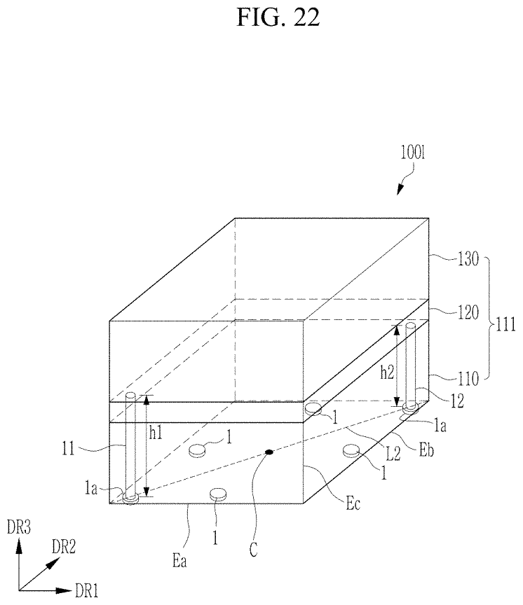

An example dielectric resonator antenna 100l, in accordance with one or more embodiments, is described with reference to FIG. 22. FIG. 22 illustrates a perspective view of an example dielectric resonator antenna, in accordance with one or more embodiments.

Referring to FIG. 22, the example dielectric resonator antenna 100l, in accordance with one or more embodiments is similar to the dielectric resonator antenna 100k according to the above-described example. The detailed description for the same constituent elements is omitted.

The example dielectric resonator antenna 100l, in accordance with one or more embodiments, may include a dielectric material block 111, a first feed unit 11 and a second feed unit 12 disposed inside the dielectric material block 111, and a plurality of connecting parts 1 and 1a disposed under the dielectric material block 111, that is, attached to the bottom surface of the dielectric material block 111.

The dielectric material block 111 may include a first dielectric material block 110, a second dielectric material block 120, and a third dielectric material block 130 sequentially disposed along the third direction DR3. The dielectric constants of the first dielectric material block 110, the second dielectric material block 120, and the third dielectric material block 130 may be the same. However, this is only an example, and the dielectric constants of the first dielectric material block 110, the second dielectric material block 120, and the third dielectric material block 130 may be different from each other.

The first feed unit 11 may be disposed in the first dielectric material block 110 and the second dielectric material block 120, and the second feed unit 12 may be disposed in the first dielectric material block 110. In an example, the first height h1 of the first feed unit 11 measured from the bottom surface of the dielectric material block 111 along the third direction DR3 may be higher than the second height h2 of the second feed unit 12.

The example dielectric resonator antenna 100l may transmit and/or receive the RF signal of the first bandwidth through the first feed unit 11 and may transmit and/or receive the RF signal of the second bandwidth different from the first bandwidth through the second feed unit 12. In an example, the center frequency of the first bandwidth may be lower than the center frequency of the second bandwidth.

However, in the dielectric resonator antenna 100l, in accordance with one or more embodiments, different from the example dielectric resonator antenna 100k according to the example described above, the first feed unit 11 and the second feed unit 12 may be disposed on a virtual second straight line L2 of the diagonal passing through the center part C of the bottom surface of the dielectric material block 111.

The first feed unit 11 and the second feed unit 12 may be disposed adjacent to two edges where the first side Ea which is parallel to the first direction DR1 and the second side Eb which is parallel to the second direction DR2 meet each other.

In an example, the first feed unit 11 and the second feed unit 12 may have substantially a same interval from the center part C of the bottom surface of the dielectric material block 111.

Accordingly, the first feed unit 11 and the second feed unit 12 may be disposed to be spaced apart from each other so as to be adjacent to two edges formed by the meeting of the first side Ea which is parallel to the first direction DR1 and the second side Eb which is parallel to the second direction DR2, and may face each other to be symmetrical to each other with reference of the center part C of the bottom surface of the dielectric material block 111, thereby the interval between first feed unit 11 and second feed unit 12 may be widened.

Therefore, the interference between the RF signal of the first bandwidth transmitted and received by the electrical signal applied to the first feed unit 11 and the RF signal of the second bandwidth transmitted and received by the electrical signal applied to the second feed unit 12 may be reduced. Additionally, in the dielectric material block 111, the distribution length of the electric field generated by the electrical signal applied to the first feed unit 11 and the distribution length of the electric field generated by the electrical signal applied to the second feed unit 12 may be increased, respectively, and accordingly the bandwidth of the RF signal of the first bandwidth and the RF signal of the second bandwidth may be widened without increasing the size of the dielectric material block 111.

Accordingly, the example dielectric resonator antenna 100l according to the present example may include the first feed unit 11 disposed in the first dielectric material block 110 and the second dielectric material block 120 of the dielectric material block 111 including the first dielectric material block 110, the second dielectric material block 120, and the third dielectric material block 130, and the second feed unit 12 disposed in the first dielectric material block 110. The first feed unit 11 and the second feed unit 12 may be disposed to be spaced apart from each other so as to be symmetrical to each other with reference to the center part C of the bottom surface of the dielectric material block 111 and to be adjacent to two edges formed by the meeting of the first side Ea which is parallel to the first direction DR1 and the second side Eb which is parallel to the second direction DR2, thereby the RF signals of the different bands may be transmitted and/or received by implementing the same dielectric material block 111, the bandwidths of the RF signal of the first bandwidth and the RF signal of the second bandwidth may be widened, and the gain of the antenna 100l may be increased by reducing the interference between the RF signal of the first bandwidth and the RF signal of the second bandwidth.

Many features of the example antennas described above are applicable to the example antennas according to the present example.

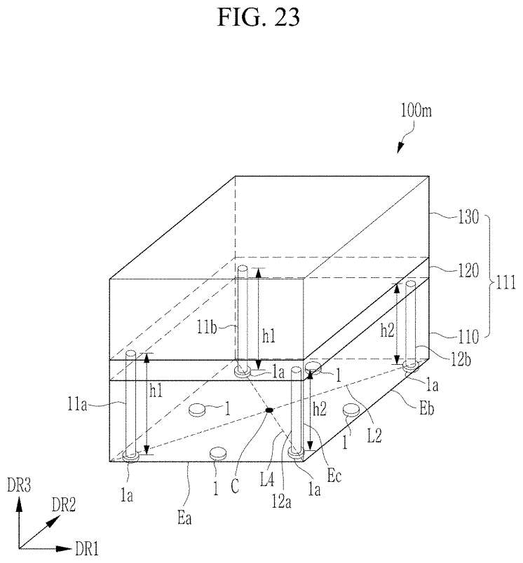

An example dielectric resonator antenna 100m, in accordance with one or more embodiments is described with reference to FIG. 23. FIG. 23 illustrates a perspective view of an example dielectric resonator antenna, in accordance with one or more embodiments.

Referring to FIG. 23, the example dielectric resonator antenna 100m, in accordance with one or more embodiments, may include a plurality of feed units 11a, 11b, 12a, and 12b disposed inside the dielectric material block 111 and a plurality of connecting parts 1 and 1a attached to the bottom surface of the dielectric material block 111.

The dielectric material block 111 may include a first dielectric material block 110, a second dielectric material block 120, and a third dielectric material block 130 sequentially disposed along the third direction DR3. In an example, the dielectric constants of the first dielectric material block 110, the second dielectric material block 120, and the third dielectric material block 130 may be the same. However, this is only an example, and the dielectric constants of the first dielectric material block 110, the second dielectric material block 120, and the third dielectric material block 130 may be different from each other.

In an example, the first feed unit 11a and the second feed unit 11b may be disposed in the first dielectric material block 110 and the second dielectric material block 120, and the third feed unit 12a and the fourth feed unit 12b may be disposed in the first dielectric material block 110. In an example, the first height h1 of the first feed unit 11a and the second feed unit 11b measured from the bottom surface of the dielectric material block 111 along the third direction DR3 may be higher than the second height h2 of the third feed unit 12a and fourth feed unit 12b.

The example dielectric resonator antenna 100m may transmit and/or receive the first polarization RF signal of the first bandwidth through the first feed unit 11a, may transmit and/or receive the second polarization RF signal of the first bandwidth through the second feed unit 11b, may transmit and/or receive the first polarization RF signal of the second bandwidth through the third feed unit 12a, and may transmit and/or receive the second polarization RF signal of the second bandwidth through the fourth feed unit 12b.

In an example, the center frequency of the first bandwidth may be lower than the center frequency of the second bandwidth, the first polarization may be horizontal polarization, and the second polarization may be vertical polarization.

The first feed unit 11a, the second feed unit 11b, the third feed unit 12a, and the fourth feed unit 12b may overlap the second straight line L2 and the fourth straight line L4, which are the diagonals passing through the center part C of the bottom surface of the dielectric material block 111 and passing through the corner portion formed by the intersection of the two first sides Ea and the two second sides Eb. The first feed unit 11a, the second feed unit 11b, the third feed unit 12a, and the fourth feed unit 12b may be symmetrically disposed at four corners of the dielectric material block 111 with reference to the center part C of the bottom surface of the dielectric material block 111.

The first feed unit 11a, the second feed unit 11b, the third feed unit 12a, and the fourth feed unit 12b may have approximately a same interval from the center part C of the bottom surface of the dielectric material block 111. The first feed unit 11a and the fourth feed unit 12b may be disposed to be symmetrical to each other with reference to the center part C of the bottom surface, and the second feed unit 11b and the third feed unit 12a may be disposed to be symmetrical to each other with reference to the center part C of the bottom surface.

Accordingly, the first feed unit 11a, the second feed unit 11b, the third feed unit 12a, and the fourth feed unit 12b may be disposed to be spaced apart from each other on the second straight line L2 and the fourth straight line L4 that bisect the center part C and are two diagonals, so as to be respectively adjacent to four corners formed by the intersection of the first side Ea which is parallel to the first direction DR1 and the second side Eb which is parallel to the second direction DR2, and to be symmetrical to each other with reference to the center part C of the bottom surface of the dielectric material block 111, thereby the interval between the first feed unit 11a, the second feed unit 11b, the third feed unit 12a, and the fourth feed unit 12b may be further widened without increasing the size of the dielectric material block 111.

Accordingly, an interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b, may be reduced. Additionally, in the dielectric material block 111, the distribution length of the electric field generated by the electrical signal applied to the first feed unit 11a and the second feed unit 11b and the distribution length of the electric field generated by the electrical signal applied to the third feed unit 12a and the fourth feed unit 12b may be largely formed so that the bandwidth of the first polarization RF signal and the second polarization RF signal of the first bandwidth and the first polarization RF signal and the second polarization RF signal of the second bandwidth may be widened without increasing the size of the dielectric material block 111.

The example dielectric resonator antenna 100m, in accordance with one or more embodiments, may include the first feed unit 11a and the second feed unit 11b, which may be disposed in the first dielectric material block 110 and the second dielectric material block 120 of the dielectric material block 111 including the first dielectric material block 110, the second dielectric material block 120, and the third dielectric material block 130, and the third feed unit 12a and the fourth feed unit 12b, which may be disposed in the first dielectric material block 110, and the first feed unit 11a, the second feed unit 11b, the third feed unit 12a, and the fourth feed unit 12b may be disposed to be spaced on the second straight line L2 and the fourth straight line L4 that bisect the center part C and are two diagonals so as to be symmetrical to each other with reference to the center part C of the bottom surface, thereby the RF signals of the different bands may be transmitted and/or received by implementing the same dielectric material block 111, the bandwidths of the RF signal of the first bandwidth and the RF signal of the second bandwidth may be widened, and the gain of antenna 100m may be increased by reducing the interference between the RF signals of the first bandwidth and the RF signals of the second bandwidth.

Many features of the example antenna according to the example described above are applicable to the example antenna according to the present example.

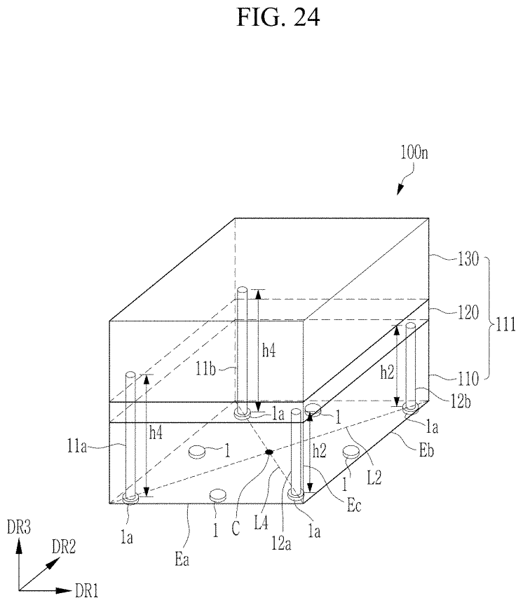

An example dielectric resonator antenna 100n, in accordance with one or more embodiments, is described with reference to FIG. 24. FIG. 24 illustrates a perspective view of an example dielectric resonator antenna, in accordance with one or more embodiments.

Referring to FIG. 24, the example dielectric resonator antenna 100n is similar to the example dielectric resonator antenna 100m described with reference to FIG. 23 above. The detailed description for the same constituent elements is omitted.

The example dielectric resonator antenna 100n, in accordance with one or more embodiments, may include a plurality of feed units 11a, 11b, 12a, and 12b disposed inside the dielectric material block 111 and a plurality of connecting parts 1 and 1a attached to the bottom surface of the dielectric material block 111.

The example dielectric resonator antenna 100n may transmit and/or receive the first polarization RF signal of the first bandwidth through the first feed unit 11a, may transmit and/or receive the second polarization RF signal of the first bandwidth through the second feed unit 11b, may transmit and/or receive the first polarization RF signal of the second bandwidth through the third feed unit 12a, and may transmit and/or receive the second polarization RF signal of the second bandwidth through the fourth feed unit 12b.

In an example, the center frequency of the first bandwidth may be lower than the center frequency of the second bandwidth, the first polarization may be horizontal polarization, and the second polarization may be vertical polarization.

The first feed unit 11a, the second feed unit 11b, the third feed unit 12a, and the fourth feed unit 12b may overlap the second straight line L2 and the fourth straight line L4, which are the diagonals that bisect the center part C of the bottom surface of the dielectric material block 111 and bisect the corner portion formed by the intersection of the two first sides Ea and the two second sides Eb. The first feed unit 11a, the second feed unit 11b, the third feed unit 12a, and the fourth feed unit 12b may be symmetrically disposed at four corners with reference to the center part C of the bottom surface of the dielectric material block 111.

The first feed unit 11a, the second feed unit 11b, the third feed unit 12a, and the fourth feed unit 12b may have approximately a same interval from the center part C of the bottom surface of the dielectric material block 111, the first feed unit 11a and the fourth feed unit 12b may be disposed to be symmetrical to each other with reference to the center part C of the bottom surface, and the second feed unit 11b and the third feed unit 12a may be disposed to be symmetrical to each other with reference to the center part C of the bottom surface.

However, in the example dielectric resonator antenna 100n according to the present example, unlike the dielectric resonator antenna 100m according to the above-described example, the first feed unit 11a and the second feed unit 11b may be disposed in a portion of the third dielectric material block 130 as well as the first dielectric material block 110 and the second dielectric material block 120, and the third feed unit 12a and the fourth feed unit 12b may be disposed in the first dielectric material block 110. In an example, the fourth height h4 of the first feed unit 11a and the second feed unit 11b measured from the bottom surface of the dielectric material block 111 along the third direction DR3 may be higher than the second height h2 of the third feed unit 12a and the fourth feed unit 12b.

Accordingly, by adjusting the height of the first feed unit 11a, the second feed unit 11b, the third feed unit 12a, and the fourth feed unit 12b, the frequency band of the RF signal transmitted and received by the dielectric resonator antenna 100n may be adjusted.

The dielectric resonator antenna 100n, in accordance with one or more embodiments, may include the first feed unit 11a and the second feed unit 11b disposed in the first dielectric material block 110, the second dielectric material block 120, and a portion of the third dielectric material block 130 of the dielectric material block 111 including the first dielectric material block 110, the second dielectric material block 120, and the third dielectric material block 130, and the third feed unit 12a and the fourth feed unit 12b disposed in the first dielectric material block 110. The first feed unit 11a, the second feed unit 11b, the third feed unit 12a, and the fourth feed unit 12b may be disposed to be spaced on the second straight line L2 and the fourth straight line L4 that pass through the center part C and are two diagonals so as to be symmetrical to each other with reference to the center part C of the bottom surface. Accordingly, the RF signals of the different bands may be transmitted and/or received by implementing the same dielectric material block 111, the bandwidths of the RF signal of the first bandwidth and the RF signal of the second bandwidth may be widened, and the gain of the antenna 100m may be increased by reducing the interference between the RF signals of the first bandwidth and the RF signals of the second bandwidth.

Many features of the example antenna according to the example described above are applicable to the example antenna according to the present example.

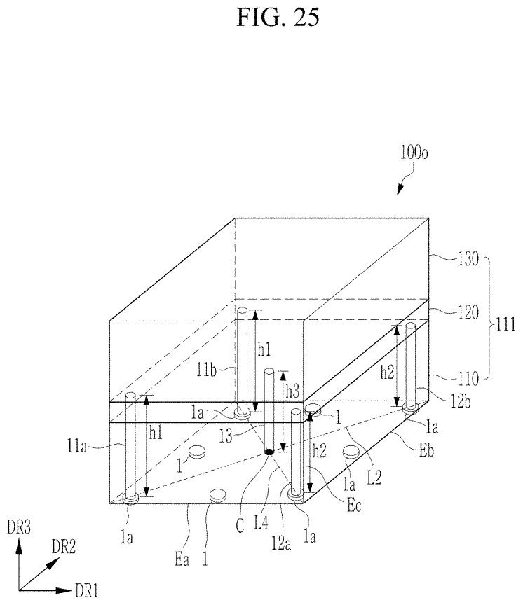

An example dielectric resonator antenna 100o, in accordance with one or more embodiments, is described with reference to FIG. 25. FIG. 25 illustrates a perspective view of an example dielectric resonator antenna, in accordance with one or more embodiments.

Referring to FIG. 25, the example dielectric resonator antenna 100o is similar to the example dielectric resonator antenna 100m according to the example described with reference to FIG. 23 above. The detailed description for the same constituent elements is omitted.

Referring to FIG. 25, the example dielectric resonator antenna 100o, in accordance with one or more embodiments, may include a plurality of feed units 11a, 11b, 12a, and 12b disposed inside the dielectric material block 111 and a plurality of connecting parts 1 and 1a attached to the bottom surface of the dielectric material block 111.

In an example, the first feed unit 11a and the second feed unit 11b may be disposed in the first dielectric material block 110 and the second dielectric material block 120. The third feed unit 12a and the fourth feed unit 12b may be disposed in the first dielectric material block 110, and the first height h1 of the first feed unit 11a and the second feed unit 11b measured from the bottom surface of the dielectric material block 111 along the third direction DR3 may be higher than the second height h2 of the third feed unit 12a and the fourth feed unit 12b.

The example dielectric resonator antenna 100o may transmit and/or receive the first polarization RF signal of the first bandwidth through the first feed unit 11a, may transmit and/or receive the second polarization RF signal of the first bandwidth through the second feed unit 11b, may transmit and/or receive the first polarization RF signal of the second bandwidth through the third feed unit 12a, and may transmit and/or receive the second polarization RF signal of the second bandwidth through the fourth feed unit 12b.

In an example, the center frequency of the first bandwidth may be lower than the center frequency of the second bandwidth, the first polarization may be horizontal polarization, and the second polarization may be vertical polarization.

The first feed unit 11a, the second feed unit 11b, the third feed unit 12a, and the fourth feed unit 12b may be disposed to be spaced apart from each other on the second straight line L2 and the fourth straight line L4 that pass through the center part C and are two diagonals so as to be respectively adjacent to four corners formed by the intersection of the first side Ea which is parallel to the first direction DR1 and the second side Eb which is parallel to the second direction DR2 and to be symmetrical to each other with reference to the center part C of the bottom surface of the dielectric material block 111, thereby the interval between the first feed unit 11a, the second feed unit 11b, the third feed unit 12a, and the fourth feed unit 12b may be further widened without increasing the size of the dielectric material block 111.

Accordingly, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b, may be reduced. Additionally, in the dielectric material block 111, the distribution length of the electric field generated by the electrical signal applied to the first feed unit 11a and the second feed unit 11b and the distribution length of the electric field generated by the electrical signal applied to the third feed unit 12a and the fourth feed unit 12b may be largely formed so that the respective bandwidths of the first polarization RF signal and the second polarization RF signal of the first bandwidth and the first polarization RF signal and the second polarization RF signal of the second bandwidth may be widened without increasing the size of the dielectric material block 111.

However, the dielectric resonator antenna 100o, in accordance with one or more embodiments, may further include a shield via 13 overlapping the center part C of the bottom surface of the dielectric material block 111, unlike the dielectric resonator antenna 100m according to the example described above.

The shield via 13 may be disposed on a diagonal line between the first feed unit 11a and the fourth feed unit 12b, and on a diagonal line between the second feed unit 11b and the third feed unit 12a, the shield via 13 may be spaced or disposed to have almost a same interval from the first feed unit 11a, the second feed unit 11b, the third feed unit 12a, and the fourth feed unit 12b, and the third height h3 of the shield via 13 measured from the bottom surface of the dielectric material block 111 may be lower than the first height h1 of the first feed unit 11a and the second feed unit 11b and equal to or higher than the second height h2 of the third feed unit 12a and the fourth feed unit 12b.

Accordingly, the dielectric resonator antenna 100o according to the present example, may further include the shield via 13 that is disposed between the first feed unit 11a and the fourth feed unit 12b, and between the second feed unit 11b and the third feed unit 12a, and is spaced to have approximately the same interval from the first feed unit 11a, the second feed unit 11b, the third feed unit 12a, and the fourth feed unit 12b, and may have the third height h3 that may be equal to or higher than the second height h2 of the third feed unit 12a and the fourth feed unit 12b, and accordingly the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b, may be additionally reduced.

The dielectric resonator antenna 100o, in accordance with one or more embodiments, may include the first feed unit 11a and the second feed unit 11b disposed in the first dielectric material block 110 and the second dielectric material block 120 of the dielectric material block 111 including the first dielectric material block 110, the second dielectric material block 120, and the third dielectric material block 130, and the third feed unit 12a and the fourth feed unit 12b disposed in the first dielectric material block 110. The first feed unit 11a, the second feed unit 11b, the third feed unit 12a, and the fourth feed unit 12b may be disposed to be spaced on the second straight line L2 and the fourth straight line L4 that pass through the center part C. The second straight line L2 and the fourth straight line L4 are two diagonals that are symmetrical to each other with reference to the center part C of the bottom surface, thereby the RF signals of the different bands may be transmitted and/or received by implementing the same dielectric material block 111, the bandwidths of the RF signal of the first bandwidth and the RF signal of the second bandwidth may be widened, and the gain of the antenna 100o may be increased by reducing the interference between the RF signals of the first bandwidth and the RF signals of the second bandwidth.

Additionally, the dielectric resonator antenna 100o according to the present example, may further include the shield via 13, and accordingly, the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be additionally reduced.

Many features of the example antenna according to the example described above are applicable to the example antenna according to the present example.

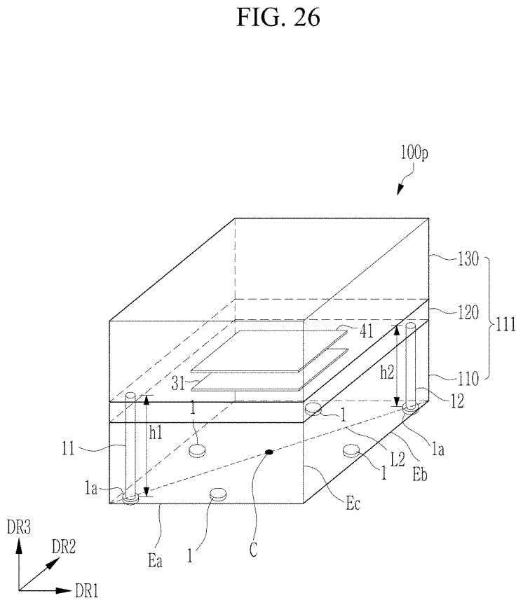

A dielectric resonator antenna 100p, in accordance with one or more embodiments, is described with reference to FIG. 26. FIG. 26 is a perspective view of an example dielectric resonator antenna, in accordance with one or more embodiments.

Referring to FIG. 26, the example dielectric resonator antenna 100p, in accordance with one or more embodiments, is similar to the dielectric resonator antenna 100l according to the example described with reference to FIG. 22 above. The detailed description for the same constituent elements is omitted.

The dielectric resonator antenna 100p, in accordance with one or more embodiments, may include a dielectric material block 111, a first feed unit 11 and a second feed unit 12 disposed inside the dielectric material block 111, and a plurality of connecting parts 1 and 1a disposed under the dielectric material block 111, that is, attached to the bottom surface of the dielectric material block 111.

The first feed unit 11 may be disposed in the first dielectric material block 110 and the second dielectric material block 120, the second feed unit 12 may be disposed in the first dielectric material block 110. In an example, the first height h1 of the first feed unit 11 measured from the bottom surface of the dielectric material block 111 along the third direction DR3 may be higher than the second height h2 of the second feed unit 12.

In an example, the first feed unit 11 and the second feed unit 12 may be adjacent to two corners where the first side Ea which is parallel to the first direction DR1 and the second side Eb which is parallel to the second direction DR2 intersect, and may be disposed on the imaginary second straight line L2 of the diagonal passing through the center part C of the bottom surface of the dielectric material block 111, and may have almost a same interval from the center part C of the bottom surface of the dielectric material block 111.

Accordingly, the first feed unit 11 and the second feed unit 12 may be disposed to be spaced apart from each other so as to be adjacent to two corners formed by the intersection of the first side Ea which is parallel to the first direction DR1 and the second side Eb which is parallel to the second direction DR2, and face each other to be symmetrical to each other with reference to the center part C of the bottom surface of the dielectric material block 111, thereby widening the interval between the first feed unit 11 and the second feed unit 12.

Therefore, interference between the RF signal of the first bandwidth transmitted and received by the electrical signal applied to the first feed unit 11 and the RF signal of the second bandwidth transmitted and received by the electrical signal applied to the second feed unit 12 may be reduced. Additionally, in the dielectric material block 111, the distribution length of the electric field generated by the electrical signal applied to the first feed unit 11 and the distribution length of the electric field generated by the electrical signal applied to the second feed unit 12 may be increased, respectively, and accordingly the bandwidth of the RF signal of the first bandwidth and the RF signal of the second bandwidth may be widened without increasing the size of the dielectric material block 111.

The dielectric resonator antenna 100p, in accordance with one or more embodiments, unlike the dielectric resonator antenna 100l according to the above-described embodiment, may further include a first antenna patch 31 disposed between the first dielectric material block 110 and the second dielectric material block 120 of the dielectric material block 111, and a second antenna patch 41 disposed between the second dielectric material block 120 and the third dielectric material block 130. However, this is only an example, and the first antenna patch 31 and the second antenna patch 41 may be variably disposed between the first dielectric material block 110, the second dielectric material block 120, and the third dielectric material block 130 of the dielectric material block 111.

The first antenna patch 31 may be spaced apart from the second feed unit 12 and coupled, so that it may be fed in a capacitively coupled feed method, and the second antenna patch 41 may be spaced apart from the first feed unit 11 and coupled, so that it may be fed in a capacitively coupled feed method. The example dielectric resonator antenna 100p, according to the present example, may further include the first antenna patch 31 and the second antenna patch 41, thereby increasing the bandwidth of the RF signal to be transmitted and received.

The first feed unit 11 and the second feed unit 12 may not overlap the first antenna patch 31 and the second antenna patch 41 along the third direction DR3, thereby a resonance occurrence of a certain frequency inside the dielectric material block 111 may not be interfered with by the electrical signal fed to the first feed unit 11 and the second feed unit 12.

The size and shape of the first antenna patch 31 and the second antenna patch 41 may be varied. Additionally, the size and shape of the first antenna patch 31 and the second antenna patch 41 and the spacing interval between the feed unit 11 and 12 and the antenna patch 31 and 41 may also be varied, thereby the design freedom of the antenna may be improved.

Many features of the example antennas according to the various embodiments described above are applicable to the example antennas according to the present example.

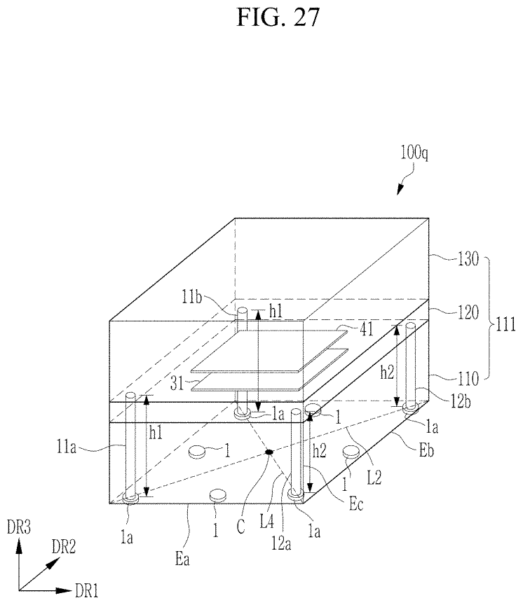

An example dielectric resonator antenna 100q, in accordance with one or more embodiments, is described with reference to FIG. 27. FIG. 27 is a perspective view of an example dielectric resonator antenna, in accordance with one or more embodiments.

Referring to FIG. 27, the dielectric resonator antenna 100q, in accordance with one or more embodiments, is similar to the dielectric resonator antenna 100m according to the example described with reference to FIG. 23 above. The detailed description for the same constituent elements is omitted.

The example dielectric resonator antenna 100q, in accordance with one or more embodiments, may include a plurality of feed units 11a, 11b, 12a, and 12b disposed inside the dielectric material block 111, and a plurality of connecting parts 1 and 1a attached to the bottom surface of the dielectric material block 111.

The dielectric material block 111 may include the first dielectric material block 110, the second dielectric material block 120, and the third dielectric material block 130 sequentially disposed along the third direction DR3.

In a non-limited example, the first feed unit 11a and the second feed unit 11b may be disposed in the first dielectric material block 110 and the second dielectric material block 120, and the third feed unit 12a and the fourth feed unit 12b may be disposed in the first dielectric material block 110. In an example, the first height h1 of the first feed unit 11a and the second feed unit 11b measured from the bottom surface of the dielectric material block 111 along the third direction DR3, may be higher than the second height h2 of the third feed unit 12a and the fourth feed unit 12b.

The example dielectric resonator antenna 100q may transmit and/or receive the first polarization RF signal of the first bandwidth through the first feed unit 11a, may transmit and or receive the second polarization RF signal of the first bandwidth through the second feed unit 11b, may transmit and/or receive the first polarization RF signal of the second bandwidth through the third feed unit 12a, and may transmit and/or receive the second polarization RF signal of the second bandwidth through the fourth feed unit 12b.

In an example, the center frequency of the first bandwidth may be lower than the center frequency of the second bandwidth, the first polarization may be horizontal polarization, and the second polarization may be vertical polarization.

The first feed unit 11a, the second feed unit 11b, the third feed unit 12a, and the fourth feed unit 12b may be symmetrically disposed at four corners with reference to the center part C of the bottom surface of the dielectric material block 111.

The first feed unit 11a, the second feed unit 11b, the third feed unit 12a, and the fourth feed unit 12b may have approximately a same interval from the center part C of the bottom surface of the dielectric material block 111, the first feed unit 11a and the fourth feed unit 12b may be disposed to be symmetrical to each other with reference to the center part C of the bottom surface, and the second feed unit 11b and the third feed unit 12a may be disposed to be symmetrical to each other with reference to the center part C of the bottom surface.

The example dielectric resonator antenna 100q, in accordance with one or more embodiments, may include the first feed unit 11a and the second feed unit 11b disposed in the first dielectric material block 110 and the second dielectric material block 120 of the dielectric material block 111 including the first dielectric material block 110, the second dielectric material block 120 and the third dielectric material block 130, and the third feed unit 12a and the fourth feed unit 12b disposed in the first dielectric material block 110. The first feed unit 11a, the second feed unit 11b, the third feed unit 12a, and the fourth feed unit 12b may be disposed to be spaced on the imaginary second straight line L2 and the imaginary fourth straight line L4 that pass through the center part C and are two diagonals so as to be symmetrical to each other with reference to the center part C of the bottom surface, thereby the RF signals of the different bands may be transmitted and/or received by implementing the same dielectric material block 111, the bandwidths of the RF signal of the first bandwidth and the RF signal of the second bandwidth may be widened, and the gain of the antenna 100m may be increased by reducing the interference between the RF signals of the first bandwidth and the RF signals of the second bandwidth.

The example dielectric resonator antenna 100q, in accordance with one or more embodiments, unlike the example dielectric resonator antenna 100m according to the above-described example, may further include a first antenna patch 31 disposed between the first dielectric material block 110 and the second dielectric material block 120 of the dielectric material block 111 and a second antenna patch 41 disposed between the second dielectric material block 120 and the third dielectric material block 130, thereby it is possible to increase the bandwidth of the RF signal to be transmitted and received. However, this is only an example, and the first antenna patch 31 and the second antenna patch 41 may be variably disposed between the first dielectric material block 110, the second dielectric material block 120, and the third dielectric material block 130 of the dielectric material block 111.

In a non-limiting example, the first feed unit 11a and the second feed unit 11b, and the third feed unit 12a and the fourth feed unit 12b, may not overlap the first antenna patch 31 and the second antenna patch 41 along the third direction DR3. Accordingly, the resonance occurrence of a certain frequency may not be interfered with inside the dielectric material block 111 by the electrical signal fed to the first feed unit 11a and the second feed unit 11b, and the third feed unit 12a and the fourth feed unit 12b.

The size and shape of the first antenna patch 31 and the second antenna patch 41 may be varied, and the size and shape of the first antenna patch 31 and the second antenna patch 41, and the separation interval between the feed unit 11a, 11b, 12a and 12b and the antenna patch 31 and 41, may be varied, thereby the design freedom of the antenna may be improved.

Many features of the antenna according to the embodiment described above are applicable to the antenna according to the present embodiment.

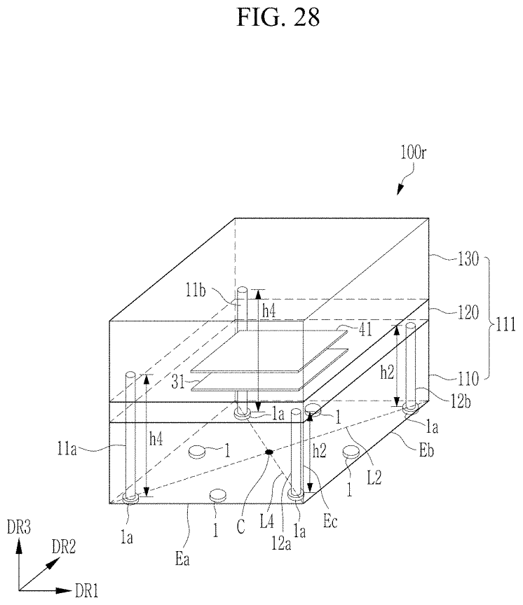

An example dielectric resonator antenna 100r, in accordance with one or more embodiments, is described with reference to FIG. 28. FIG. 28 is a perspective view of an example dielectric resonator antenna, in accordance with one or more embodiments.

Referring to FIG. 28, the example dielectric resonator antenna 100r according to the present example is similar to the example dielectric resonator antenna 100n according to the example described with reference to FIG. 24 above. The detailed description for the same constituent elements is omitted.

The example dielectric resonator antenna 100r, in accordance with one or more embodiments, may include a plurality of feed units 11a, 11b, 12a, and 12b disposed inside the dielectric material block 111, and a plurality of connecting parts 1 and 1a attached to the bottom surface of the dielectric material block 111.

The example dielectric resonator antenna 100r may transmit and/or receive the first polarization RF signal of the first bandwidth through the first feed unit 11a, may transmit and/or receive the second polarization RF signal of the first bandwidth through the second feed unit 11b, may transmit and/or receive the first polarization RF signal of the second bandwidth through the third feed unit 12a, and may transmit and/or receive the second polarization RF signal of the second bandwidth through the fourth feed unit 12b.

In an example, the center frequency of the first bandwidth may be lower than the center frequency of the second bandwidth, the first polarization may be horizontal polarization, and the second polarization may be vertical polarization.

The first feed unit 11a, the second feed unit 11b, the third feed unit 12a, and the fourth feed unit 12b may be symmetrically disposed at four corners with reference to the center part C of the bottom surface of the dielectric material block 111. The first feed unit 11a, the second feed unit 11b, the third feed unit 12a, and the fourth feed unit 12b may have approximately a same interval from the center part C of the bottom surface of the dielectric material block 111, the first feed unit 11a and the fourth feed unit 12b may be disposed to be symmetrical to each other with reference to the center part C of the bottom surface, and the second feed unit 11b and the third feed unit 12a may be disposed to be symmetrical to each other with reference to the center part C of the bottom surface.

In an example, the first feed unit 11a and the second feed unit 11b may be disposed in at least a portion of the third dielectric material block 130 as well as being disposed in the first dielectric material block 110 and the second dielectric material block 120, and the third feed unit 12a and the fourth feed unit 12b may be disposed in the first dielectric material block 110. The fourth height h4 of the first feed unit 11a and the second feed unit 11b measured from the bottom surface of the dielectric material block 111 along the third direction DR3 may be higher than the second height h2 of the third feed unit 12a and the fourth feed unit 12b.

The example dielectric resonator antenna 100r, in accordance with one or more embodiments, may include the first feed unit 11a and the second feed unit 11b that may be disposed in the first dielectric material block 110 and the second dielectric material block 120 and at least a portion of the third dielectric material block 130, and the third feed unit 12a and the fourth feed unit 12b disposed in the first dielectric material block 110 in the dielectric material block 111 including the first dielectric material block 110, the second dielectric material block 120, and the third dielectric material block 130. The first feed unit 11a, the second feed unit 11b, the third feed unit 12a, and the fourth feed unit 12b may be disposed to be spaced on the second imaginary straight line L2 and the fourth imaginary straight line L4 that pass through the center part C and are two diagonals so as to be symmetrical to each other with reference to the center part C of the bottom surface. Accordingly, the RF signals of the different bands may be transmitted and/or received by implementing the same dielectric material block 111, the bandwidths of the RF signal of the first bandwidth and the RF signal of the second bandwidth may be widened, and the gain of the antenna 100r may be increased by reducing the interference between the RF signals of the first bandwidth and the RF signals of the second bandwidth.

The dielectric resonator antenna 100r, in accordance with one or more embodiments, unlike the dielectric resonator antenna 100n according to the above-described example, may further include a first antenna patch 31 disposed between the first dielectric material block 110 and the second dielectric material block 120 of the dielectric material block 111, and a second antenna patch 41 disposed between the second dielectric material block 120 and the third dielectric material block 130, thereby increasing the bandwidth of the RF signal to be transmitted and received. However, this is only an example, and the first antenna patch 31 and the second antenna patch 41 may be variably disposed between the first dielectric material block 110, the second dielectric material block 120, and the third dielectric material block 130 of the dielectric material block 111.

The first feed unit 11a and the second feed unit 11b, and the third feed unit 12a and the fourth feed unit 12b, may not overlap the first antenna patch 31 and the second antenna patch 41 along the third direction DR3. Accordingly, the resonance occurrence of a certain frequency may not be interfered with inside the dielectric material block 111 by the electrical signal fed to the first feed unit 11a and the second feed unit 11b, and the third feed unit 12a and the fourth feed unit 12b.

The size and shape of the first antenna patch 31 and the second antenna patch 41 may be varied, and the size and shape of the first antenna patch 31 and the second antenna patch 41, and the separation interval between the feed units 11a, 11b, 12a, and 12b and the antenna patches 31 and 41 may be varied. Accordingly, the design freedom of the antenna may be improved.

Many features of the example antenna according to the example described above are applicable to the example antenna according to the present example.

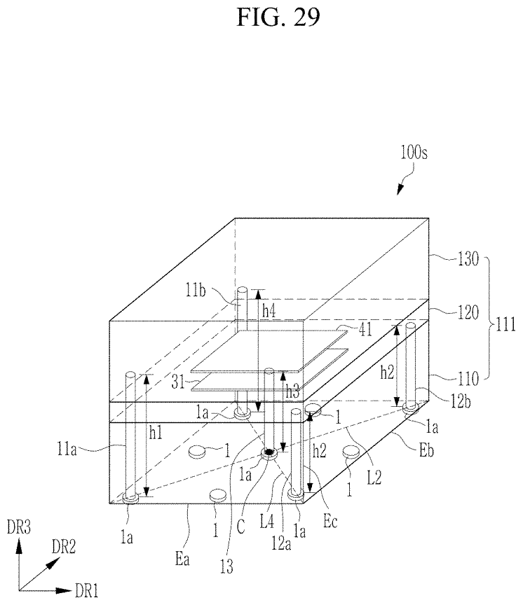

An example dielectric resonator antenna 100s, in accordance with one or more embodiments, is described with reference to FIG. 29. FIG. 29 is a perspective view of an example dielectric resonator antenna, in accordance with one or more embodiments.

Referring to FIG. 29, the example dielectric resonator antenna 100s according to the present example is similar to the dielectric resonator antenna 100o according to the example described with reference to FIG. 25 above. The detailed description for the same constituent elements is omitted.

The dielectric resonator antenna 100s according to the present example may include a plurality of feed units 11a, 11b, 12a, and 12b disposed inside the dielectric material block 111, a plurality of connecting parts 1 and 1a attached to the bottom surface of the dielectric material block 111, and a shield via 13 overlapping the center part C of the bottom surface of the dielectric material block 111.

The example dielectric resonator antenna 100s, in accordance with one or more embodiments, may include the first feed unit 11a and the second feed unit 11b disposed in the first dielectric material block 110 and the second dielectric material block 120, and the third feed unit 12a and the fourth feed unit 12b disposed in the first dielectric material block 110 in the dielectric material block 111 including the first dielectric material block 110, the second dielectric material block 120, and the third dielectric material block 130, and the first feed unit 11a, the second feed unit 11b, the third feed unit 12a, and the fourth feed unit 12b may be disposed to be spaced on the imaginary second straight line L2 and the imaginary fourth straight line L4 that pass through the center part C and are two diagonals so as to be symmetrical to each other with reference to the center part C of the bottom surface, thereby the RF signals of the different bands may be transmitted and/or received by implementing the same dielectric material block 111, the bandwidths of the RF signal of the first bandwidth and the RF signal of the second bandwidth may be widened, and the gain of antenna 100s may be increased by reducing the interference between the RF signals of the first bandwidth and the RF signals of the second bandwidth.

Additionally, the dielectric resonator antenna 100s, in accordance with one or more embodiments, may further include the shield via 13, and accordingly, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be additionally reduced.

The example dielectric resonator antenna 100s, in accordance with one or more embodiments, unlike the example dielectric resonator antenna 100o according to the above-described example, may further include the first antenna patch 31 disposed between the first dielectric material block 110 and the second dielectric material block 120 of the dielectric material block 111 and the second antenna patch 41 disposed between the second dielectric material block 120 and the third dielectric material block 130, thereby increasing the bandwidth of the RF signal to be transmitted and received.

The first feed unit 11a and the second feed unit 11b, and the third feed unit 12a and the fourth feed unit 12b, may not overlap the first antenna patch 31 and the second antenna patch 41 along the third direction DR3, thereby the resonance occurrence of a certain frequency may not be interfered with inside the dielectric material block 111 by the electrical signal fed to the first feed unit 11a and the second feed unit 11b, and the third feed unit 12a and the fourth feed unit 12b.

The size and shape of the first antenna patch 31 and the second antenna patch 41 may be varied, and the size and shape of the first antenna patch 31 and the second antenna patch 41, and the separation interval between the feed units 11a, 11b, 12a, and 12b and the antenna patch 31 and 41 may be varied, thereby the design freedom of the antenna may be improved.

Many features of the example antenna, in accordance with one or more embodiments, described above are applicable to the example antenna according to the present example.

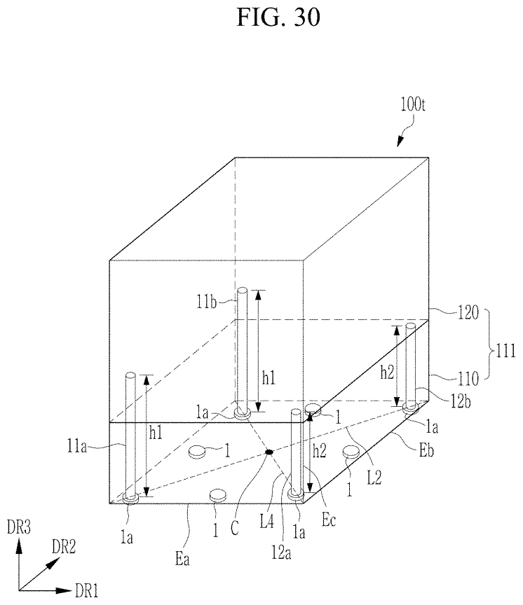

An example dielectric resonator antenna 100t, in accordance with one or more embodiments, is described with reference to FIG. 30. FIG. 30 is a perspective view of an example dielectric resonator antenna, in accordance with one or more embodiments.

Referring to FIG. 30, the example dielectric resonator antenna 100t according to the present example is similar to the dielectric resonator antenna 100m according to the example described with reference to FIG. 23 above. The detailed description for the same constituent elements is omitted.

The dielectric resonator antenna 100t, in accordance with one or more embodiments, may include a plurality of feed units 11a, 11b, 12a, and 12b disposed inside the dielectric material block 111 and a plurality of connecting parts 1 and 1a attached to the bottom surface of the dielectric material block 111.

The example dielectric material block 111 may include the first dielectric material block 110 and the second dielectric material block 120 sequentially disposed along the third direction DR3, the first feed unit 11a and the second feed unit 11b may be disposed in at least a portion of the first dielectric material block 110 and at least a portion of the second dielectric material block 120, and the third feed unit 12a and the fourth feed unit 12b may be disposed in the first dielectric material block 110. In an example, the first height h1 of the first feed unit 11a and the second feed unit 11b measured from the bottom surface of the dielectric material block 111 along the third direction DR3 may be higher than the second height h2 of the third feed unit 12a and the fourth feed unit 12b.

The dielectric constant of the dielectric material block 111 may be adjusted by changing the dielectric constant and a layer thickness of the first dielectric material block 110 and the second dielectric material block 120 included in the dielectric material block 111, and accordingly the first polarization RF signal and the second polarization RF signal of the first bandwidth transmitted and received by the electrical signal applied to the first feed unit 11a and the second feed unit 11b and the first polarization RF signal and the second polarization RF signal of the second bandwidth transmitted and received by the electrical signal applied to the third feed unit 12a and the fourth feed unit 12b may be adjusted.

In the dielectric material block 111 including the first dielectric material block 110 and the second dielectric material block 120, the first feed unit 11a and the second feed unit 11b disposed within at least a portion of the first dielectric material block 110 and within at least a portion of the second dielectric material block 120, and the third feed unit 12a and the fourth feed unit 12b disposed in the first dielectric material block 110 are included, and the first feed unit 11a, the second feed unit 11b, the third feed unit 12a, and the fourth feed unit 12b may be disposed to be spaced on the second imaginary straight line L2 and the fourth imaginary straight line L4 that pass through the center part C and are two diagonals so as to be symmetrical to each other with reference to the center part C of the bottom surface, thereby the RF signals of the different bands may be transmitted and/or received by implementing the same dielectric material block 111, the bandwidths of the RF signal of the first bandwidth and the RF signal of the second bandwidth may be widened, and the gain of antenna 100m may be increased by reducing the interference between the RF signals of the first bandwidth and the RF signals of the second bandwidth.

Many features of the example antenna according to the example described above are applicable to the example antenna according to the present example.

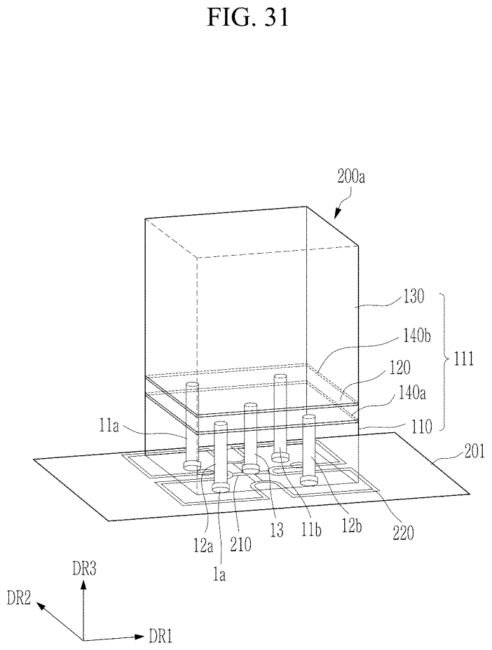

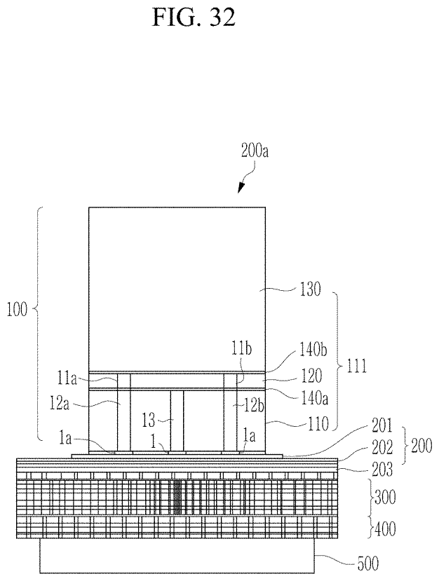

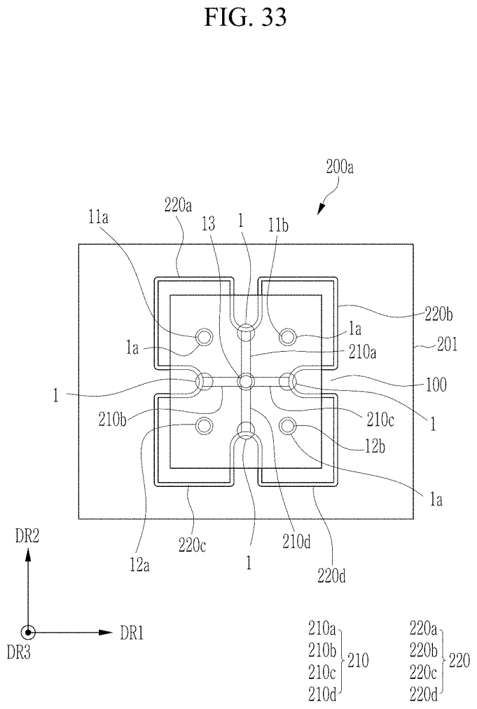

An example antenna device 200a, in accordance with one or more embodiments, is described with reference to FIG. 31 to FIG. 33. FIG. 31 is a perspective view of an example antenna device, in accordance with one or more embodiments, FIG. 32 is a cross-sectional view of an example antenna device of FIG. 31, and FIG. 33 is a top plan view of an example antenna device of FIG. 31.

Referring to FIG. 31 to FIG. 33, the example antenna device 200a, in accordance with one or more embodiments, may include an antenna unit 100, a connection substrate 200 disposed under the antenna unit 100, a main circuit unit 300 disposed under the connection substrate 200, an RF-SiP (Radio Frequency-System in Package) 400 disposed under the main circuit unit 300, and a passive component 500 connected to the RF-SiP 400.

The antenna unit 100 of the antenna device 200a may include a plurality of feed units 11a, 11b, 12a, and 12b and a shield via 13 disposed inside the dielectric material block 111, and a plurality of connecting parts 1 and 1a attached to the bottom surface of the dielectric material block 111.

The dielectric material block 111 may include the first dielectric material block 110, the second dielectric material block 120, and the third dielectric material block 130 sequentially disposed along the third direction DR3, the first dielectric layer 140a disposed between the first dielectric material block 110 and the second dielectric material block 120, and the second dielectric layer 140b disposed between the second dielectric material block 120 and the third dielectric material block 130.

In a non-limiting example, the first dielectric material block 110, the second dielectric material block 120, the third dielectric material block 130, the first dielectric layer 140a, and the second dielectric layer 140b may have the same planar shape, and may overlap each other along the third direction DR3. When the first dielectric material block 110, the second dielectric material block 120, and the third dielectric material block 130 are laminated and joined together along the third direction DR3, the side surfaces of each, that is, four pairs of the side surfaces, may be connected to each other smoothly without a step so as to be respectively disposed coplanarly.

In a non-limiting example, the dielectric constant of the first dielectric layer 140a and the second dielectric layer 140b may be lower than the dielectric constant of the first dielectric material block 110, the second dielectric material block 120, and the third dielectric material block 130. In an example, the first dielectric layer 140a and the second dielectric layer 140b may have adhesive properties.

The dielectric material block 111 including the first dielectric material block 110, the second dielectric material block 120, the third dielectric material block 130, the first dielectric layer 140a, and the second dielectric layer 140b may have a cuboid shape, as a non-limiting example, and the dielectric material block 111 may have via holes into which the feed units 11a, 11b, 12a, and 12b and the shield via 13 are inserted.

In an example, the dielectric constants of the first dielectric material block 110, the second dielectric material block 120, and the third dielectric material block 130 may be the same. However, this is only an example, and the dielectric constants of the first dielectric material block 110, the second dielectric material block 120, and the third dielectric material block 130 may be different from each other.

In an example, the first feed unit 11a and the second feed unit 11b may be disposed in the first dielectric material block 110 and the second dielectric material block 120, and the first dielectric layer 140a, the third feed unit 12a, and the fourth feed unit 12b may be disposed in the first dielectric material block 110. In an example, the first height h1 of the first feed unit 11a and the second feed unit 11b measured from the bottom surface of the dielectric material block 111 along the third direction DR3 may be higher than the second height h2 of the third feed unit 12a and the fourth feed unit 12b.

The antenna unit 100 may transmit and/or receive the first polarization RF signal of the first bandwidth through the first feed unit 11a, may transmit and/or receive the second polarization RF signal of the first bandwidth through the second feed unit 11b, may transmit and/or receive the first polarization RF signal of the second bandwidth through the third feed unit 12a, and may transmit and/or receive the second polarization RF signal of the second bandwidth through the fourth feed unit 12b.

In an example, the center frequency of the first bandwidth may be lower than the center frequency of the second bandwidth, the first polarization may be horizontal polarization, and the second polarization may be vertical polarization.

In an example, the first feed unit 11a, the second feed unit 11b, the third feed unit 12a, and the fourth feed unit 12b may overlap the second imaginary straight line L2 and the fourth imaginary straight line L4, which are the diagonal lines passing through the center part C of the bottom surface of the dielectric material block 111 and passing through the corner portion formed by the intersection of the two first sides Ea and the two second sides Eb. The first feed unit 11a, the second feed unit 11b, the third feed unit 12a, and the fourth feed unit 12b may be symmetrically disposed at four corners with reference to the center part C of the bottom surface of the dielectric material block 111.

The first feed unit 11a, the second feed unit 11b, the third feed unit 12a, and the fourth feed unit 12b may have approximately a same interval from the center part C of the bottom surface of the dielectric material block 111, the first feed unit 11a and the fourth feed unit 12b may be disposed to be symmetrical to each other with reference to the center part C of the bottom surface, and the second feed unit 11b and the third feed unit 12a may be disposed to be symmetrical to each other with reference to the center part C of the bottom surface.

In an example, the respective heights h1 and h2 of the feed units 11a, 11b, and the feed units 12a and 12b that generate the resonance inside the dielectric material block 111, may be greater than 0.25λ, which is a value obtained by multiplying an operating frequency (λ) by 0.25, thereby causing the resonance by reducing an input reactance. In a non-limiting example, the first height h1 of the first feed unit 11a and the second feed unit 11b may be approximately 0.32λ, and the second height h2 of the third feed unit 12a and the fourth feed unit 12b may be approximately 0.25λ, but are not limited thereto.

The first feed unit 11a and the fourth feed unit 12b may be disposed to be symmetrical to each other with reference to the center part C of the bottom surface, and the second feed unit 11b and the third feed unit 12a may be disposed to be symmetrical to each with reference to the center part C of the bottom surface.

The first feed unit 11a, the second feed unit 11b, the third feed unit 12a, and the fourth feed unit 12b may be disposed to be spaced apart each other on two diagonals passing through the center part C so as to be adjacent to four corners formed by the intersection of the first side Ea which is parallel to the first direction DR1 and the second side Eb which is parallel to the second direction DR2 and to be symmetrical to each other with reference to the center part C of the bottom surface of the dielectric material block 111, thereby the interval between the first feed unit 11a, the second feed unit 11b, the third feed unit 12a, and the fourth feed unit 12b may be further widened without increasing the size of the dielectric material block 111.

Accordingly, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b, may be reduced. Additionally, in the dielectric material block 111, the distribution length of the electric field generated by the electrical signal applied to the first feed unit 11a and the second feed unit 11b, and the distribution length of the electric field generated by the electrical signal applied to the third feed unit 12a and the fourth feed unit 12b may be largely formed so that the respective bandwidths of the first polarization RF signal and the second polarization RF signal of the first bandwidth and the first polarization RF signal and the second polarization RF signal of the second bandwidth may be widened without increasing the size of the dielectric material block 111.

In an example, the thickness of the third dielectric material block 130 of the dielectric material block 111 of the antenna unit 100 may be thicker than the thickness of the first dielectric material block 110 and the thickness of the second dielectric material block 120, but is not limited thereto.

The antenna unit 100 may be connected to the connection substrate 200 thorough a plurality of connecting parts 1 and 1a, and the feed units 11a, 11b, 11c, and 11d of the antenna unit 100 may be connected to a metal layer (202 and 203) that may transmit an electrical signal that is not a ground plane 201 through the connecting parts 1a.

The connection substrate 200 may include the ground plane 201 and a plurality of metal layers 202 and 203.

The ground plane 201 may be connected to the shield via 13. Additionally, the ground plane 201 may be connected to the first decoupling pattern 210 and the second decoupling pattern 220.

The first decoupling pattern 210 may be connected to the shield via 13, and the first decoupling pattern 210 may have a crossed shape to include a first portion 210a extending from the center portion connected to the shield via 13 between the first feed unit 11a and the second feed unit 11b, a second portion 210b extending from the center portion connected to the shield via 13 between the first feed unit 11a and the third feed unit 12a, a third portion 210c extending from the center portion connected to the shield via 13 between the second feed unit 11b and the fourth feed unit 12b, and a fourth portion 210d extending from the center portion connected to the shield via 13 between the third feed unit 12a and the fourth feed unit 12b.

The second decoupling pattern 220 may be connected to the first decoupling pattern 210, and may include a first portion 220a surrounding the first feed unit 11a, a second portion 220b surrounding the second feed unit 11b, a third portion 220c surrounding the third feed unit 12a, and a fourth portion 220d surrounding the fourth feed unit 12b.

The second decoupling pattern 220 may extend to the outside of the dielectric material block 111, but is not limited thereto.

Accordingly, in the antenna unit 100 of the antenna device 200a according to the present example, the respective heights of the first feed unit 11a and the second feed unit 11b, and the respective heights of the third feed unit 12a and the fourth feed unit 12b, may be different from each other in the dielectric material block 111, and the first feed unit 11a, the second feed unit 11b, the third feed unit 12a, and the fourth feed unit 12b may be disposed to be spaced apart from each other on the second imaginary straight line L2 and the fourth imaginary straight line L4 of two diagonals passing through the center part C, so as to be symmetrical to each other with reference to the center part C of the bottom surface, and accordingly the RF signals of the different bands may be transmitted/received by using one dielectric material block 111, the bandwidth of the first polarization RF signal and the second polarization RF signal of the first bandwidth and the first polarization RF signal and the second polarization RF signal of the second bandwidth may be expanded, and the gain of the antenna device 200a may be increased by reducing the interference between the first polarization RF signal and the second polarization RF signal of the first bandwidth and the first polarization RF signal and the second polarization RF signal of the second bandwidth.

Additionally, since the antenna device 200a according to the present example may include the first decoupling pattern 210 and the second decoupling pattern 220 connected to the ground plane 201 along with the shield via 13 formed in the dielectric material block 111, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

The connection substrate 200 and the main circuit unit 300, and the main circuit unit 300 and the RF-SiP 400, may be connected through a connection part such as, but not limited to, a solder ball, a pin, a land, a pad, or an SOP (solder on pad).

The antenna unit 100 according to the example described with reference to FIG. 31 to FIG. 33, may include one of the dielectric resonator antennas 100a to 100t according to the above-described examples.

Many features of the dielectric resonator antennas 100a to 100t according to the examples described above are applicable to the example antenna device 200a according to the present example.

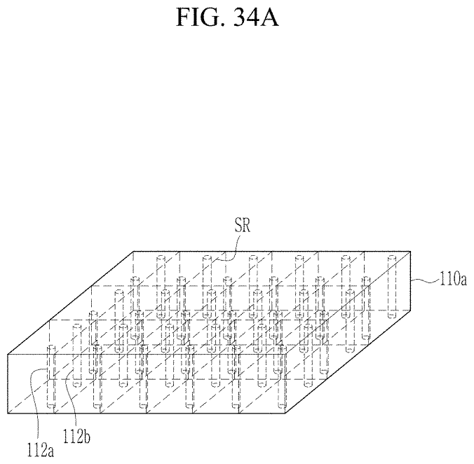

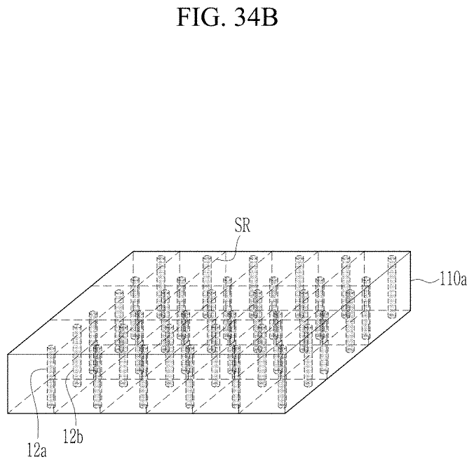

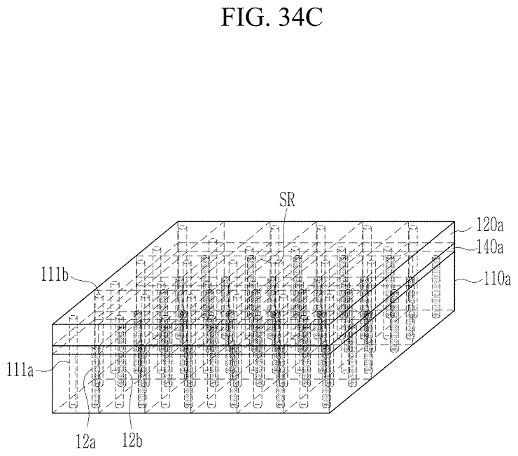

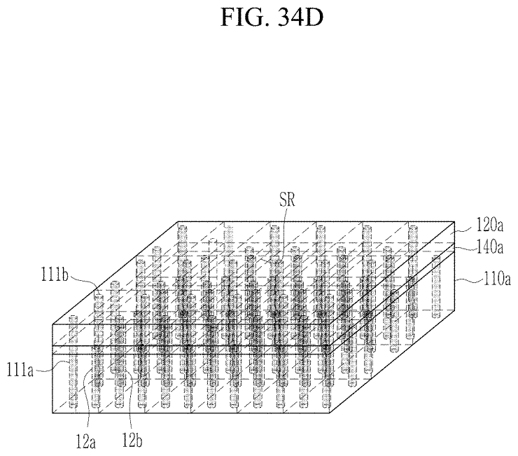

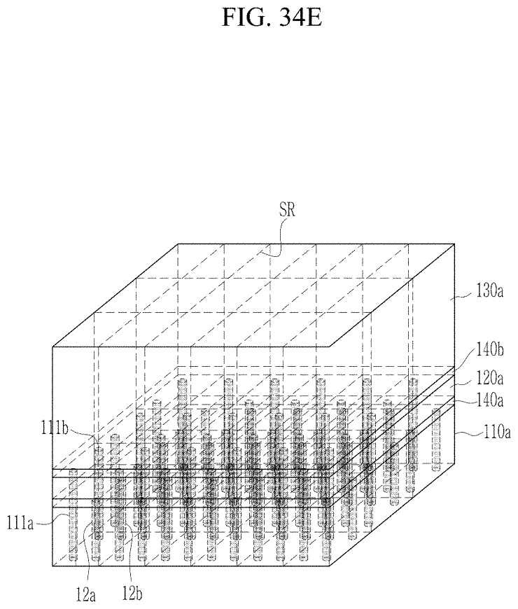

Next, a manufacturing method of the example antenna device, in accordance with one or more embodiments, is described with reference to FIG. 34A to FIG. 34E. FIG. 34A to FIG. 34E are perspective views showing an example manufacturing method of an example antenna device, in accordance with one or more embodiments.

Referring to FIG. 34A, a first dielectric material plate 110a that is representative of a first dielectric material block 110 is prepared. A plurality of first penetration holes 112a and a plurality of second penetration holes 112b, in which a third feed unit 12a and a fourth feed unit 12b are to be formed, are formed in a plurality of regions of the first dielectric material plate 110a that may be divided by an imaginary dividing line SR. At this time, a penetration hole where the shield via 13 will be formed may be formed together.

Referring to FIG. 34B, a metal layer is filled in a plurality of first penetration holes 112a and a plurality of second penetration holes 112b formed in a plurality of regions of the first dielectric material plate 110a with plating to form a plurality of third feed units 12a and a plurality of fourth feed units 12b.

Referring to FIG. 34C, a second dielectric material plate 120a that is representative of a second dielectric material block 120, is stacked on the first dielectric material plate 110a. In this example, a first dielectric layer 140a having adherence may be stacked between the first dielectric material plate 110a and the second dielectric material plate 120a. Thereafter, a plurality of third penetration holes 111a and fourth penetration holes 111b, in which a first feed unit 11a and a second feed unit 11b are to be formed, are formed in the second dielectric material plate 120a, the first dielectric layer 140a, and the first dielectric material plate 110a.

As illustrated in FIG. 34D, a metal layer is filled in a plurality of third penetration holes 111a and a plurality of fourth penetration holes 111b formed in a plurality of regions with plating to form a plurality of first feed units 11a and a plurality of second feed units 11b.

As illustrated in FIG. 34E, a third dielectric material plate 130a constituting the third dielectric material block 130 may be stacked on the second dielectric material plate 120a. In this example, a second dielectric layer 140b having adherence may be stacked between the second dielectric material plate 120a and the third dielectric material plate 130a. Thereafter, a plurality of connecting parts 1 and 1a may be formed under the first dielectric material plate 110a. Additionally, the third dielectric material plate 130a, the second dielectric layer 140b, the second dielectric material plate 120a, the first dielectric layer 140a, and the first dielectric material plate 110a may be cut along an imaginary dividing line SR dividing a plurality of regions including the first feed unit 11a, the second feed unit 11b, the third feed unit 12a, and the fourth feed unit 12b, respectively, to form a plurality of antennas.

Accordingly, the forming of a plurality of vias 11a, 11b, 12a, and 12b in the dielectric material plates 110a and 120a, and the forming of a plurality of antennas by cutting the dielectric material plates 110a, 120a, and 130a, as described above, may be performed. Similarly, the first dielectric material block 110, the second dielectric material block 120, the third dielectric material block 130, the first dielectric layer 140a, and the second dielectric layer 140b may have a same planar shape, and thus may be overlapped with each other along the third direction DR3. When the first dielectric material block 110, the second dielectric material block 120, and the third dielectric material block 130 are laminated and joined together along the third direction DR3, the sides of each, that is, four pairs of the side surfaces, may be seamlessly connected to each other without a step to be disposed coplanarly, respectively.

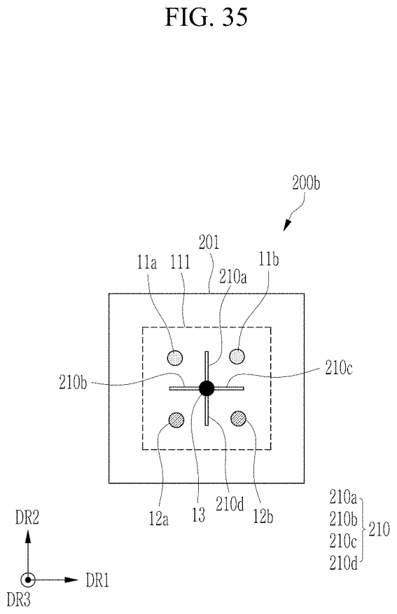

Next, an example antenna device 200b, in accordance with one or more embodiments, is described with reference to FIG. 35. FIG. 35 is a top plan view illustrating a part of an example antenna device, in accordance with one or more embodiments.

Referring to FIG. 35, the example antenna device 200b according to the present example includes the first feed unit 11a and the second feed unit 11b, and the third feed unit 12a and the fourth feed unit 12b, which may be formed in the dielectric material block 111, and a first decoupling pattern 210 connected to the shield via 13 and the ground plane 201.

Many features of the first feed unit 11a and the second feed unit 11b, the third feed unit 12a and the fourth feed unit 12b, and the shield via 13 of the antenna device 200a according to the example described with reference to FIG. 31 to FIG. 33 above are applicable to the first feed unit 11a and the second feed unit 11b, the third feed unit 12a and the fourth feed unit 12b, and the shield via 13 of the example antenna device 200b according to the present example.

The example antenna device 200b, in accordance with one or more embodiments, may include the first feed unit 11a, the second feed unit 11b, the third feed unit 12a, and the fourth feed unit 12b which may have a same interval from the center part C of the bottom surface of the dielectric material block 111, and may be disposed to be adjacent to four corners formed by the intersection of the first side Ea and the second side Eb of the bottom surface of the dielectric material block 111.

Additionally, the example antenna device 200b according to the present example may include the first decoupling pattern 210, having the crossed shape, which may include a first portion 210a extending from the center portion connected to the shield via 13 between the first feed unit 11a and the second feed unit 11b, a second portion 210b extending from the center portion connected to the shield via 13 between the first feed unit 11a and the third feed unit 12a, a third portion 210c extending from the center portion connected to the shield via 13 between the second feed unit 11b and the fourth feed unit 12b, and a fourth portion 210d extending from the center portion connected to the shield via 13 between the third feed unit 12a and the fourth feed unit 12b.

In the example antenna device 200b according to the present example, in the dielectric material block 111, respective heights of the first feed unit 11a and the second feed unit 11b, and respective heights of the third feed unit 12a and the fourth feed unit 12b are formed differently may be different from each other, and the first feed unit 11a, the second feed unit 11b, the third feed unit 12a, and the fourth feed unit 12b may be disposed to be spaced apart from each other on two diagonals passing through the center part C so as to be symmetrical to each other with reference to the center part C of the bottom surface, and accordingly the RF signals of the different bands may be transmitted and/or received by implementing one dielectric material block 111, the bandwidth of the first polarization RF signal and the second polarization RF signal of the first bandwidth and the first polarization RF signal and the second polarization RF signal of the second bandwidth may be expanded, and the gain of the antenna device 200b may be increased by reducing interference between the first polarization RF signal and the second polarization RF signal of the first bandwidth and the first polarization RF signal and the second polarization RF signal of the second bandwidth.

Unlike the example antenna device 200a according to the example described with reference to FIG. 31 to FIG. 33 above, the example antenna device 200b according to the present example may not include the second decoupling pattern 220. However, the first portion 210a of the first decoupling pattern 210 may extend between the first feed unit 11a and the second feed unit 11b, the second portion 210b of the first decoupling pattern 210 may extend between the first feed unit 11a and the second feed unit 11b, the third portion 210c of the first decoupling pattern 210 may extend between the second feed unit 11b and the fourth feed unit 12b, and the fourth portion 210d of the first decoupling pattern 210 may extend between the third feed unit 12a and the fourth feed unit 12b. Therefore, through the first decoupling pattern 210 connected to the ground plane 201 together with the shield via 13 formed in the dielectric material block 111, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Many features of the example antennas 100a to 100t according to the examples described above are applicable to the antenna device 200b according to the present example.

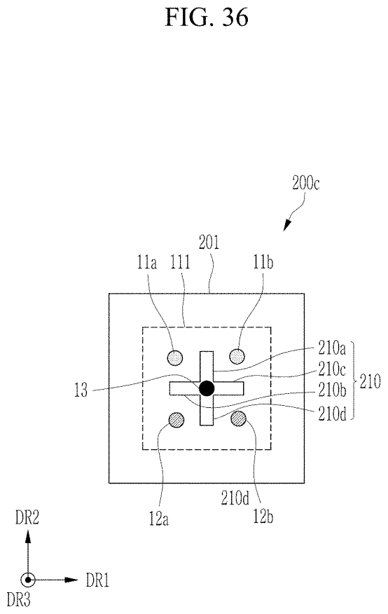

An antenna device 200c, in accordance with one or more embodiments, is described with reference to FIG. 36. FIG. 36 is a top plan view of a part of an example antenna device, in accordance with one or more embodiments.

Referring to FIG. 36, the example antenna device 200c, in accordance with one or more embodiments includes the first feed unit 11a and the second feed unit 11b, and the third feed unit 12a and the fourth feed unit 12b disposed in the dielectric material block 111, and the first decoupling pattern 210 connected to the shield via 13 and the ground plane 201.

Many features of the first feed unit 11a, the second feed unit 11b, the third feed unit 12a, the fourth feed unit 12b, and the shield via 13 of the example antenna device 200a according to the example described with reference to FIG. 31 to FIG. 33 above are applicable to the first feed unit 11a, the second feed unit 11b, the third feed unit 12a, the fourth feed unit 12b, and the shield via 13 of the antenna device 200c according to the present example.

The example antenna device 200c, in accordance with one or more embodiments, may include the first feed unit 11a, the second feed unit 11b, the third feed unit 12a, and the fourth feed unit 12b which may have a same interval from the center part C of the bottom surface of the dielectric material block 111, and may be disposed adjacent to four corners of the bottom surface of the dielectric material block 111.

Additionally, the example antenna device 200c, in accordance with one or more embodiments, may include the first decoupling pattern 210 having the crossed shape to include a first portion 210a extending from the center portion connected to the shield via 13 between the first feed unit 11a and the second feed unit 11b, a second portion 210b extending from the center portion connected to the shield via 13 between the first feed unit 11a and the third feed unit 12a, a third portion 210c extending from the center portion connected to the shield via 13 between the second feed unit 11b and the fourth feed unit 12b, and a fourth portion 210d extending from the center portion connected to the shield via 13 between the third feed unit 12a and the fourth feed unit 12b, and the width of the first decoupling pattern 210 of the antenna device 200c according to the present example may be wider than the width of the first decoupling pattern 210 of the antenna device 200b according to the example described above.

In the example antenna device 200c, in the dielectric material block 111, the respective heights of first feed unit 11a and second feed unit 11b, and the respective heights of the third feed unit 12a and fourth feed unit 12b may be different, and the first feed unit 11a, the second feed unit 11b, the third feed unit 12a, and the fourth feed unit 12b may be disposed to be spaced apart from each other on two diagonals passing through the center part C so as to be symmetrical to each other with reference to the center part C of the bottom surface, and accordingly the RF signals of the different bands may be transmitted and/or received by implementing one dielectric material block 111, the bandwidth of the first polarization RF signal and the second polarization RF signal of the first bandwidth and the first polarization RF signal and the second polarization RF signal of the second bandwidth may be expanded, and the gain of the antenna device 200c may be increased by reducing the interference between the first polarization RF signal and the second polarization RF signal of the first bandwidth and the first polarization RF signal and the second polarization RF signal of the second bandwidth.

The first portion 210a of the first decoupling pattern 210 may extend between the first feed unit 11a and the second feed unit 11b, the second portion 210b of the first decoupling pattern 210 may extend between the first feed unit 11a and the third feed unit 12a, the third portion 210c of the first decoupling pattern 210 may extend between the second feed unit 11b and the fourth feed unit 12b, the fourth portion 210d of the first decoupling pattern 210 may extend between the third feed unit 12a and the fourth feed unit 12b, and the width of the first decoupling pattern 210 of the antenna device 200c may be wider than the width of the first decoupling pattern 210 of the antenna device 200b according to the example described above.

Therefore, through the first decoupling pattern 210 connected to the ground plane 201 together with the shield via 13 formed in the dielectric material block 111, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and the interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Many features of the example antennas 100a to 100t according to the examples described above are applicable to the example antenna device 200c according to the present example.

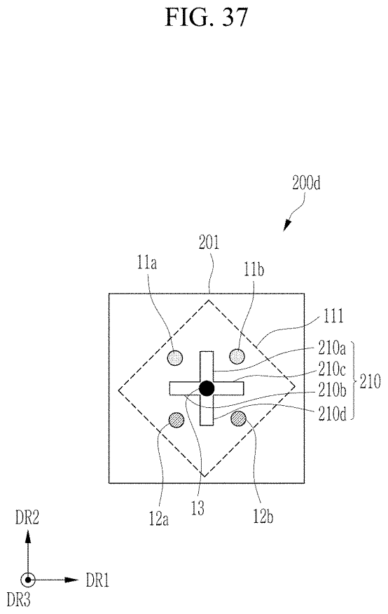

An example antenna device 200d, in accordance with one or more embodiments is described with reference to FIG. 37. FIG. 37 is a top plan view of a part of an example antenna device, in accordance with one or more embodiments.

Referring to FIG. 37, the example antenna device 200d, in accordance with one or more embodiments may include the first feed unit 11a, the second feed unit 11b, the third feed unit 12a, and the fourth feed unit 12b disposed in the dielectric material block 111, and the first decoupling pattern 210 connected to the shield via 13 and the ground plane 201.

Many features of the first feed unit 11a, the second feed unit 11b, the third feed unit 12a, the fourth feed unit 12b, and the shield via 13 of the example antenna device 200a described with reference to FIG. 31 to FIG. 33 above are applicable to the first feed unit 11a, the second feed unit 11b, the third feed unit 12a, the fourth feed unit 12b, and the shield via 13 of the example antenna device 200d according to the present example.

The first feed unit 11a, the second feed unit 11b, the third feed unit 12a and the fourth feed unit 12b of the example antenna device 200d may have a same interval from the center part C of the bottom surface of the dielectric material block 111, and may be disposed adjacent to the center part of the four sides of the bottom surface of the dielectric material block 111.

Additionally, the first decoupling pattern 210 of the example antenna device 200d may have the crossed shape that may include the first portion 210a extending between the first feed unit 11a and the second feed unit 11b toward four corners of the bottom surface of the dielectric material block 111 from the center portion connected to the shield via 13, the second portion 210b from the center portion connected to the shield via 13 between the first feed unit 11a and the third feed unit 12a, the third portion 210c extending from the center portion connected to the shield via 13 between the second feed unit 11b and the fourth feed unit 12b, and the fourth portion 210d from the center portion connected to the shield via 13 between the third feed unit 12a and the fourth feed unit 12b.

In the example antenna device 200d, in the dielectric material block 111, the respective heights of the first feed unit 11a, the second feed unit 11b, and the respective heights of the third feed unit 12a and the fourth feed unit 12b may be different, and the first feed unit 11a, the second feed unit 11b, the third feed unit 12a, and the fourth feed unit 12b may be disposed to be spaced apart each other on two straight lines passing through the center part C and parallel to two sides Ea and Eb of the bottom surface so as to be symmetrical to each other with reference to the center part C of the bottom surface, and accordingly the RF signals of the different bands may be transmitted/received by using one dielectric material block 111, the bandwidth of the first polarization RF signal and the second polarization RF signal of the first bandwidth and the first polarization RF signal and the second polarization RF signal of the second bandwidth may be expanded, and the gain of the antenna device 200d may be increased by reducing interference between the first polarization RF signal and the second polarization RF signal of the first bandwidth and the first polarization RF signal and the second polarization RF signal of the second bandwidth.

By including the first decoupling pattern 210 having the crossed shape that includes the first portion 210a extending between the first feed unit 11a and the second feed unit 11b toward four corners of the bottom surface of the dielectric material block 111 from the center portion connected to the shield via 13, the second portion 210b from the center portion connected to the shield via 13 between the first feed unit 11a and the third feed unit 12a, the third portion 210c extending from the center portion connected to the shield via 13 between the second feed unit 11b and the fourth feed unit 12b, and the fourth portion 210d extending from the center portion connected to the shield via 13 between the third feed unit 12a and the fourth feed unit 12b, the interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b may be reduced, the interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and the interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Many features of the example antennas 100a to 100t according to the examples described above are applicable to the example antenna device 200d.

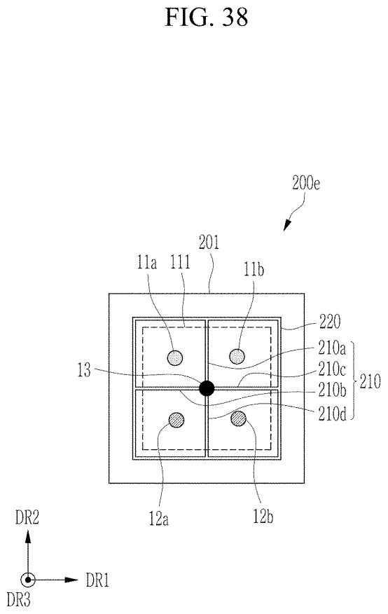

An example antenna device 200e, in accordance with one or more embodiments is described with reference to FIG. 38. FIG. 38 is a top plan view of a part of an example antenna device, in accordance with one or more embodiments.

Referring to FIG. 38, the example antenna device 200e, in accordance with one or more embodiments, t may include the first feed unit 11a, the second feed unit 11b, the third feed unit 12a, and the fourth feed unit 12b disposed in the dielectric material block 111, and the first decoupling pattern 210 and the second decoupling pattern 220 connected to the shield via 13 and the ground plane 201.

Many features of the first feed unit 11a, the second feed unit 11b, the third feed unit 12a, the fourth feed unit 12b, and the shield via 13 of the example antenna device 200a described with reference to FIG. 31 to FIG. 33 above are applicable to the first feed unit 11a, the second feed unit 11b, the third feed unit 12a, the fourth feed unit 12b, and the shield via 13 of the example antenna device 200e.

The example antenna device 200e may include the first feed unit 11a, the second feed unit 11b, the third feed unit 12a, and the fourth feed unit 12b which may have a same interval from the center part C of the bottom surface of the dielectric material block 111, and may be disposed to be adjacent to four corners formed by the intersection of the first side Ea and the second side Eb of the bottom surface of the dielectric material block 111.

Additionally, the example antenna device 200e may include the first decoupling pattern 210 having the crossed shape, and including the first portion 210a extending from the center portion connected to the shield via 13 between the first feed unit 11a and the second feed unit 11b, the second portion 210b extending from the center portion connected to the shield via 13 between the first feed unit 11a and the third feed unit 12a, the third portion 210c extending from the center portion connected to the shield via 13 between the second feed unit 11b and the fourth feed unit 12b, and the fourth portion 210d extending from the center portion connected to the shield via 13 between the third feed unit 12a and the fourth feed unit 12b, and a second decoupling pattern 220 that is connected to the first decoupling pattern 210 and forms a decoupling pattern in a form of four quadrangles surrounding the first feed unit 11a, the second feed unit 11b, the third feed unit 12a, and the fourth feed unit 12b together with the first decoupling pattern 210.

In the example antenna device 200e, in the dielectric material block 111, the respective heights of the first feed unit 11a and the second feed unit 11b, and the respective heights of the third feed unit 12a, and the fourth feed unit 12b may be different, and the first feed unit 11a, the second feed unit 11b, the third feed unit 12a, and the fourth feed unit 12b may be disposed to be spaced apart from each other on two diagonals passing through the center part C so as to be symmetrical to each other with reference to the center part C of the bottom surface, and accordingly the RF signals of the different bands may be transmitted and/or received by implementing one dielectric material block 111, the bandwidth of the first polarization RF signal and the second polarization RF signal of the first bandwidth and the first polarization RF signal and the second polarization RF signal of the second bandwidth may be expanded, and the gain of the antenna device 200e may be increased by reducing interference between the first polarization RF signal and the second polarization RF signal of the first bandwidth and the first polarization RF signal and the second polarization RF signal of the second bandwidth.

Additionally, by including the first decoupling pattern 210 and the second decoupling pattern 220 that form four quadrangular shapes surrounding the first feed unit 11a, the second feed unit 11b, the third feed unit 12a, and the fourth feed unit 12b, through the shield via 13, and the first decoupling pattern 210 and the second decoupling pattern 220, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b, may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and the interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b, may be reduced.

Many features of the antennas 100a to 100t according to the examples described above are applicable to the example antenna device 200e.

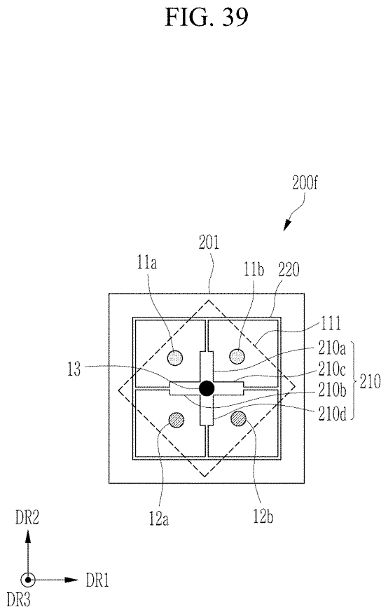

An example antenna device 200f according to another embodiment is described with reference to FIG. 39. FIG. 39 is a top plan view of a part of an antenna device according to another embodiment.

Referring to FIG. 39, the antenna device 200e, in accordance with one or more embodiments may include the first feed unit 11a, the second feed unit 11b, the third feed unit 12a, the fourth feed unit 12b formed in the dielectric material block 111, and the first decoupling pattern 210 and the second decoupling pattern 220 connected to the shield via 13 and the ground plane 201.

Many features of the first feed unit 11a, the second feed unit 11b, the third feed unit 12a, the fourth feed unit 12b and the shield via 13 of the example antenna device 200a described with reference to FIG. 31 to FIG. 33 above are applicable to the first feed unit 11a, the second feed unit 11b, the third feed unit 12a, the fourth feed unit 12b, and the shield via 13 of the example antenna device 200f.

The example antenna device 200f, in accordance with one or more embodiments, may include the first feed unit 11a, the second feed unit 11b, the third feed unit 12a, and the fourth feed unit 12b which may have a same interval from the center part C of the bottom surface of the dielectric material block 111, and may be disposed to be adjacent to four corners formed by the intersection of the first side Ea and the second side Eb of the bottom surface of the dielectric material block 111.

Additionally, the example antenna device 200f may include the first decoupling pattern 210 having the cross shape to include the first portion 210a extending from the center portion connected to the shield via 13 between the first feed unit 11a and the second feed unit 11b, the second portion 210b extending from the center portion connected to the shield via 13 between the first feed unit 11a and the third feed unit 12a, the third portion 210c extending from the center portion connected to the shield via 13 between the second feed unit 11b and the fourth feed unit 12b, and the fourth portion 210d extending from the center portion connected to the shield via 13 between the third feed unit 12a and the fourth feed unit 12b, and the second decoupling pattern 220 that is connected to the first decoupling pattern 210 and forms the decoupling pattern in the form of four quadrangles surrounding the first feed unit 11a, the second feed unit 11b, the third feed unit 12a, and the fourth feed unit 12b together with the first decoupling pattern 210.

In the example antenna device 200f, in a dielectric material block 111, the respective heights of the first feed unit 11a and the second feed unit 11b, and the respective heights of the third feed unit 12a and the fourth feed unit 12b may be different, and the first feed unit 11a, the second feed unit 11b, the third feed unit 12a, and the fourth feed unit 12b may be disposed to be spaced apart from each other on two diagonals passing through the center part C so as to be symmetrical to each other with reference to the center part C of the bottom surface, and accordingly the RF signals of the different bands may be transmitted and/or received by implementing one dielectric material block 111, the bandwidth of the first polarization RF signal and the second polarization RF signal of the first bandwidth and the first polarization RF signal and the second polarization RF signal of the second bandwidth may be expanded, and the gain of the antenna device 200f may be increased by reducing interference between the first polarization RF signal and the second polarization RF signal of the first bandwidth and the first polarization RF signal and the second polarization RF signal of the second bandwidth.

Additionally, by including the first decoupling pattern 210 and the second decoupling pattern 220 which form four quadrangular shapes surrounding the first feed unit 11a, the second feed unit 11b, the third feed unit 12a, and the fourth feed unit 12b, through the shield via 13, the first decoupling pattern 210 and the second decoupling pattern 220, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Additionally, the first side Ea and the second side Eb of the bottom surface of the dielectric material block 111 may form an oblique line instead of being parallel to the edge of the ground plane 201. Accordingly, by disposing the first side Ea and the second side Eb of the bottom surface of the dielectric material block 111 to form the oblique line with the edge of the ground plane 201, when disposing a plurality of dielectric material blocks 111, an area of the adjacent portion between the adjacent dielectric material blocks 111 may be disposed to be narrow, thereby reducing interference between the RF signals transmitted and received by the resonance frequencies within two adjacent dielectric material blocks 111.

Many features of the example antennas 100a to 100t according to the examples described above are applicable to the example antenna device 200f.

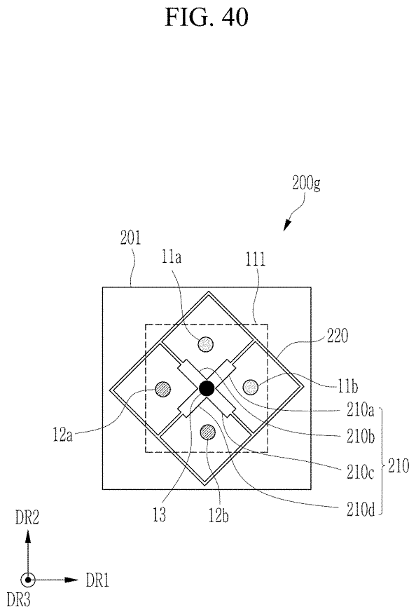

Next, an example antenna device 200g, in accordance with one or more embodiments is described with reference to FIG. 40. FIG. 40 is a top plan view of a part of an example antenna device, in accordance with one or more embodiments.

Referring to FIG. 40, the example antenna device 200e, in accordance with one or more embodiments, may include the first feed unit 11a, the second feed unit 11b, the third feed unit 12a, the fourth feed unit 12b disposed in the dielectric material block 111, and the first decoupling pattern 210 and the second decoupling pattern 220 connected to the shield via 13 and the ground plane 201.

Many features of the first feed unit 11a, the second feed unit 11b, the third feed unit 12a, the fourth feed unit 12b, and the shield via 13 of the example antenna device 200a described with reference to FIG. 31 to FIG. 33 above are applicable to the first feed unit 11a, the second feed unit 11b, the third feed unit 12a, the fourth feed unit 12b, and the shield via 13 of the example antenna device 200g.

The example antenna device 200g may include the first feed unit 11a, the second feed unit 11b, the third feed unit 12a, and the fourth feed unit 12b that may have a same interval from the center part C of the bottom surface of the dielectric material block 111, and may be disposed adjacent to the center part of four sides of the bottom surface of the dielectric material block 111.

Additionally, the example antenna device 200g may include the first decoupling pattern 210 having a crossed “X” shape that includes the first portion 210a extending between the first feed unit 11a and the second feed unit 11b from the center portion connected to the shield via 13 toward four corners of the dielectric material block 111, the second portion 210b from the center portion connected to the shield via 13 between the first feed unit 11a and the third feed unit 12a, the third portion 210c from the center portion connected to the shield via 13 between the second feed unit 11b and the fourth feed unit 12b, and the fourth portion 210d from the center portion connected to the shield via 13 between the third feed unit 12a and the fourth feed unit 12b, and the second decoupling pattern 220 that is connected to the first decoupling pattern 210 and forms a decoupling pattern in the form of four rhombi surrounding the first feed unit 11a, the second feed unit 11b, the third feed unit 12a, and the fourth feed unit 12b together with the first decoupling pattern 210.

In the example antenna device 200g, in the dielectric material block 111, the respective heights of the first feed unit 11a and the second feed unit 11b, and the respective heights of the third feed unit 12a and the fourth feed unit 12b, may be different, and the first feed unit 11a, the second feed unit 11b, the third feed unit 12a, and the fourth feed unit 12b may be disposed to be spaced apart from each other on two straight lines passing through the center part C and may be parallel to two sides Ea and Eb of the bottom surface of the dielectric material block 111 so as to be symmetrical to each other with reference to the center part C of the bottom surface of the dielectric material block 111, and accordingly the RF signals of the different bands may be transmitted and/or received by implementing one dielectric material block 111, the bandwidth of the first polarization RF signal and the second polarization RF signal of the first bandwidth and the first polarization RF signal and the second polarization RF signal of the second bandwidth may be expanded, and the gain of the antenna device 200g may be increased by reducing interference between the first polarization RF signal and the second polarization RF signal of the first bandwidth and the first polarization RF signal and the second polarization RF signal of the second bandwidth.

Additionally, since the example antenna device 200g may include the first decoupling pattern 210 and the second decoupling pattern 220 that may form four rhombus shapes surrounding each of the first feed unit 11a, the second feed unit 11b, the third feed unit 12a, and the fourth feed unit 12b, through the shield via 13, the first decoupling pattern 210, and the second decoupling pattern 220, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and fourth feed unit 12b, may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Many features of the antennas 100a to 100t according to the examples described above are applicable to the example antenna device 200g.

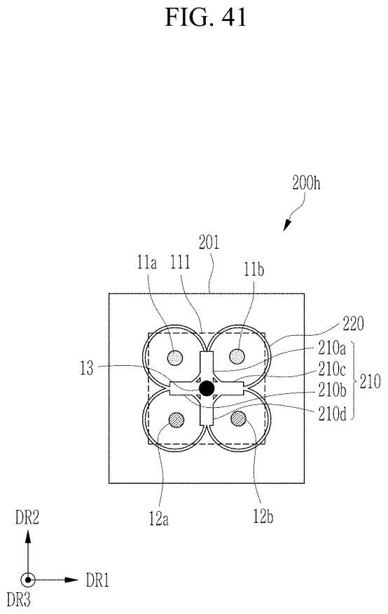

An example antenna device 200h, in accordance with one or more embodiments, is described with reference to FIG. 41. FIG. 41 is a top plan view of a part of an example antenna device, in accordance with one or more embodiments.

Referring to FIG. 41, the example antenna device 200e, in accordance with one or more embodiments, may include the first feed unit 11a, the second feed unit 11b, the third feed unit 12a, and the fourth feed unit 12b formed in the dielectric material block 111, and the first decoupling pattern 210 and the second decoupling pattern 220 connected to the shield via 13 and the ground plane 201.

Many features of the first feed unit 11a, the second feed unit 11b, the third feed unit 12a, the fourth feed unit 12b, and the shield via 13 of the example antenna device 200a described with reference to FIG. 31 to FIG. 33 above are applicable to the first feed unit 11a, the second feed unit 11b, the third feed unit 12a, the fourth feed unit 12b, and the shield via 13 of the example antenna device 200h.

The example antenna device 200h may include the first feed unit 11a, the second feed unit 11b, the third feed unit 12a, and the fourth feed unit 12b having the same interval from the center part C of the bottom surface of the dielectric material block 111 and may be disposed to be adjacent to four corners formed by the intersection of the first side Ea and the second side Eb of the bottom surface of the dielectric material block 111.

Additionally, the example antenna device 200h may include the first decoupling pattern 210 which may have a crossed shape that includes a first portion 210a extending from the center portion connected to the shield via 13 between the first feed unit 11a and the second feed unit 11b, a second portion 210b extending from the center portion connected to the shield via 13 between the first feed unit 11a and the third feed unit 12a, a third portion 210c extending from the center portion connected to the shield via 13 between the second feed unit 11b and the fourth feed unit 12b, and a fourth portion 210d extending from the center portion connected to the shield via 13 between the third feed unit 12a and the fourth feed unit 12b, and the second decoupling pattern 220 that is connected to the first decoupling pattern 210 and has a form of four circles surrounding the first feed unit 11a, the second feed unit 11b, the third feed unit 12a, and the fourth feed unit 12b.

In the example antenna device 200h, in the dielectric material block 111, the respective heights of the first feed unit 11a and the second feed unit 11b, and the respective heights of the third feed unit 12a and the fourth feed unit 12b, may be different, and the first feed unit 11a, the second feed unit 11b, the third feed unit 12a, and the fourth feed unit 12b may be disposed on two diagonals passing through the center part C, and may be spaced apart from each other so as to be symmetrical to each other with reference to the center part C of the bottom surface, and accordingly the RF signals of the different bands may be transmitted and/or received by implementing one dielectric material block 111, the bandwidth of the first polarization RF signal and the second polarization RF signal of the first bandwidth and the first polarization RF signal and the second polarization RF signal of the second bandwidth may be expanded, and the gain of the antenna device 200h may be increased by reducing the interference between the first polarization RF signal and the second polarization RF signal of the first bandwidth and the first polarization RF signal and the second polarization RF signal of the second bandwidth.

Since the example antenna device 200h may include the first decoupling pattern 210 and the second decoupling pattern 220 surrounding the first feed unit 11a, the second feed unit 11b, the third feed unit 12a, and the fourth feed unit 12b, through the first decoupling pattern 210 and the second decoupling pattern 220 connected to the ground plane 201 together with the shield via 13 formed in the dielectric material block 111, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b, may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Many features of the antennas 100a to 100t according to the examples described above are applicable to the example antenna device 200h.

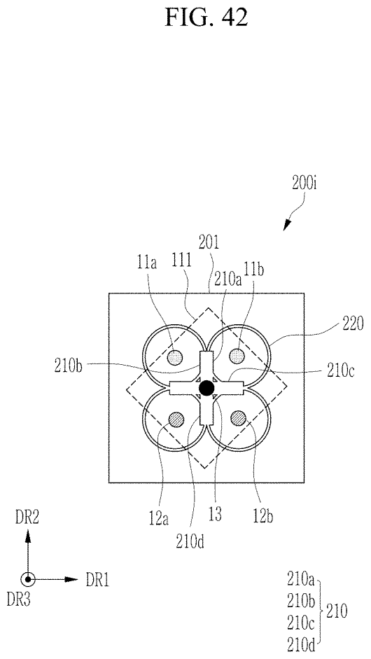

An example antenna device 200i, in accordance with one or more embodiments, is described with reference to FIG. 42. FIG. 42 is a top plan view of a part of an example antenna device, in accordance with one or more embodiments.

Referring to FIG. 42, the example antenna device 200i may include the first feed unit 11a, the second feed unit 11b, the third feed unit 12a, and the fourth feed unit 12b formed in the dielectric material block 111, and the first decoupling pattern 210 and the second decoupling pattern 220 connected to the shield via 13 and the ground plane 201.

Many features of the first feed unit 11a, the second feed unit 11b, the third feed unit 12a, the fourth feed unit 12b, and the shield via 13 of the example antenna device 200a described with reference to FIG. 31 to FIG. 33 above are applicable to the first feed unit 11a, the second feed unit 11b, the third feed unit 12a, the fourth feed unit 12b, and the shield via 13 of the example antenna device 200i.

The example antenna device 200i may include the first feed unit 11a, the second feed unit 11b, the third feed unit 12a, and the fourth feed unit 12b that have the same interval from the center part C of the bottom surface of the dielectric material block 111 may be disposed adjacent to the center portions of four sides of the bottom surface of the dielectric material block 111, and are disposed on two straight lines passing through the center part C of the bottom surface of the dielectric material block 111 and parallel to four sides of the bottom surface of the dielectric material block 111.

Additionally, the example antenna device 200i may include the first decoupling pattern 210 having the crossed shape to include the first portion 210a extending between the first feed unit 11a and the second feed unit 11b toward four corners of the bottom surface dielectric material block 111 from the center portion connected to the shield via 13, the second portion 210b extending between the second feed unit 11b and the third feed unit 12a from the center portion connected to the shield via 13, and the third portion 210c extending between the third feed unit 12a and the fourth feed unit 12b from the center portion connected to the shield via 13, and the fourth portion 210d from the center portion connected to the shield via 13 between the fourth feed unit 12b and the first feed unit 11a, and the second decoupling pattern 220 that is connected to the first decoupling pattern 210 and forms a decoupling pattern of four circular shapes surrounding the first feed unit 11a, the second feed unit 11b, the third feed unit 12am and the fourth feed unit 12b together with the first decoupling pattern 210.

In the example antenna device 200i, in the dielectric material block 111, the respective heights of the first feed unit 11a and the second feed unit 11b, and the respective heights of the third feed unit 12a and the fourth feed unit 12bm may be different, and the first feed unit 11a, the second feed unit 11b, the third feed unit 12a and the fourth feed unit 12b may be disposed to be spaced apart from each other on two straight lines passing the center part C so as to be symmetrical to each other with reference to the center part C of the bottom surface, and accordingly the RF signals of the different bands may be transmitted and/or received by implementing a single dielectric material block 111, the bandwidth of the first polarization RF signal and the second polarization RF signal of the first bandwidth and the first polarization RF signal and the second polarization RF signal of the second bandwidth may be expanded, and the gain of the antenna device 200i may be increased by reducing interference between the first polarization RF signal and the second polarization RF signal of the first bandwidth and the first polarization RF signal and the second polarization RF signal of the second bandwidth.

Additionally, since the example antenna device 200i may include the first decoupling pattern 210 and the second decoupling pattern 220 surrounding the first feed unit 11a, the second feed unit 11b, the third feed unit 12a, and the fourth feed unit 12b, through the first decoupling pattern 210 and the second decoupling pattern 220 connected to the ground plane 201 together with the shield via 13 formed in the dielectric material block 111, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b, may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Additionally, the first side Ea and the second side Eb of the bottom surface of the dielectric material block 111 of the example antenna device 200i may form an oblique line instead of being parallel to the edge of the ground plane 201. Accordingly, by disposing the first side Ea and the second side Eb of the bottom surface of the dielectric material block 111 to form the oblique line with the edge of the ground plane 201, when disposing a plurality of dielectric material blocks 111, an area of the adjacent portion between the adjacent dielectric material blocks 111 may be disposed to be narrow, thereby reducing interference between the RF signals transmitted and received by the resonance frequencies within two adjacent dielectric material blocks 111.

Many features of the example antennas 100a to 100t described above are applicable to the example antenna device 200i.

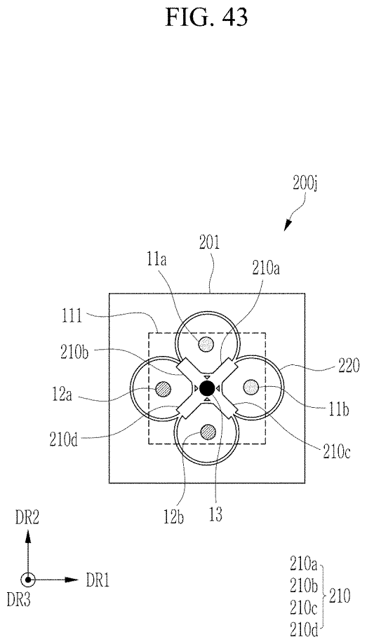

An example antenna device 200j is described with reference to FIG. 43. FIG. 43 is a top plan view of a part of an example antenna device.

Referring to FIG. 43, the example antenna device 200e may include the first feed unit 11a, the second feed unit 11b, the third feed unit 12a, and the fourth feed unit 12b formed in the dielectric material block 111, and the first decoupling pattern 210 and the second decoupling pattern 220 connected to the shield via 13 and the ground plane 201.

Many features of the first feed unit 11a, the second feed unit 11b, the third feed unit 12a, the fourth feed unit 12b, and the shield via 13 of the example antenna device 200a described with reference to FIG. 31 to FIG. 33 above are applicable to the first feed unit 11a, the second feed unit 11b, the third feed unit 12a, the fourth feed unit 12b, and the shield via 13 of the example antenna device 200j.

The example antenna device 200j may include the first feed unit 11a, the second feed unit 11b, the third feed unit 12a, and the fourth feed unit 12b that may have a same interval from the center part C of the bottom surface of the dielectric material block 111, and may be disposed adjacent to the center portions of four sides of the bottom surface of the dielectric material block 111.

Additionally, the example antenna device 200j may include the first decoupling pattern 210 having the crossed shape to include the first portion 210a extending between the first feed unit 11a and the second feed unit 11b toward four corners of the bottom surface dielectric material block 111 from the center portion connected to the shield via 13, the second portion 210b extending between the second feed unit 11b and the third feed unit 12a from the center portion connected to the shield via 13, the third portion 210c extending between the third feed unit 12a and the fourth feed unit 12b from the center portion connected to the shield via 13, and the fourth portion 210d extending from the center portion connected to the shield via 13 between the fourth feed unit 12b and the first feed unit 11a, and the second decoupling pattern 220 that is connected to the first decoupling pattern 210 and forms a decoupling pattern of four circular shapes surrounding the first feed unit 11a, the second feed unit 11b, the third feed unit 12a, and the fourth feed unit 12b together with the first decoupling pattern 210.

In the example antenna device 200j, the heights of the first feed unit 11a and the second feed unit 11b, and the third feed unit 12a and the fourth feed unit 12b, may be formed differently in the dielectric material block 111, and the first feed unit 11a, the second feed unit 11b, the third feed unit 12a, and the fourth feed unit 12b may be disposed to be spaced apart from each other on two imaginary straight lines passing the center part C so as to be symmetrical to each other with reference to the center part C of the bottom surface, and accordingly the RF signals of the different bands may be transmitted and/or received by implementing a single dielectric material block 111, the bandwidth of the first polarization RF signal and the second polarization RF signal of the first bandwidth and the first polarization RF signal and the second polarization RF signal of the second bandwidth may be expanded, and the gain of the antenna device 200j may be increased by reducing the interference between the first polarization RF signal and the second polarization RF signal of the first bandwidth and the first polarization RF signal and the second polarization RF signal of the second bandwidth.

The example antenna device 200j may include the first decoupling pattern 210 and the second decoupling pattern 220 that form the decoupling pattern of four circular shapes surrounding the first feed unit 11a, the second feed unit 11b, the third feed unit 12a, and the fourth feed unit 12b. Therefore, through the first decoupling pattern 210 and the second decoupling pattern 220 connected to the ground plane 201 together with the shield via 13 formed on the dielectric material block 111, interference between the first polarization RF signal and the second polarization RF signal of the first bandwidth transmitted and received by the electrical signal applied to the first feed unit 11a and the second feed unit 11b, and the first polarization RF signal and the second polarization RF signal of the second bandwidth transmitted and received by the electrical signal applied to the third feed unit 12a and the fourth feed unit 12b, may be reduced, interference between the first polarization RF signal of the first bandwidth transmitted and received by the electrical signal applied to the first feed unit 11a and the second polarization RF signal of the first bandwidth transmitted and received by the electrical signal applied to the second feed unit 11b may be reduced, and interference between the first polarization RF signal of the second bandwidth transmitted and received by the electrical signal applied to the third feed unit 12a and the second polarization RF signal of the second bandwidth transmitted and received by the electrical signal applied to the fourth feed unit 12b may be reduced.

Many features of the antennas 100a to 100t and 100 according to the embodiments described above are applicable to the antenna device 200j according to the present embodiment.

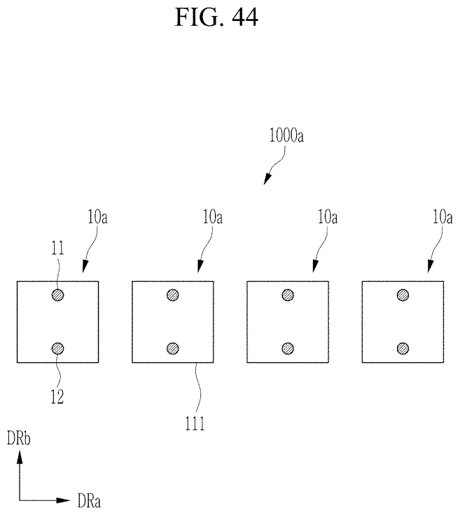

Next, an example antenna device 1000a, in accordance with one or more embodiments, is described with reference to FIG. 44. FIG. 44 is a layout view of an example antenna device, in accordance with one or more embodiments.

Referring to FIG. 44, the example antenna device 1000a may include a plurality of antennas 10a arranged along an arrangement direction DRa.

A plurality of example antennas 10a, like the antennas 100a, 100c, and 100k according to the above-described examples, may include the first feed unit 11 and the second feed unit 12 disposed adjacent to the center portion of two sides parallel to the dielectric material block 111.

The edges of the bottom surface of the dielectric material block 111 of a plurality of example antennas 10a may be parallel to or substantially perpendicular to the arrangement direction DRa, and the first feed unit 11 and the second feed unit 12 of a plurality of antennas 10a may face to each other along a right-angled direction DRb perpendicular to the arrangement direction DRa and overlap the straight line passing through the center part of the bottom surface of the dielectric material block 111 and parallel to the right-angled direction DRb.

Accordingly, by disposing the first feed unit 11 and the second feed unit 12 of a plurality of example antennas 10a to face each other along the right-angled direction DRb, the resonance direction of the RF signals of each antenna 10a may be parallel to the right-angled direction DRb, thereby preventing the RF signals of the adjacent antennas 10a from interfering with each other.

Many features of the antennas 100a to 100t according to the examples described above are applicable to the example antenna device 1000a.

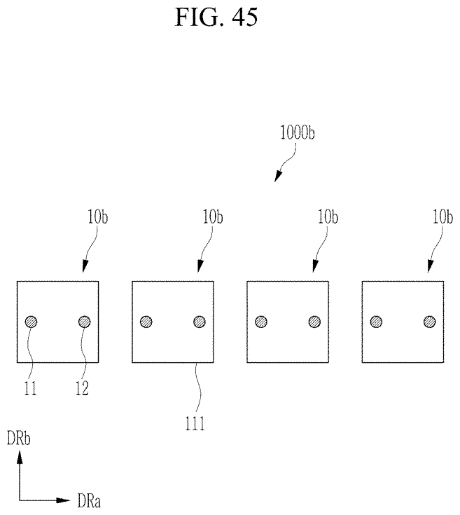

An example antenna device 1000b, in accordance with one or more embodiments, is described with reference to FIG. 45. FIG. 45 is a layout view of an example antenna device, in accordance with one or more embodiments.

Referring to FIG. 45, the example antenna device 1000b, in accordance with one or more embodiments may include a plurality of antennas 10b arranged along the arrangement direction DRa.

A plurality of example antennas 10b, like the antennas 100a, 100c, and 100k according to the above-described examples, may include the first feed unit 11 and the second feed unit 12 disposed adjacent to the center portion of two sides of the dielectric material block 111.

The edges of the bottom surface of the dielectric material block 111 of a plurality of antennas 10a may be parallel to, or substantially perpendicular to, the arrangement direction DRa, and the first feed unit 11 and the second feed unit 12 of the plurality of antennas 10a may face each other along the direction parallel to the arrangement direction DRa and overlap the imaginary straight line passing through the center part of the bottom surface of the dielectric material block 111 and parallel to the arrangement direction DRa.

Accordingly, by disposing the first feed unit 11 and the second feed unit 12 of a plurality of example antennas 10a to face each other along the direction parallel to the arrangement direction DRa, the resonance direction of the RF signals of each antenna 10a may be parallel to the arrangement direction DRa, thereby the RF signals of the adjacent antennas 10a may be strengthened along the antenna arrangement direction DRa.

Many features of the antennas 100a to 100t according to the examples described above are applicable to the example antenna device 1000b.

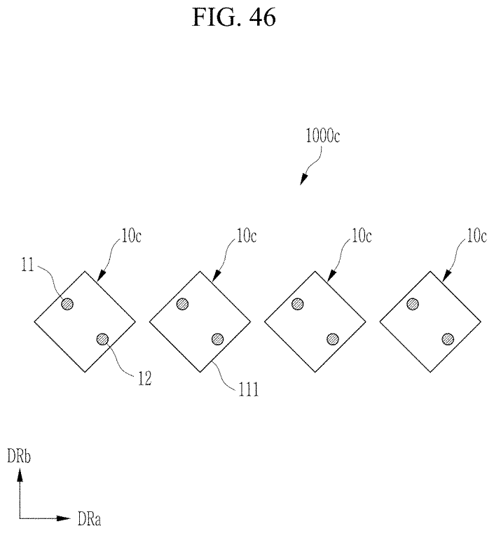

An example antenna device 1000c, in accordance with one or more embodiments, is described with reference to FIG. 46. FIG. 46 is a layout view of an example antenna device, in accordance with one or more embodiments.

Referring to FIG. 46, the example antenna device 1000c may include a plurality of antennas 10c arranged along the arrangement direction DRa.

A plurality of example antennas 10c, like the antennas 100a, 100c, and 100k according to the above-described examples, may include the first feed unit 11 and the second feed unit 12 disposed adjacent to the center portion of two sides of the dielectric material block 111.

The edges of the bottom surface of the dielectric material block 111 of a plurality of example antennas 10c may form an oblique line with respect to the arrangement direction DRa, and the first feed unit 11 and the second feed unit 12 of a plurality of example antennas 10c may face each other along the direction oblique to the arrangement direction DRa and overlap the imaginary straight line passing through the center part of the bottom surface of the dielectric material block 111 and parallel to the direction oblique to the arrangement direction DRa.

Accordingly, the edges of the bottom surface of the dielectric material block 111 of the plurality of antennas 10c may be disposed to form the oblique line with respect to the arrangement direction DRa, thereby reducing the area of the adjacent portion between the two adjacent antennas 10c, thereby reducing interference between the two adjacent antennas 10c.

Many features of the example antennas 100a to 100t according to the examples described above are applicable to the example antenna device 1000c, in accordance with one or more embodiments.

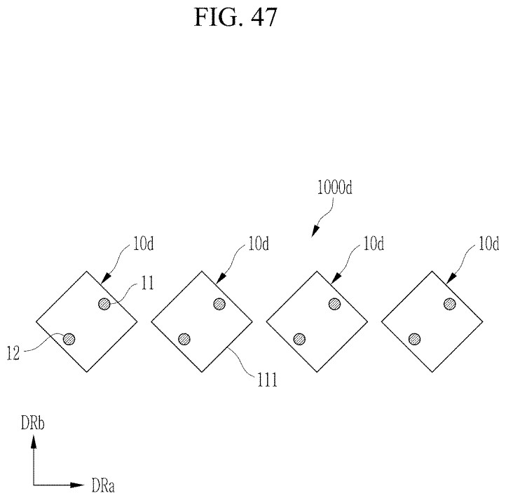

An example antenna device 1000d, in accordance with one or more embodiments, is described with reference to FIG. 47. FIG. 47 is a layout view of an example antenna device, in accordance with one or more embodiments.

Referring to FIG. 47, the example antenna device 1000d may include a plurality of antennas 10d arranged along the arrangement direction DRa.

A plurality of antennas 10d, like the antennas 100a, 100c, and 100k according to the above-described examples, may include the first feed unit 11 and the second feed unit 12 disposed adjacent to the center portion of two sides of the dielectric material block 111.

The edges of the bottom surface of the dielectric material block 111 of a plurality of example antennas 10d may form the oblique line with respect to the arrangement direction DRa, and the first feed unit 11 and the second feed unit 12 of a plurality of antennas 10c may face each other along the direction oblique to the arrangement direction DRa and overlap the straight line passing through the center part of the bottom surface of the dielectric material block 111 and parallel to the direction oblique to the arrangement direction DRa.

Accordingly, by disposing the edges of the bottom surface of the dielectric material block 111 of a plurality of antennas 10d to form the oblique line with respect to the arrangement direction DRa, the area of the adjacent portion between two adjacent antennas 10d may be reduced, thereby reducing interference between two adjacent antennas 10d.

Many features of the antennas 100a to 100t according to the examples described above are applicable to the example antenna device 1000d.

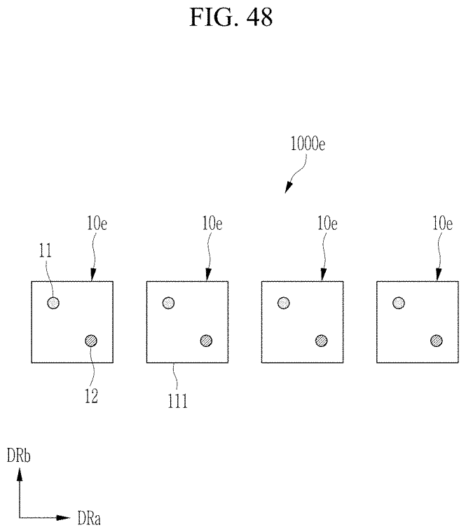

An example antenna device 1000e, in accordance with one or more embodiments, is described with reference to FIG. 48. FIG. 48 is a layout view of an example antenna device, in accordance with one or more embodiments.

Referring to FIG. 48, the example antenna device 1000e may include a plurality of example antennas 10e arranged along the arrangement direction DRa.

A plurality of example antennas 10e, like the antennas 100b, 100d, 1001, and 100p according to the above-described examples, may include the first feed unit 11 and the second feed unit 12 disposed adjacent to two opposing corners of the bottom surface of the dielectric material block 111.

The edges of the bottom surface of the dielectric material block 111 of a plurality of antennas 10e may be parallel to, or substantially perpendicular to, the arrangement direction DRa, and the first feed unit 11 and the second feed unit 12 of a plurality of antennas 10e may face each other along the oblique direction oblique line to the arrangement direction DRa and overlap the imaginary straight line passing through the center part of the bottom surface of the dielectric material block 111 and parallel to the oblique direction.

Accordingly, by disposing the first feed unit 11 and the second feed unit 12 of a plurality of antennas 10e to face each other along the oblique direction oblique to the arrangement direction DRa, the resonance direction of the RF signals of each of the antennas 10e may be parallel to the diagonal direction forming the oblique line with the arrangement direction DRa, thereby preventing the RF signals of the adjacent antennas 10e from interfering with each other.

Many features of the example antennas 100a to 100t according to the examples described above are applicable to the example antenna device 1000e.

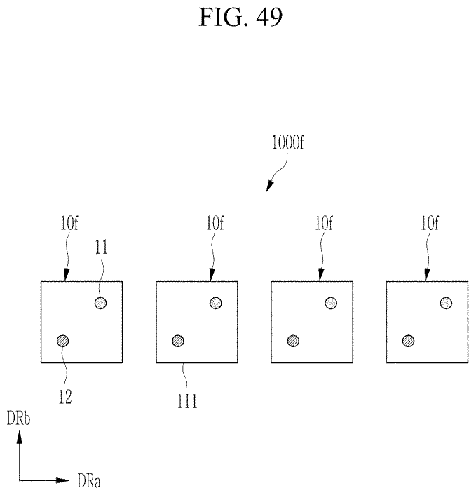

An example antenna device 1000f, in accordance with one or more embodiments is described with reference to FIG. 49. FIG. 49 is a layout view of an example antenna device, in accordance with one or more embodiments.

Referring to FIG. 49, the example antenna device 1000f may include a plurality of example antennas 10f arranged along the arrangement direction DRa.

A plurality of antennas 10f, like the example antennas 100b, 100d, 1001, and 100p described above, may include the first feed unit 11 and the second feed unit 12, that are disposed adjacent to two opposing corner portions of the bottom surface of the dielectric material block 111, the edges of the bottom surface of the dielectric material block 111 of a plurality of antennas 10f may be parallel to, or substantially perpendicular to, the arrangement direction DRa, and the first feed unit 11 and the second feed unit 12 may face each other along the oblique direction oblique to the arrangement direction DRa and overlap the straight line passing through the center part of the bottom surface of the dielectric material block 111 and parallel to the oblique direction.

Accordingly, by disposing the first feed unit 11 and the second feed unit 12 of a plurality of antennas 10f to face each other along the oblique direction oblique to the arrangement direction DRa, the resonance direction of the RF signals of each of the antennas 10f may be parallel to the oblique direction oblique to the arrangement direction DRa, thereby preventing the RF signals of the adjacent antennas 10f from interfering with each other.

Many features of the example antennas 100a to 100t according to the examples described above are applicable to the example antenna device 1000f.

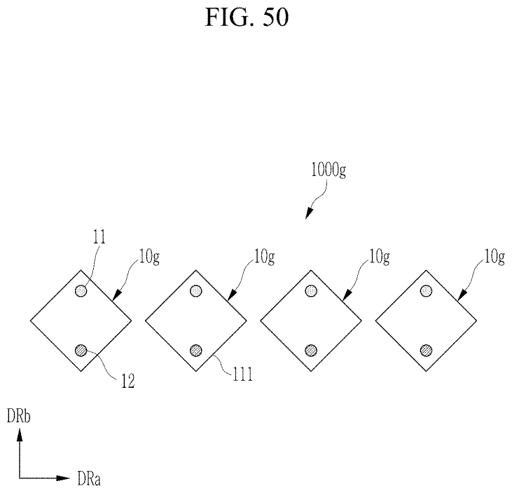

An example antenna device 1000g, in accordance with one or more embodiments is described with reference to FIG. 50. FIG. 50 is a layout view of an example antenna device, in accordance with one or more embodiments.

Referring to FIG. 50, the example antenna device 1000g may include a plurality of example antennas 10g arranged along the arrangement direction DRa.

A plurality of antennas 10g, like the example antennas 100a, 100c, and 100k, may include the first feed unit 11 and the second feed unit 12 disposed adjacent to the center portion of two sides of the dielectric material block 111.

The edges of the bottom surface of the dielectric material block 111 of a plurality of antennas 10g may be oblique with respect to the arrangement direction DRa, and the first feed unit 11 and the second feed unit 12 of a plurality of antennas 10g may face each other along the right-angled direction DRb perpendicular to the arrangement direction DRa and overlap the imaginary straight line passing through the center part of the bottom surface of the dielectric material block 111 and parallel to the right-angled direction DRb.

Accordingly, a plurality of antennas 10g may be disposed so that the edges of the bottom surface of the dielectric material block 111 of a plurality of antennas 10g are oblique to the arrangement direction DRa, thereby reducing the area of the adjacent portion between two adjacent antennas 10g, and then reducing interference between two adjacent antennas 10g.

Many features of the example antennas 100a to 100t described above are applicable to the example antenna device 1000g.

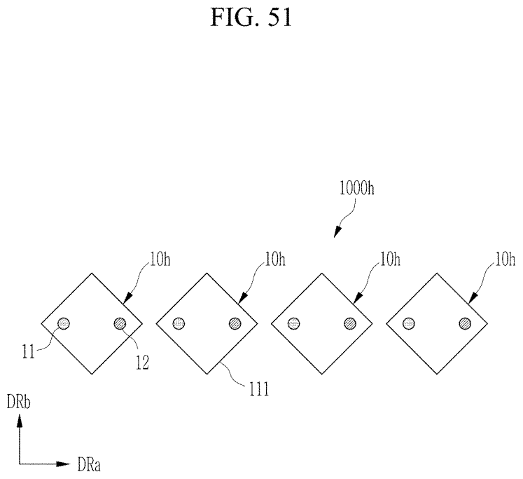

An example antenna device 1000h, in accordance with one or more embodiments is described with reference to FIG. 51. FIG. 51 is a layout view of an example antenna device, in accordance with one or more embodiments.

Referring to FIG. 51, the example antenna device 1000h may include a plurality of antennas 10h arranged along the arrangement direction DRa.

A plurality of example antennas 10h, like the antennas 100b, 100d, 1001, and 100p according to the examples described above, may include the first feed unit 11 and the second feed unit 12 that may be disposed adjacent to two opposing corners of the bottom surface of the dielectric material block 111.

The edges of the bottom surface of the dielectric material block 111 of a plurality of antennas 10h may be oblique with respect to the arrangement direction DRa, and the first feed unit 11 and the second feed unit 12 of a plurality of antennas 10h may face each other along the direction parallel to the arrangement direction DRa and may overlap the imaginary straight line passing through the center part of the bottom surface of the dielectric material block 111 and parallel to the direction parallel to the arrangement direction DRa.

Accordingly, the edges of the bottom surface of the dielectric material block 111 of a plurality of antennas 10h may be disposed to be oblique with respect to the arrangement direction DRa, thereby reducing the area of the adjacent portion between two adjacent antennas 10h, thereby reducing interference between two adjacent antennas 10h.

Further, by disposing the first feed unit 11 and the second feed unit 12 of a plurality of antennas 10h to face each other along the direction parallel to the arrangement direction DRa, the resonance direction of the RF signals of each of the antennas 10h may be parallel to the arrangement direction DRa, thereby the RF signals of adjacent antennas 10h may be strengthened along the antenna arrangement direction DRa.

Many features of the antennas 100a to 100t described above are applicable to the example antenna device 1000h.

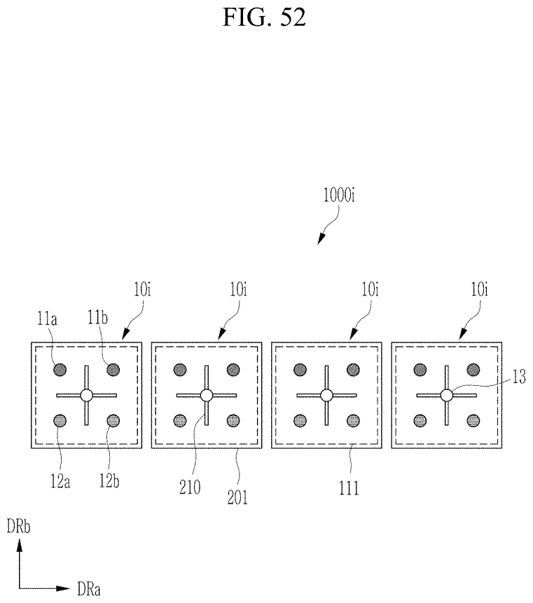

An example antenna device 1000i, in accordance with one or more embodiments, is described with reference to FIG. 52. FIG. 52 is a layout view of an example antenna device, in accordance with one or more embodiments.

Referring to FIG. 52, the example antenna device 1000i may include a plurality of antennas 10i arranged along the arrangement direction DRa.

A plurality of example antennas 10i, like the antennas 100f, 100h, 100m, 100n, 100o, 100q, 100r, 100s, 100t, and 100 according to the examples described above, may include the first feed unit 11a, the second feed unit 11b, the third feed unit 12a, and the fourth feed unit 12b that are disposed adjacent to the four corners of the bottom surface of the dielectric material block 111.

The edges of the bottom surface of the dielectric material block 111 of the plurality of example antennas 10i may be parallel to, or substantially perpendicular to, the arrangement direction DRa, and the first feed unit 11a, the second feed unit 11b, the third feed unit 12a, and the fourth feed unit 12b of a plurality of antennas 10i may overlap two imaginary diagonal lines passing through the center part of the bottom surface of the dielectric material block 111.

Additionally, the ground plane 201 of the plurality of example antennas 10i may include a decoupling pattern 210.

The interval between the first feed unit 11a, the second feed unit 11b, the third feed unit 12a, and the fourth feed unit 12b of the plurality of example antennas 10i may be widened, and accordingly the RF signals of the different bands may be transmitted and/or received by implementing a single dielectric material block 111, the respective bandwidths of the first polarization RF signal and the second polarization RF signal of the first bandwidth, and the first polarization RF signal and the second polarization RF signal of the second bandwidth may be expanded, and the gain of the antenna device 1000i may be increased by reducing interference between the first polarization RF signal and the second polarization RF signal of the first bandwidth and the first polarization RF signal and the second polarization RF signal of the second bandwidth.

Many features of the example antennas 100a to 100t according to the examples described above are applicable to the example antenna device 1000i.

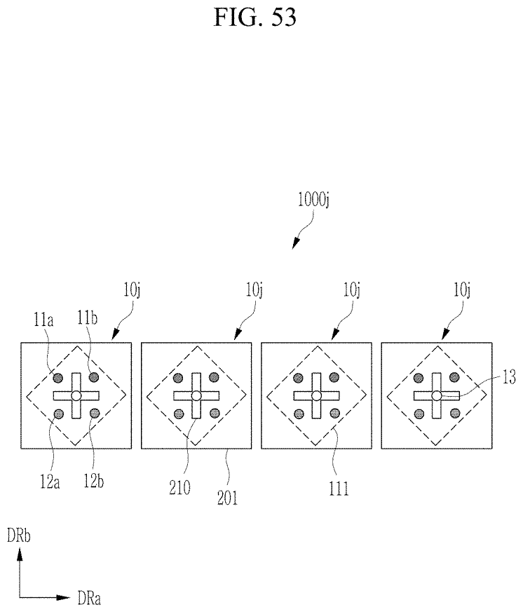

An example antenna device 1000j, in accordance with one or more embodiments, is described with reference to FIG. 53. FIG. 53 is a layout view of an example antenna device, in accordance with one or more embodiments.

Referring to FIG. 53, the example antenna device 1000j may include a plurality of example antennas 10j arranged along the arrangement direction DRa.

The plurality of example antennas 10j, like the antennas 100e and 100g according to the above-described examples, may include the first feed unit 11a, the second feed unit 11b, the third feed unit 12a, and the fourth feed unit 12b disposed adjacent to the center portions of four sides of the dielectric material block 111.

The edges of the bottom surface of the dielectric material block 111 of a plurality of antennas 10j may be oblique with respect to the arrangement direction DRa, and the first feed unit 11a, the second feed unit 11b, the third feed unit 12a, and the fourth feed unit 12ba of a plurality of antennas 10j may overlap an imaginary straight line passing through the center part of the bottom surface of the dielectric material block 111 and parallel to the direction oblique to the arrangement direction DRa.

Accordingly, the edges of the bottom surface of the dielectric material block 111 of a plurality of antennas 10j may be disposed to be oblique with respect to the arrangement direction DRa, thereby reducing the area of the adjacent portion between two adjacent antennas 10j, and thereby reducing interference between two adjacent antennas 10j.

Additionally, the ground plane 201 of a plurality of antennas 10j may include the decoupling pattern 210.

The interval between the first feed unit 11a, the second feed unit 11b, the third feed unit 12a, and the fourth feed unit 12b of a plurality of antennas 10j may be widened, and accordingly the RF signals of the different bands may be transmitted and/or received by implementing a single dielectric material block 111, the bandwidth of the first polarization RF signal and the second polarization RF signal of the first bandwidth and the first polarization RF signal and the second polarization RF signal of the second bandwidth may be expanded, and the gain of the antenna device 1000j may be increased by reducing the interference between the first polarization RF signal and the second polarization RF signal of the first bandwidth and the first polarization RF signal and the second polarization RF signal of the second bandwidth.

Many features of the example antennas 100a to 100t according to the examples described above are applicable to the example antenna device 1000j.

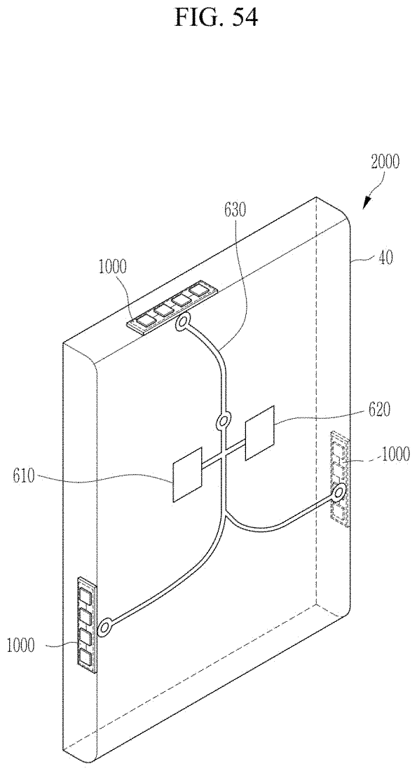

An example electronic device including an example antenna device, in accordance with one or more embodiments, is described with reference to FIG. 54. FIG. 54 is a simplified diagram illustrating an example electronic device including an example antenna device, in accordance with one or more embodiments.

Referring to FIG. 54, an example electronic device 2000, in accordance with one or more embodiments includes one or more antenna devices 1000, and the one or more antenna devices 1000 may be disposed in a set 40 of the electronic device 2000.

The electronic device 2000 may be, as non-limited examples, a smart phone, a personal digital assistant, a digital video camera, a digital still camera, a network system, a computer, a monitor, a tablet, a laptop, a netbook, a television, a video game, a smart watch, an automotive part, and the like, but it is not limited thereto.

In an example, the electronic device 2000 may have polygonal sides, and the antenna apparatus 1000 may be disposed adjacent to at least a portion of a plurality of sides of the electronic device 2000.

In the set 40, a communication device 610 and a baseband circuit 620 may be further disposed. The antenna device may be connected to the communication device 610 and/or the baseband circuit 620 through a coaxial cable 630.

As non-limiting examples, the communication module 610 may include at least one among a memory chip such as a volatile memory (e.g., a DRAM), a non-volatile memory (e.g., a ROM), and a flash memory to perform digital signal processing, an application processor chip such as a central processor (e.g., a CPU), a graphics processor (e.g., a GPU), a digital signal processor, an encryption processor, a microprocessor, a microcontroller, a logic chip such as an analog-digital converter, and an application-specific IC (ASIC).

The baseband circuit 620 may generate a base signal by performing, as non-limiting examples, analog-digital conversion, amplification of an analog signal, filtering, and frequency conversion. The base signal input and output from the baseband circuit 620 may be transmitted to the antenna apparatus through a cable.

In an example, the base signal may be transferred to an integrated circuit (IC) through an electrical connection structure, a core via, and wiring. The IC may convert the base signal into an RF signal of a millimeter waveband.

In an example, the antenna device 1000 may include any one of the aforementioned antenna devices 1000a to 1000j.

Many features of the aforementioned antenna devices 1000a to 1000j are applicable to the antenna device 1000 of the electronic device 2000.

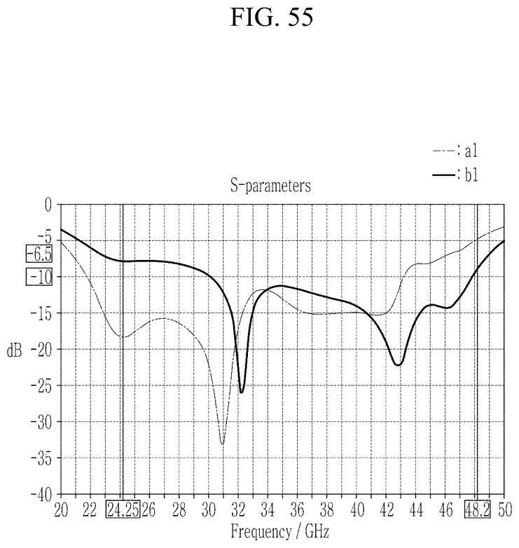

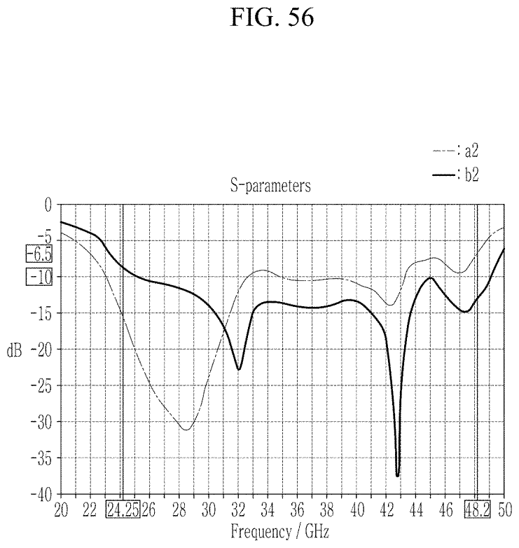

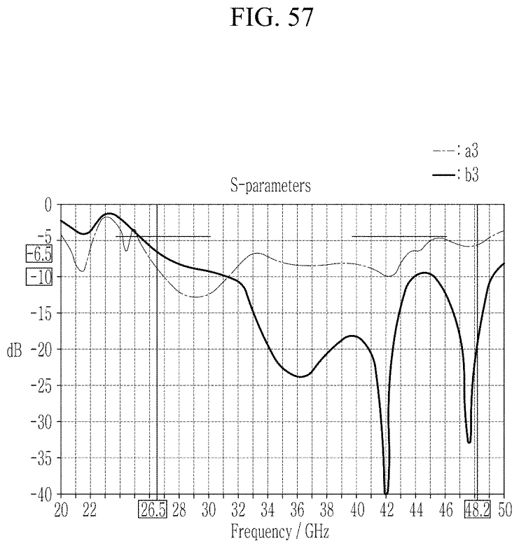

Now, an experimental example is described with reference to FIG. 55 to FIG. 57 and Table 1. FIG. 55 to FIG. 57 are graphs showing a result of an experimental example.

In the present experimental example, the antenna device 200a, in accordance with one or more embodiments shown in FIG. 31 to FIG. 33 was formed, in a first example (Example 1) without the shield via 13 unlike the antenna device 200a, a second example (Example 2) in which one shield via 13 position at the center part of the dielectric material block 111 is formed like the antenna device 200a, and a third example (Example 3) in which three shield vias disposed at the center part of the dielectric material block 111 are formed, a S-parameter of the RF signal of the first bandwidth and the RF signal of the second bandwidth is measured and a result thereof is shown in FIG. 55 to FIG. 57 as graphs and in Table 1.

FIG. 55 shows the result of the first example (Example 1), and in FIG. 55, a1 represents the result of the RF signal of the first bandwidth, while b1 represents the result of the RF signal of the second bandwidth. FIG. 56 shows the result of the second example (Example 2), and in FIG. 56, a2 represents the result of the RF signal of the first bandwidth, while b2 represents the result of the RF signal of the second bandwidth. FIG. 57 shows the result of the third example (Example 3), and in FIG. 57, a3 represents the result of the RF signal of the first bandwidth, while b3 represents the result of the RF signal of the second bandwidth.

In Table 1 below, for the first example (Example 1), the second example (Example 2), and the third example (Example 3), a difference value of the RF signal of the first bandwidth and the RF signal of the second bandwidth at about 28 GHz of a low frequency region and a difference value of the RF signal of the first bandwidth and the RF signal of the second bandwidth at about 39 GHz of a high frequency region are shown.

TABLE 1

| | Low frequency | High frequency |
|---|---|---|
| | band | band |
| | (28 GHz) | (39 GHz) |
| First example (Example 1) | 8 dB | 2 dB |
| Second example (Example 2) | 18 dB | 4 dB |
| Third example (Example 3) | 5 dB | 10 dB |

Referring to FIG. 54 to FIG. 56 along with Table 1, unlike the antenna device 200a, compared with the first example (Example 1) without the shield via 13, in the second example (Example 2), in which one shield via 13 disposed on the center part of the dielectric material block 111 like the antenna device 200a was formed, it was found that an isolation characteristic increased by about twice or more. Compared to the second example (Example 2) where one shield via 13 disposed on the center part of the dielectric material block 111 was formed like the antenna device 200a, it was confirmed that the change in the isolation characteristic of the third example (Example 3) where three shield vias disposed on the center part of the dielectric material block 111 were formed was not large, and the isolation characteristic of the low frequency band is small. Accordingly, as in the antennas 100a to 100t according to the examples, by forming one shield via 13 disposed on the center part of the dielectric material block 111, it was found that the isolation characteristic of the antenna may be increased.

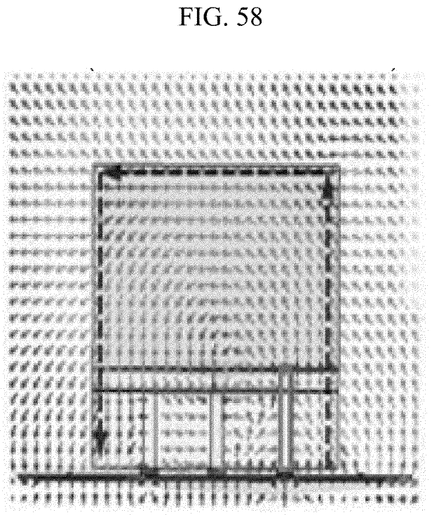

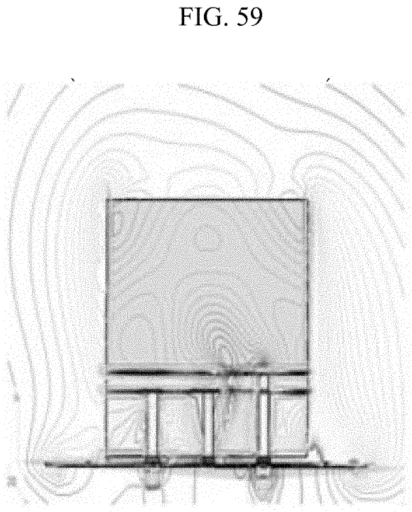

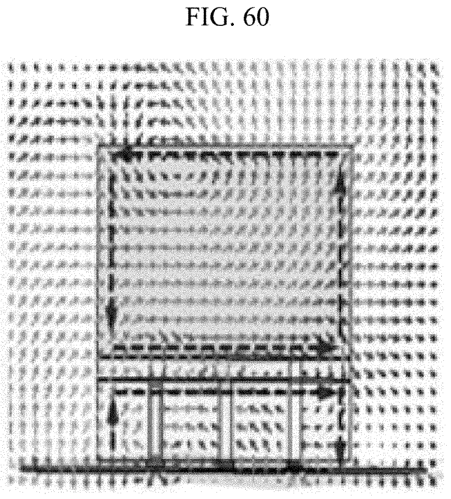

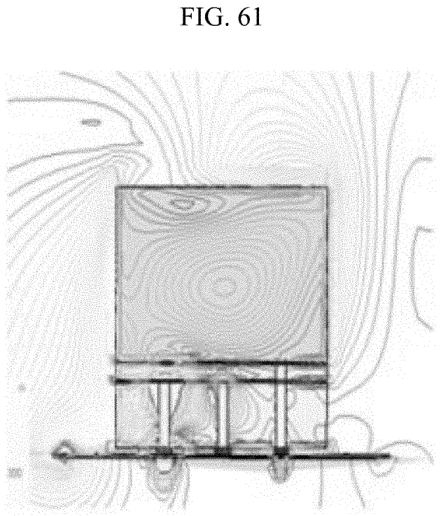

Another experimental example is described with reference to FIG. 58 to FIG. 61. FIG. 58 to FIG. 61 are views showing a result of another experimental example.

In the present experimental example, the antenna device 200a according to the example shown in FIG. 31 to FIG. 33 is formed, and when transmitting and receiving the RF signal of the first bandwidth and the RF signal of the second bandwidth, the current of the dielectric material block 111 is observed and a result thereof is shown in FIG. 58 to FIG. 61. FIG. 58 and FIG. 59 show the results of the first bandwidth, and FIG. 60 and FIG. 61 show the results of the second bandwidth.

Referring to FIG. 58 to FIG. 61, it was found that the resonance occurred for the entire dielectric material block 111 when transmitting and receiving the RF signal of the first bandwidth, and it was found that the resonance occurred so that the first dielectric material block 110 and the third dielectric material block 130 of the dielectric material block 111 were symmetrical to each other when transmitting and receiving the RF signal of the second bandwidth. Accordingly, as in the antennas 100a to 100t and 100 according to embodiments, by forming the feeding unit of the first bandwidth and the feeding unit of the second bandwidth having different heights in one dielectric material block 111, it was found that the resonance was achieved so that the RF signals of two different bandwidths may be transmitted/received.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A dielectric resonator antenna, comprising:
a dielectric material block;
a first feed unit disposed in the dielectric material block and configured to have a first height; and
a second feed unit disposed in the dielectric material block and configured to have a second height,
wherein the first feed unit and the second feed unit are disposed to be symmetrical to each other with reference to a center region of a lower surface of the dielectric material block.

2. The dielectric resonator antenna of claim 1, wherein the first height and the second height are measured from the lower surface of the dielectric material block.

3. The dielectric resonator antenna of claim 1, further comprising:
a shield via disposed in the dielectric material block, and disposed between the first feed unit and the second feed unit.

4. The dielectric resonator antenna of claim 3, wherein the shield via is configured to overlap the center region.

5. The dielectric resonator antenna of claim 1, wherein:
the lower surface of the dielectric material block comprises a first side that extends in a first direction and a second side that extends in a second direction different from the first direction, and
a first straight line overlaps an intersection of the first side and the second side.

6. The dielectric resonator antenna of claim 5, wherein:
the first feed unit and the second feed unit are each respectively a via disposed in the dielectric material block.

7. The dielectric resonator antenna of claim 5, wherein:
the first feed unit and the second feed unit are each respectively a feed strip disposed on an external surface of the dielectric material block.

8. The dielectric resonator antenna of claim 1, wherein:
the lower surface of the dielectric material block comprises a first side that extends in a first direction, and a second side that extends in a second direction different from the first direction, and
a first straight line is parallel to one of first side and the second side.

9. The dielectric resonator antenna of claim 1, further comprising:
a third feed unit disposed in the dielectric material block, and configured to have the first height, and
a fourth feed unit disposed in the dielectric material block, and configured to have the second height,
wherein the third feed unit and the fourth feed unit are configured to overlap a second straight line intersecting the center region of the lower surface of the dielectric material block, and
wherein a first interval is formed between the third feed unit and the center region, and a second interval is formed between the fourth feed unit and the center region.

10. The dielectric resonator antenna of claim 9, wherein:
the dielectric material block is configured to extend in a first direction, a second direction different from the first direction, and a third direction perpendicular to the first direction and the second direction,
the lower surface comprises two first sides parallel to the first direction and two second sides parallel to the second direction, and
a first straight line and the second straight line overlap an intersection of the first side and the second side.

11. The dielectric resonator antenna of claim 9, wherein:
the dielectric material block is configured to extend in a first direction, a second direction different from the first direction, and a third direction perpendicular to the first direction and the second direction, and
a first straight line is parallel to the first direction and the second straight line is parallel to the second direction.

12. The dielectric resonator antenna of claim 11, wherein:
the lower surface comprises two first sides parallel to the first direction and two second sides parallel to the second direction, and
the first straight line and the second straight line overlap a center of the first side and a center of the second side.

13. The dielectric resonator antenna of claim 1, wherein:
the dielectric material block comprises a first dielectric material block, a second dielectric material block, and a third dielectric material block stacked from the lower surface,
the first feed unit is disposed in the first dielectric material block and the second dielectric material block, and
the second feed unit is disposed in the first dielectric material block.

14. The dielectric resonator antenna of claim 13, wherein:
the dielectric material block further comprises a first dielectric layer disposed between the first dielectric material block and the second dielectric material block, and a second dielectric layer disposed between the second dielectric material block and the third dielectric material block, and
a dielectric constant of the first dielectric layer and a dielectric constant of the second dielectric layer are lower than a dielectric constant of the first dielectric material block, a dielectric constant of the second dielectric material block, and a dielectric constant of the third dielectric material block.

15. A dielectric resonator antenna, comprising:
a dielectric material block;
a first feed unit disposed in the dielectric material block, and configured to have a first height;
a second feed unit disposed in the dielectric material block, and configured to have a second height different from the first height; and
a shield via disposed in the dielectric material block, and configured to overlap a center region of a lower surface of the dielectric material block, and configured to be separated from the first feed unit and the second feed unit by a same interval.

16. The dielectric resonator antenna of claim 15, wherein the first height and the second height are measured from the lower surface of the dielectric material block.

17. The dielectric resonator antenna of claim 15, wherein:
the shield via comprises a third height,
the third height of the shield via is measured from the lower surface of the dielectric material block; and
the third height is equal to or greater than the second height.

18. The dielectric resonator antenna of claim 15, wherein:
the lower surface of the dielectric material block comprises a first side that extends in the first direction and a second side that extends in a second direction different from the first direction,
the first feed unit and the second feed unit are configured to overlap a straight line disposed on the lower surface of the dielectric material block, and
the straight line is parallel to one of the first side and the second side.

19. The dielectric resonator antenna of claim 15, wherein:
the lower surface of the dielectric material block comprises a first side that extends in a first direction and a second side that extends in a second direction different from the first direction,
the first feed unit and the second feed unit are configured to overlap a straight line disposed on the lower surface of the dielectric material block, and
the straight line is configured to overlap an intersection of the first side and the second side.

20. The dielectric resonator antenna of claim 15, further comprising:
a third feed unit disposed in the dielectric material block, and configured to have the first height, and a fourth feed unit disposed in the dielectric material block, and configured to have the second height,
wherein the shield via is spaced at a same interval from the third feed unit and the fourth feed unit.

21. The dielectric resonator antenna of claim 20, wherein:
the lower surface of the dielectric material block comprises a first side that extends in a first direction and a second side that extends in a second direction different from the first direction,
the first feed unit and the second feed unit overlap a first straight line on the lower surface of the dielectric material block,
the third feed unit and the fourth feed unit overlap a second straight line on the lower surface of the dielectric material block, and
the first straight line and the second straight line are respectively parallel to the first side or the second side.

22. The dielectric resonator antenna of claim 20, wherein:
the lower surface of the dielectric material block comprises a first side that extends in a first direction, and a second side that extends in a second direction different from the first direction,
the first feed unit and the second feed unit overlap the first straight line on the lower surface of the dielectric material block,
the third feed unit and the fourth feed unit overlap the second straight line on the lower surface of the dielectric material block, and
the first straight line and the second straight line are diagonal lines that overlap an intersection of the first side and the second side.

23. The dielectric resonator antenna of claim 15, wherein:
the dielectric material block comprises a first dielectric material block, a second dielectric material block, and a third dielectric material block stacked from the lower surface,
the first feed unit is disposed in the first dielectric material block and the second dielectric material block, and
the second feed unit is disposed in the first dielectric material block.

24. The dielectric resonator antenna of claim 23, wherein:
the dielectric material block further comprises a first dielectric layer disposed between the first dielectric material block and the second dielectric material block, and a second dielectric layer disposed between the second dielectric material block and the third dielectric material block, and
a dielectric constant of the first dielectric layer and a dielectric constant of the second dielectric layer are lower than a dielectric constant of the first dielectric material block, a dielectric constant of the second dielectric material block, and a dielectric constant of the third dielectric material block.

25. An antenna device, comprising:
a dielectric material block;
a first feed unit disposed in the dielectric material block and configured to have a first height measured from a lower surface of the dielectric material block;
a second feed unit disposed in the dielectric material block and configured to have a second height measured from the lower surface of the dielectric material block;
a ground plane disposed under the dielectric material block; and
a pattern part connected to the ground plane and disposed between the first feed unit and the second feed unit,
wherein the first height is different from the second height.

26. The antenna device of claim 25, further comprising:
a shield via, disposed in the dielectric material block, and separated at a same interval from the first feed unit and the second feed unit, and
the pattern part is configured to overlap the shield via.

27. The antenna device of claim 25, wherein:
the pattern part comprises an extension part that extends between the first feed unit and the second feed unit from a center region of the dielectric material block overlapping the shield via.

28. The antenna device of claim 27, wherein:
the pattern part comprises a first pattern part comprising an extension part that extends between the first feed unit and the second feed unit from the center region overlapping the shield via, and
a second pattern part connected to the first pattern part and configured to surround the first feed unit and the second feed unit.

29. The antenna device of claim 28, wherein:
the second pattern part comprises a part that extends outside the lower surface of the dielectric material block.

30. The antenna device of claim 27, further comprising:
a third feed unit, disposed in the dielectric material block, and configured to have the first height, and a fourth feed unit, disposed in the dielectric material block, and configured to have the second height, and
the pattern part comprises a first extension that extends between the first feed unit and the second feed unit from the center region overlapping the shield via, a second extension that extends between the first feed unit and the third feed unit, a third extension that extends between the second feed unit and the fourth feed unit, and a fourth extension that extends between the third feed unit and the fourth feed unit.

31. The antenna device of claim 30, wherein:
the dielectric material block comprises a first dielectric material block, a second dielectric material block, and a third dielectric material block stacked from the lower surface,
the first feed unit and the third feed unit are disposed in the first dielectric material block and the second dielectric material block, and
the second feed unit and the fourth feed unit are disposed in the first dielectric material block.
